(19) United States
(12) Patent Application Publication
(10) Pub. No.: US 2026/0288030 A1
(43) Pub. Date: Sep. 24, 2026

(54) IMAGE FORMING APPARATUS

(71) Applicant: CANON KABUSHIKI KAISHA, Tokyo (JP)

(72) Inventors: SATOSHI ISHIDA, Kanagawa (JP); SHOTOKU MATSUI, Kanagawa (JP); TOMOYA TATEISHI, Kanagawa (JP)

(21) Appl. No.: 19/560,745

(22) Filed: Mar. 9, 2026

(30) Foreign Application Priority Data
Mar. 19, 2025 (JP) 2025-046029

(51) Int. Cl. G03G 15/01; G03G 15/00; G03G 15/043; G03G 15/23

(52) U.S. Cl. CPC G03G 15/0173; G03G 15/043; G03G 15/234; G03G 15/5029; G03G 15/6511; G03G 15/6558; G03G 2215/00599; G03G 2215/00734

(57) ABSTRACT

An image forming apparatus includes a photosensitive drum, a rotary including a plurality of developing rollers, an intermediate transfer member, a transfer unit, a conveyance unit, a detection unit disposed between the conveyance unit and the transfer unit in the sheet conveyance direction, and configured to detect the sheet, a motor configured to drive the rotary by rotating in a first direction, and drive the conveyance unit by rotating in a second direction opposite to the first direction, and a control unit configured to control the motor. The control unit controls the motor in the image forming operation such that the sheet is detected by the detection unit after the rotary is moved to a predetermined development posture, the predetermined development posture being a development posture to which the rotary moves last during the execution of the image forming operation, among the plurality of development postures.

### BACKGROUND

### Field of the Technology

The present disclosure relates to an image forming apparatus that forms an image on a recording material.

### Description of the Related Art

Concerning electrophotographic image forming apparatuses, there has been known a rotary developing scheme in which a color image is formed by rotating a rotary including a plurality of developing members. JP 2011-002725 A describes an image forming apparatus including four developing devices that develop latent images using yellow, magenta, cyan, and black developers, respectively, and forming an image on a sheet fed from a cassette by a sheet feeding unit. When forming a color image, the image forming apparatus starts feeding a sheet by the sheet feeding unit during a yellow image forming operation, and performs a sheet feeding retry in which the sheet feeding unit feeds the sheet again when a leading edge detection sensor cannot detect the sheet by the sheet feeding retry determination timing. When the leading edge detection sensor detects the sheet, the sheet feeding retry ends, and the sheet is temporarily stopped. Then, the image forming apparatus resumes the conveyance of the sheet after starting a black image forming operation, and transfers the color image onto the sheet.

In recent years, there has been demand for suppressing a variation in timing at which a sheet reaches a transfer unit that transfers an image to a sheet.

However, the problems to be solved by the embodiments disclosed in the present specification and the drawings are not limited to the aforementioned problems. The problems corresponding to the respective effects achieved by the configurations of the embodiments to be described below can also be positioned as other problems.

### SUMMARY

According to a first aspect of the present disclosure, an image forming apparatus configured to execute an image forming operation of forming a color image on a sheet includes a photosensitive drum, a rotary including a plurality of developing rollers, the rotary being rotatable to a plurality of development postures during an execution of the image forming operation, one of the plurality of developing rollers facing the photosensitive drum in a case where the rotary takes each of the plurality of development postures, an intermediate transfer member to which a toner image is transferred from the photosensitive drum, a transfer unit configured to transfer the toner image borne on the intermediate transfer member to the sheet, a conveyance unit configured to execute a conveyance operation of conveying the sheet in a sheet conveyance direction toward the transfer unit, a detection unit disposed between the conveyance unit and the transfer unit in the sheet conveyance direction, and configured to detect the sheet, a motor configured to drive the rotary by rotating in a first direction, and drive the conveyance unit by rotating in a second direction opposite to the first direction, and a control unit configured to control the motor. The control unit controls the motor in the image forming operation such that the sheet is detected by the detection unit after the rotary is moved to a predetermined development posture, the predetermined development posture being a development posture to which the rotary moves last during the execution of the image forming operation, among the plurality of development postures.

According to a second aspect of the present disclosure, an image forming apparatus configured to execute an image forming operation of forming a color image on a sheet includes a photosensitive drum, a rotary including a plurality of developing rollers, the rotary being rotatable to a plurality of development postures during an execution of the image forming operation, one of the plurality of developing rollers facing the photosensitive drum in a case where the rotary takes each of the plurality of development postures, an intermediate transfer member to which a toner image is transferred from the photosensitive drum, a transfer unit configured to transfer the toner image borne on the intermediate transfer member to the sheet, a conveyance unit configured to execute a conveyance operation of conveying the sheet in a sheet conveyance direction toward the transfer unit, a detection unit disposed between the conveyance unit and the transfer unit in the sheet conveyance direction, and configured to detect the sheet, a first motor configured to drive the rotary, a second motor configured to drive the conveyance unit, and a control unit configured to control the first motor and the second motor. The control unit controls the first motor and the second motor in the image forming operation such that the sheet is detected by the detection unit after the rotary is moved to a predetermined development posture, the predetermined development posture being a development posture to which the rotary moves last during the execution of the image forming operation, among the plurality of development postures.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an image forming apparatus according to the first embodiment.

FIG. 2 is a configuration diagram of the image forming apparatus according to the first embodiment.

FIG. 3 is a schematic view of a developing unit, a toner cartridge, and a tray according to the first embodiment.

FIG. 4A is a cross-sectional view of the image forming apparatus according to the first embodiment.

FIG. 4B is a cross-sectional view of the image forming apparatus according to the first embodiment.

FIG. 5 is a perspective view of a rotary body according to the first embodiment.

FIG. 6A is a perspective view of the image forming apparatus according to the first embodiment.

FIG. 6B is a perspective view of the image forming apparatus according to the first embodiment.

FIG. 6C is a perspective view of the image forming apparatus according to the first embodiment.

FIG. 7A is a cross-sectional view of the image forming apparatus according to the first embodiment.

FIG. 7B is a cross-sectional view of the image forming apparatus according to the first embodiment.

FIG. 8 is an explanatory view of the rotary body according to the first embodiment.

FIG. 9 is an explanatory view of the rotary body according to the first embodiment.

FIG. 10 is an explanatory view of the rotary body according to the first embodiment.

FIG. 11A is an explanatory view of a configuration related to a movement of the tray according to the first embodiment.

FIG. 11B is an explanatory view of a configuration related to a movement of the tray according to the first embodiment.

FIG. 12A is an explanatory view of a configuration related to a movement of the tray according to the first embodiment.

FIG. 12B is an explanatory view of a configuration related to a movement of the tray according to the first embodiment.

FIG. 13A is a perspective view illustrating a configuration of a drive mechanism of the tray according to the first embodiment.

FIG. 13B is a perspective view illustrating a configuration of the drive mechanism of the tray according to the first embodiment.

FIG. 14A is a perspective view illustrating a stepped gear according to the first embodiment.

FIG. 14B is a perspective view illustrating the stepped gear according to the first embodiment.

FIG. 15 is a perspective view illustrating a lock member according to the first embodiment.

FIG. 16A is a front view illustrating an operation of a lock mechanism according to the first embodiment.

FIG. 16B is a front view illustrating an operation of the lock mechanism according to the first embodiment.

FIG. 17A is a perspective view illustrating an operation of the lock mechanism according to the first embodiment.

FIG. 17B is a perspective view illustrating an operation of the lock mechanism according to the first embodiment.

FIG. 18A is a view illustrating a configuration for drive transmission from a motor to a rotary body and a conveyance unit according to the first embodiment.

FIG. 18B is a view illustrating a configuration for drive transmission from the motor to the rotary body and the conveyance unit according to the first embodiment.

FIG. 19A is a perspective view illustrating a rotary drive ratchet gear according to the first embodiment.

FIG. 19B is a perspective view illustrating the rotary drive ratchet gear according to the first embodiment.

FIG. 19C is a perspective view illustrating the rotary drive ratchet gear according to the first embodiment.

FIG. 20A is a view illustrating an engaging operation of the rotary drive ratchet gear according to the first embodiment.

FIG. 20B is a view illustrating an engaging operation of the rotary drive ratchet gear according to the first embodiment.

FIG. 20C is a view illustrating an engaging operation of the rotary drive ratchet gear according to the first embodiment.

FIG. 21A is a view illustrating a separating operation of the rotary drive ratchet gear according to the first embodiment.

FIG. 21B is a view illustrating a separating operation of the rotary drive ratchet gear according to the first embodiment.

FIG. 22A is a perspective view illustrating a conveyance drive ratchet gear according to the first embodiment.

FIG. 22B is a perspective view illustrating the conveyance drive ratchet gear according to the first embodiment.

FIG. 22C is a perspective view illustrating the conveyance drive ratchet gear according to the first embodiment.

FIG. 23A is a view illustrating an engaging operation of the conveyance drive ratchet gear according to the first embodiment.

FIG. 23B is a view illustrating an engaging operation of the conveyance drive ratchet gear according to the first embodiment.

FIG. 23C is a view illustrating an engaging operation of the conveyance drive ratchet gear according to the first embodiment.

FIG. 24A is a view illustrating a separating operation of the conveyance drive ratchet gear according to the first embodiment.

FIG. 24B is a view illustrating a separating operation of the conveyance drive ratchet gear according to the first embodiment.

FIG. 25A is a view illustrating a movement distance of the rotary body according to the first embodiment.

FIG. 25B is a view illustrating a movement distance of the rotary body according to the first embodiment.

FIG. 26A is a cross-sectional view illustrating a restriction lever according to the first embodiment.

FIG. 26B is a cross-sectional view illustrating the restriction lever according to the first embodiment.

FIG. 27A is a cross-sectional view illustrating an operation of the restriction lever according to the first embodiment.

FIG. 27B is a cross-sectional view illustrating an operation of the restriction lever according to the first embodiment.

FIG. 28 is a perspective view illustrating a configuration around the restriction lever according to the first embodiment.

FIG. 29A is a front view illustrating how the restriction lever moves between an allowing position and a restricting position according to the first embodiment.

FIG. 29B is a front view illustrating how the restriction lever moves between the allowing position and the restricting position according to the first embodiment.

FIG. 30 is a block diagram for explaining a system configuration of the image forming apparatus.

FIG. 31 is a timing chart for explaining an image forming operation and a conveyance operation according to the first embodiment.

FIG. 32 is a flowchart illustrating the image forming operation and the conveyance operation according to the first embodiment.

FIG. 33 is a flowchart illustrating the image forming operation and the conveyance operation according to the first embodiment.

FIG. 34 is a timing chart for explaining an image forming operation and a conveyance operation according to the second embodiment.

FIG. 35 is a flowchart illustrating the image forming operation and the conveyance operation according to the second embodiment.

FIG. 36 is a flowchart illustrating the image forming operation and the conveyance operation according to the second embodiment.

FIG. 37 is a timing chart for explaining an image forming operation and a conveyance operation according to the third embodiment.

FIG. 38 is a flowchart illustrating the image forming operation and the conveyance operation according to the third embodiment.

FIG. 39 is a flowchart illustrating the image forming operation and the conveyance operation according to the third embodiment.

FIG. 40 is a schematic view illustrating a cross-sectional configuration of an image forming apparatus according to the fourth embodiment.

FIG. 41 is a schematic view illustrating a width sensor according to the fourth embodiment.

FIG. 42 is a timing chart for explaining an image forming operation and a conveyance operation according to the fourth embodiment.

FIG. 43 is a flowchart illustrating the image forming operation and the conveyance operation according to the fourth embodiment.

FIG. 44 is a flowchart illustrating the image forming operation and the conveyance operation according to the fourth embodiment.

FIG. 45 is a timing chart illustrating an image forming operation and a conveyance operation in a case where a width size of a sheet cannot be detected by the width sensor according to the fourth embodiment.

FIG. 46 is a timing chart for explaining an image forming operation and a conveyance operation according to a comparative example.

### DESCRIPTION OF THE EMBODIMENTS

Hereinafter, embodiments according to the present disclosure will be described with reference to the drawings.

### First Embodiment

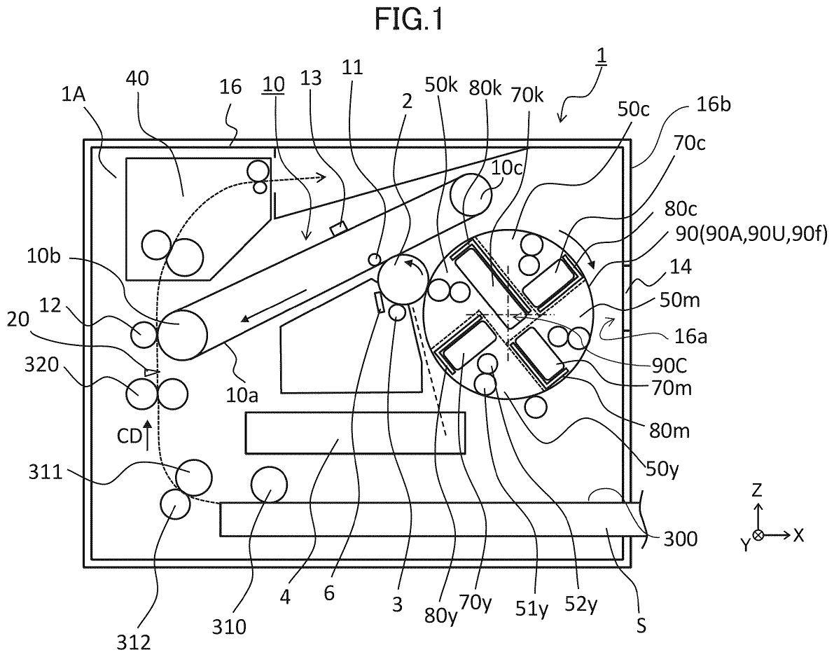

An image forming apparatus 1 according to the first embodiment will be described with reference to FIG. 1 to FIGS. 12A and 12B. In the following description and each drawing, when the image forming apparatus 1 is installed on a horizontal plane, a vertical direction is defined as a Z direction. A direction that intersects the Z direction and that is a direction of a rotation axis 90C of a rotary body 90 (a rotation axis direction of a rotary), which will be described below, is defined as a Y direction. A direction of a rotation axis of a photosensitive drum 2 (a rotation axis direction of a photosensitive drum) is also parallel to the direction of the rotation axis 90C of the rotary body 90, and is the Y direction. A direction intersecting with both the Z direction and the Y direction is defined as an X direction. The X direction and the Y direction are preferably horizontal directions. In addition, the X direction, the Y direction, and the Z direction are preferably orthogonal to each other. Further, as necessary, X, Y, and Z directions indicated by arrows illustrated in the drawings represent +X side, +Y side, and +Z side, respectively, and the opposite sides represent −X side, −Y side, and −Z side, respectively.

### Overall Configuration of Image Forming Apparatus

First, the overall configuration of the image forming apparatus 1 will be described. The image forming apparatus 1 is a laser beam printer that forms an image on a sheet S using electrophotography. More specifically, the image forming apparatus 1 is a color laser beam printer including four developing units 50y, 50m, 50c, and 50k. As the sheet S that is a recording material (recording medium), various sheet materials that are different in size and material, such as paper such as plain paper and thick paper, sheet materials subjected to surface treatment such as plastic films, cloth, coated paper, and sheet materials having special shapes such as envelopes and index paper, can be used.

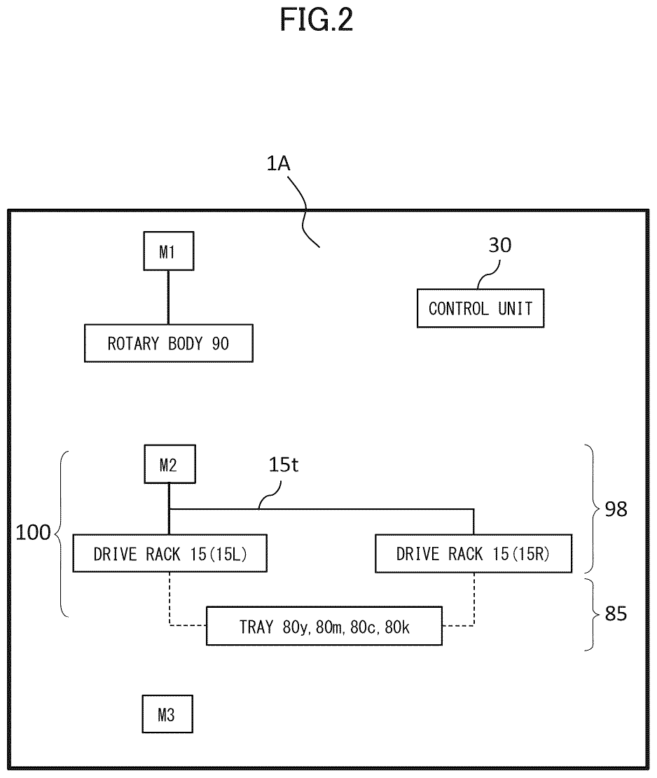

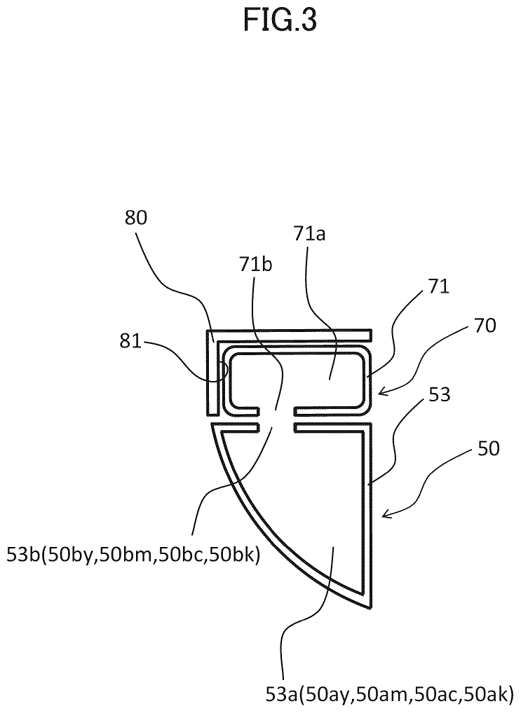

A schematic configuration and an image forming operation of the image forming apparatus 1 will be described with reference to FIGS. 1, 2, and 3. FIG. 1 is a schematic view illustrating a cross-sectional configuration of the image forming apparatus 1. FIG. 2 is a diagram for explaining a drive source of the image forming apparatus 1. FIG. 3 is a conceptual diagram illustrating a configuration for supplying a toner from a toner cartridge 70 to a developing unit 50.

As illustrated in FIG. 1, the image forming apparatus 1 includes an image forming apparatus body (hereinafter referred to as an apparatus body) 1A and toner cartridges 70y, 70m, 70c, and 70k detachably attached to the apparatus body 1A. The apparatus body 1A according to the present embodiment is a portion of the image forming apparatus 1 from which the toner cartridges 70y, 70m, 70c, and 70k are removed.

The apparatus body 1A of the image forming apparatus 1 includes an electrophotographic photosensitive member (hereinafter referred to as a photosensitive drum) 2 having a drum shape (cylindrical shape) as an image bearing member that bears an electrostatic latent image. A charging roller 3, a scanner 4 serving as an exposing unit, and a cleaning unit 6 are arranged around the photosensitive drum 2.

The charging roller 3 is an example of a charging member or a charging unit for uniformly charging the photosensitive drum 2. The scanner 4 is an example of an exposing unit that performs exposure by irradiating the photosensitive drum 2 with laser light corresponding to image information. By irradiating the charged photosensitive drum 2 with laser light, an electrostatic latent image is formed on the surface of the photosensitive drum 2. The cleaning unit 6 is an example of a cleaning unit that removes a toner remaining on the surface of the photosensitive drum 2.

Further, the apparatus body 1A includes a sheet accommodating portion 300, a pickup roller 310, a feed roller 311, a separation roller 312, a conveyance roller pair 320, a conveyance sensor 20, a secondary transfer roller 12, a fixing unit 40, and an intermediate transfer unit 10. The pickup roller 310 is an example of a feeding part or a feeding unit that feeds the sheet S. The feed roller 311 and the separation roller 312 are an example of a separation and conveyance unit that conveys sheets S while separating the sheets S one by one using a frictional force. The secondary transfer roller 12 is an example of a transfer unit that transfers an image from an intermediate transfer belt 10a onto the sheet S.

The intermediate transfer unit 10 includes an intermediate transfer belt 10a, a belt driving roller 10b, a tension roller 10c, a cleaning device 13, and a primary transfer roller 11. The intermediate transfer belt 10a is an example of an intermediate transfer member that bears the image transferred (primarily transferred) from the photosensitive drum 2 and conveys the image to be transferred (secondarily transferred) onto the sheet S. The intermediate transfer belt 10a is stretched around the belt driving roller 10b and the tension roller 10c. The belt driving roller 10b is a driving member driven to rotate by a drive source to convey the intermediate transfer belt 10a.

In addition, the apparatus body 1A includes a rotary body (rotary, rotary member, and developing device) 90 having developing units 50y, 50m, 50c, and 50k. As will be described below, in the present embodiment, trays (support members) 80y, 80m, 80c, and 80k are attached to the rotary body 90. The toner cartridges 70y, 70m, 70c, and 70k are detachably mounted on the trays 80y, 80m, 80c, and 80k.

In the following description, a plurality of members or the like having similar functions can be distinguished by assigning reference numerals. For example, one of the toner cartridges 70y, 70m, 70c, and 70k can be referred to as a first toner cartridge, one of the remaining three toner cartridges can be referred to as a second toner cartridge, one of the remaining two toner cartridges can be referred to as a third toner cartridge, and the last one can be referred to as a fourth toner cartridge. Similarly, one of the trays 80y, 80m, 80c, and 80k can be referred to as a first tray, one of the remaining three trays can be referred to as a second tray, one of the remaining two trays can be referred to as a third tray, and the last one can be referred to as a fourth tray. That is, one of the trays 80y to 80k is an example of a first support member, another one of the trays 80y to 80k is an example of a second support member, still another one of the trays 80y to 80k is an example of a third support member, and the last one of the trays 80y to 80k is an example of a fourth support member. The assignment of these numerals is merely used for convenience of explanation, and can be appropriately changed in principle.

The developing units (first to fourth developing units) 50y, 50m, 50c, and 50k are examples of developing parts or developing units that develop (visualize) the electrostatic latent images formed on the photosensitive drum 2 into toner images using toners of corresponding colors. Each of the developing units 50y, 50m, 50c, and 50k develops the electrostatic latent image formed on the photosensitive drum 2 using a yellow toner, a magenta toner, a cyan toner, or a black toner. The developing units 50y, 50m, 50c, and 50k may be arranged in an order different from the order illustrated in FIG. 1.

The developing unit 50y includes a developing roller 51y, a supplying roller 52y, and a developing blade. The developing roller 51y is a developer bearing member that bears a toner serving as a developer and rotates to supply the toner to the photosensitive drum 2. The supplying roller 52y is a supplying member disposed in contact with the developing roller 51y to supply the toner to the developing roller 51. The developing blade restricts a thickness of a toner layer borne on the developing roller 51y. Similarly, the other developing units 50m, 50c, and 50k also include developing rollers 51m, 51c, and 51k, supplying rollers 52m, 52c, and 52k, and developing blades.

The toner cartridges 70y, 70m, 70c, and 70k corresponding to the developing units 50y, 50m, 50c, and 50k are mounted on the rotary body 90. Inside the toner cartridges 70y, 70m, 70c, and 70k, a yellow toner, a magenta toner, a cyan toner, and a black toner are accommodated as toners to be supplied to the developing units 50y, 50m, 50c, and 50k, respectively. One of the four color toners can be said to be a first toner, one of the remaining three color toners can be said to be a second toner, one of the remaining two color toners can be said to be a third toner, and the last toner can be said to be a fourth toner. For example, it can be said that the black toner is an example of a first toner and the magenta toner is an example of a second toner. The assignment of these numerals is merely used for convenience of explanation, and can be appropriately changed in principle.

Here, the rotary body 90 includes a rotary frame 90f that supports the developing units 50y, 50m, 50c, and 50k. The developing units 50y, 50m, 50c, and 50k are supported by the rotary frame 90f that is a rotatable rotary support.

In addition, the trays 80y, 80m, 80c, and 80k are attached to the rotary body 90. The combination of the rotary body 90 and the trays 80y, 80m, 80c, and 80k can be referred to as a rotary unit 90U. In other words, the rotary unit 90U includes the rotary body 90 and the trays 80y, 80m, 80c, and 80k.

The toner cartridges 70y to 70k are held on the trays 80y to 80k in a detachably attached manner. As will be described below, the trays 80y to 80k are supported so as to be moved to the outside of the rotary body 90 in a sliding manner. The combination of the rotary unit 90U and the toner cartridges 70y, 70m, 70c, and 70k can be referred to as a rotary assembly 90A. In other words, the rotary assembly 90A includes the rotary unit 90U and the toner cartridges 70y, 70m, 70c, and 70k.

As will be described below, the rotary body 90 is rotatable about the rotation axis (rotation center) 90C. The rotation axis 90C coincides with the rotation axes of the rotary frame 90f, the rotary unit 90U, and the rotary assembly 90A. The rotation axis 90C is substantially parallel to the rotation axis (rotation center) of the photosensitive drum 2.

As the rotary body 90 rotates about the rotation axis 90C, any one of the developing rollers 51y, 51m, 51c, and 51k serving as a plurality of developing rollers can take a development posture by facing the photosensitive drum 2. The posture in which the developing roller 51y faces the photosensitive drum 2 is referred to as a yellow development posture. The posture in which the developing roller 51m faces the photosensitive drum 2 is referred to as a magenta development posture. The posture in which the developing roller 51c faces the photosensitive drum 2 is referred to as a cyan development posture. The posture in which the developing roller 51k faces the photosensitive drum 2 is referred to as a black development posture. That is, the rotary body 90 can rotate about the rotation axis 90C so as to change the positions of the developing rollers 51y, 51m, 51c, and 51k with respect to the photosensitive drum 2. The black development posture is an example of a first development posture in which a first developing roller (the developing roller 51k) faces the photosensitive drum 2. The other development posture is an example of a second development posture in which a second developing roller (one of the developing rollers 51y to 51c) faces the photosensitive drum 2. The yellow/magenta/cyan/black development postures can also be referred to as first to fourth development postures, respectively. The assignment of these numerals is merely used for convenience of explanation, and can be appropriately changed in principle.

As illustrated in FIG. 2, the apparatus body 1A includes motors M1, M2, and M3 serving as drive sources. As will be described below, the motor M1 serving as a first motor supplies a driving force for rotating the rotary body 90 about the rotation axis 90C. In other words, the motor M1 rotates the rotary assembly 90A and the rotary unit 90U about the rotation axis 90C.

The apparatus body 1A includes a driving device 98 including the motor M2 and a transmission device. The transmission device includes drive racks 15L and 15R serving as drive gears, which will be described below, and a transmission unit 15t. The driving force of the motor M2 serving as a second motor is transmitted to the drive racks 15L and 15R by the transmission unit 15t. In other words, the motor M2 is configured to drive the drive racks 15L and 15R, and moves the trays 80y, 80m, 80c, 80k with respect to the rotary body 90 via the drive racks 15L and 15R.

The motor M3 drives members other than the members driven by the motor M1 and the motor M2. For example, the motor M3 drives the photosensitive drum 2, the developing units 50y, 50m, 50c, and 50k, the secondary transfer roller 12, the belt driving roller 10b, and the fixing unit 40.

The members driven by the motors M1, M2, and M3 can be appropriately changed. The roles of any two or all three of the motors M1, M2, and M3 can be integrated into one motor. On the other hand, a drive source other than the motors M1, M2, and M3 may be added.

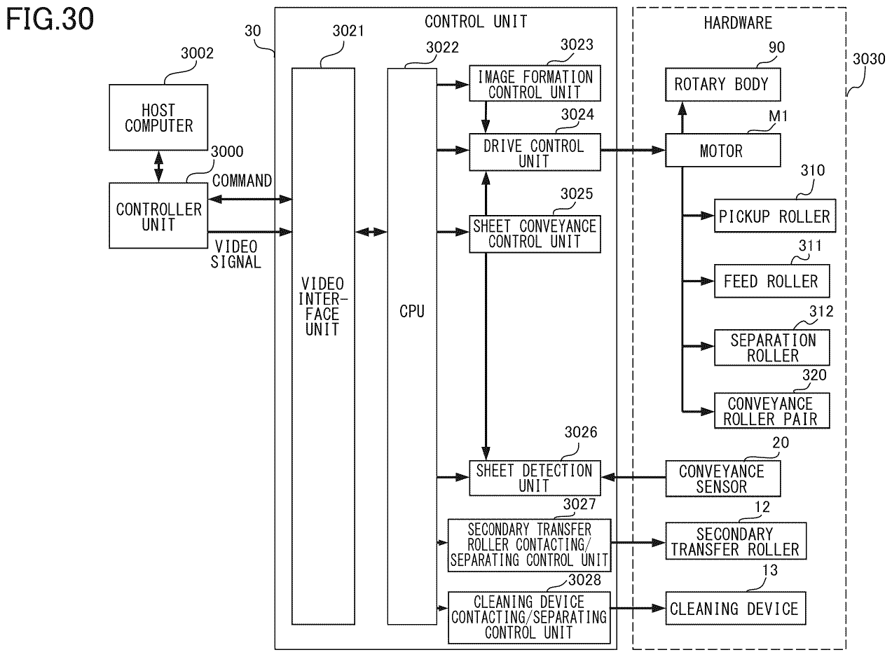

Furthermore, the apparatus body 1A includes a control unit 30 serving as a control part that controls an operation of the image forming apparatus 1. The control unit 30 includes a CPU capable of executing a program and a storage unit such as a ROM or a RAM. The CPU reads and executes the program stored in the storage unit, and controls operations of actuators such as the motors M1, M2, and M3 provided in the image forming apparatus 1. The storage unit includes a non-volatile storage medium and a volatile storage medium, and serves as a location for storing a program and data and a work space when the CPU executes the program. Note that each function of the control unit 30, which will be described below, may be implemented on a circuit in the control unit 30 as independent hardware such as an ASIC. Note that a detailed configuration of the control unit 30 will be described below with reference to FIG. 30.

Here, the suffixes y, m, c, and k attached to the developing units 50y, 50m, 50c, and 50k, the toner cartridges 70y, 70m, 70c, and 70k, the trays 80y, 80m, 80c, and 80k, and the like indicate toner colors. The basic configurations and functions of the developing units 50y, 50m, 50c, and 50k are common. The basic configurations and functions of the toner cartridges 70y, 70m, 70c, and 70k are common. In addition, the basic configurations and functions of the trays 80y, 80m, 80c, and 80k are common. Therefore, when it is not necessary to distinguish them, the suffixes y, m, c, and k will be omitted, and the description will be made assuming that the unit, cartridge, or tray is any one of the four units, cartridges, or trays. In addition, when it is necessary to distinguish the four units, cartridges, or trays, the suffixes y, m, c, and k will be added, and the description will be given assuming that the unit, cartridge, or tray is one of the four units, cartridges, and trays corresponding to the suffix.

As illustrated in FIG. 3, the toner cartridge 70 includes a toner frame 71. The toner frame 71 includes a toner accommodating portion 71a accommodating a toner and a discharging opening 71b communicating with the toner accommodating portion 71a.

The developing unit 50 includes a developing frame (accommodating frame) 53, and is configured to mount the toner cartridge 70 thereon. The developing frame 53 includes a development-side accommodating portion 53a (accommodating portion) and a receiving opening 53b communicating with the development-side accommodating portion (toner supply chamber) 53a. That is, the rotary body 90 includes a developing frame 53y, a developing frame 53m, a developing frame 53c, and a developing frame 53k. That is, the rotary body 90 includes a first developing chamber, a second developing chamber, a third developing chamber, and a fourth developing chamber. As described above, the developing unit 50 includes the developing roller 51, the supplying roller 52, etc., but these members are omitted in FIG. 3.

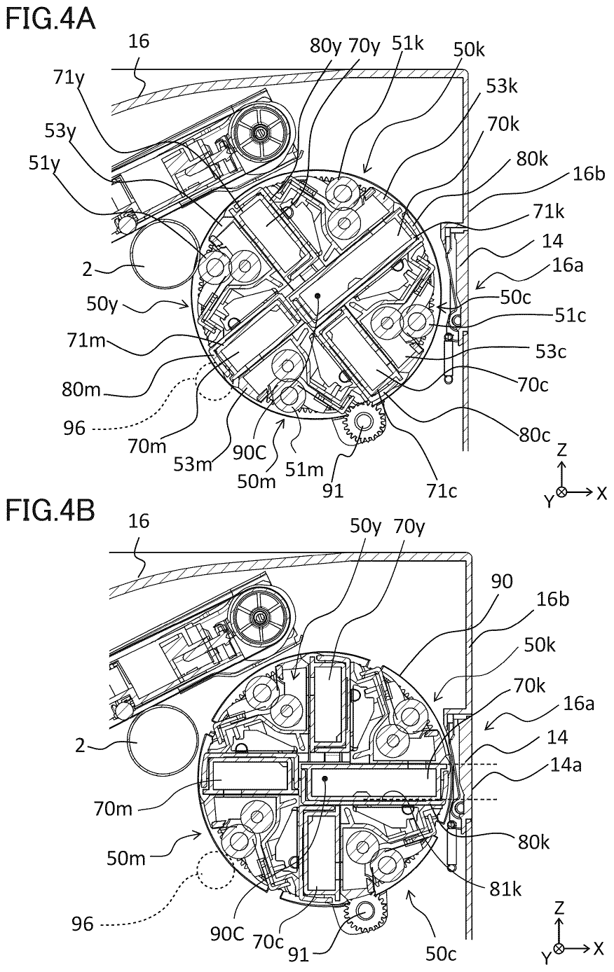

The developing roller 51k included in the developing unit 50k is an example of a first developing roller. The developing roller 51m included in the developing unit 50m is an example of a second developing roller. The developing frame 53k (FIG. 4A) of the developing unit 50k including the development-side accommodating portion 53a (first accommodating portion) is an example of a first accommodating frame including a first accommodating portion. The developing frame 53m (FIG. 4A) of the developing unit 50m including the development-side accommodating portion 53a (second accommodating portion) is an example of a second accommodating frame including a second accommodating portion. The rotary body 90 is an example of a rotatable rotary including a first developing roller, a second developing roller, a first accommodating frame including a first accommodating portion, and a second accommodating frame including a second accommodating portion. In the present embodiment, the rotary body 90 includes first to fourth developing rollers and first to fourth accommodating frames.

As will be described below, the toner cartridge 70 is movable with respect to the developing frame 53 between a mounted position and a retracted position retracted from the mounted position. In a state where the toner cartridge 70 is located at the mounted position with respect to the developing frame 53, the discharging opening 71b faces the receiving opening 53b. That is, the toner accommodating portion 71a of the toner cartridge 70 and the development-side accommodating portion 53a of the developing unit 50 communicate with each other via the discharging opening 71b and the receiving opening 53b. When a toner is supplied from the toner cartridge 70 to the developing unit 50, at least a part of the receiving opening 53b is positioned below at least a part of the discharging opening 71b.

Then, the toner accommodated in the toner accommodating portion 71a is discharged from the discharging opening 71b, and the toner discharged from the discharging opening 71b is accommodated in the development-side accommodating portion 53a through the receiving opening 53b. That is, a first developer, a second developer, a third developer, and a fourth developer are supplied to the first developing chamber, the second developing chamber, the third developing chamber, and the fourth developing chamber included in the rotary body 90, respectively.

The toner accommodated in the development-side accommodating portion 53a is supplied to the developing roller 51 by the supplying roller 52. Through this route, the toner accommodated in the toner accommodating portion 71a is supplied to the developing roller 51.

The toner cartridge 70 desirably includes a sealing member (first sealing member) (not illustrated) that covers the discharging opening 71b. In addition, the developing unit 50 desirably includes a sealing member (second sealing member) (not illustrated) that covers the receiving opening 53b.

In a state where the toner cartridge 70 is not mounted on the developing unit 50, it is desirable that the discharging opening 71b and the receiving opening 53b are covered with the respective sealing members so as to suppress the outflow of the toner from the discharging opening 71b and the receiving opening 53b.

### Image Forming Operation

An image forming operation in the present embodiment will be described. First, the photosensitive drum 2 is rotated in a direction indicated by an arrow in FIG. 1 (counterclockwise) in synchronization with the rotation of the intermediate transfer belt 10a. Then, the surface of the photosensitive drum 2 is uniformly charged by the charging roller 3.

When a color image is formed on the sheet S, the rotary body 90 rotates in a direction indicated by an arrow in FIG. 1 (clockwise) while supporting the developing units 50y, 50m, 50c, and 50k as will be described below. Then, the electrophotographic process is repeatedly performed while moving the developing rollers 51y, 51m, 51c, and 51k one by one to a developing position.

First, the scanner 4 emits laser light based on image data corresponding to a yellow image to form an electrostatic latent image corresponding to the yellow image on the surface of the photosensitive drum 2. In parallel with the formation of the electrostatic latent image, the motor M1 rotates the rotary body 90, and the rotary body 90 takes the yellow development posture. When the rotary body 90 takes the yellow development posture, the developing roller 51y is located at the developing position, and develops the electrostatic latent image formed on the photosensitive drum 2 using the yellow toner.

Here, in the present embodiment, each of the developing rollers 51y, 51m, 51c, and 51k is an elastic roller obtained by coating rubber around a metal shaft. At the developing position, each of the developing rollers 51y, 51m, 51c, and 51k develops the electrostatic latent image in contact with the photosensitive drum 2. That is, the image forming apparatus 1 according to the present embodiment employs a contact development method. However, at the developing position, each of the developing rollers 51y, 51m, 51c, and 51k may develop the electrostatic latent image in a state where a gap is formed between the photosensitive drum 2 and each of the developing rollers 51y, 51m, 51c, and 51k. That is, the image forming apparatus 1 may employ a non-contact developing method.

When a yellow toner image is developed, the yellow toner image formed on the photosensitive drum 2 is primarily transferred to the intermediate transfer belt 10a by the primary transfer roller 11 disposed inside the intermediate transfer belt 10a.

Thereafter, by rotating the rotary body 90 to sequentially move the developing rollers 51m, 51c, and 51k to the developing position, toner images of respective colors are formed. That is, after the yellow toner image is formed on the intermediate transfer belt 10a, the rotary body 90 takes the magenta development posture, and a magenta toner image is formed on the intermediate transfer belt 10a. After the magenta toner image is formed on the intermediate transfer belt 10a, the rotary body 90 takes the cyan development posture, and a cyan toner image is formed on the intermediate transfer belt 10a. After the cyan toner image is formed on the intermediate transfer belt 10a, the rotary body 90 takes the black development posture, and a black toner image is formed on the intermediate transfer belt 10a. That is, the developing rollers 51y, 51m, 51c, and 51k can develop electrostatic latent images as toner images by using toners of different colors.

After the black toner image is formed on the intermediate transfer belt 10a, the rotary body 90 rotates about the rotation axis 90C in a direction indicated by an arrow in FIG. 1 (clockwise) and returns to the yellow development posture. Note that any color of image may be formed first on the intermediate transfer belt 10a, and for example, a black toner image may be formed first.

Then, the primary transfer is repeated so as to superimpose the four colors of toner images on the intermediate transfer belt 10a, whereby a color image is formed on the intermediate transfer belt 10a. The secondary transfer roller 12 and the cleaning device 13 are not in contact with the intermediate transfer belt 10a until the color image is formed on the intermediate transfer belt 10a.

On the other hand, the sheet S is fed by the pickup roller 310 from the sheet accommodating portion 300 provided in the lower portion of the apparatus body 1A. The sheets S are sent to the conveyance roller pair 320 in the separated state one by one by the feed roller 311 and the separation roller 312. The conveyance roller pair 320 feeds the fed sheet S to a transfer portion (secondary transfer portion) that is a nip portion between the intermediate transfer belt 10a and the secondary transfer roller 12. In a sheet conveyance direction CD in which the sheet S is conveyed, the conveyance sensor 20 is disposed between the conveyance roller pair 320 and the secondary transfer roller 12, and the conveyance sensor 20 serving as a detection unit can detect the sheet S. The timing at which the sheet S is fed from the conveyance roller pair 320 to the secondary transfer portion is determined depending on the timing at which the leading edge of the sheet S is detected by the conveyance sensor 20 and the timing at which the color image is formed on the intermediate transfer belt 10a. The color image formed on the intermediate transfer belt 10a is transferred (secondarily transferred) to the surface of the conveyed sheet S in the secondary transfer portion.

The sheet S to which the color image has been transferred is sent to the fixing unit 40. In the fixing unit 40, the sheet S is heated and pressurized, and the image is fixed onto the sheet S. The sheet S having passed through the fixing unit 40 is discharged to the outside of the image forming apparatus 1 as an output sheet.

On the other hand, in a case where a monochrome image is formed on the sheet S, the rotary body 90 takes the black development posture. In this state, an electrostatic latent image is formed on the surface of the photosensitive drum 2 by charging and exposing the photosensitive drum 2, and then the electrostatic latent image is developed using the black toner by the developing roller 51k located at the developing position. The black toner image is primarily transferred to the intermediate transfer belt 10a and then secondarily transferred to the sheet S. The subsequent steps are similar to those in a case where a color image is formed.

### Configuration of Rotary

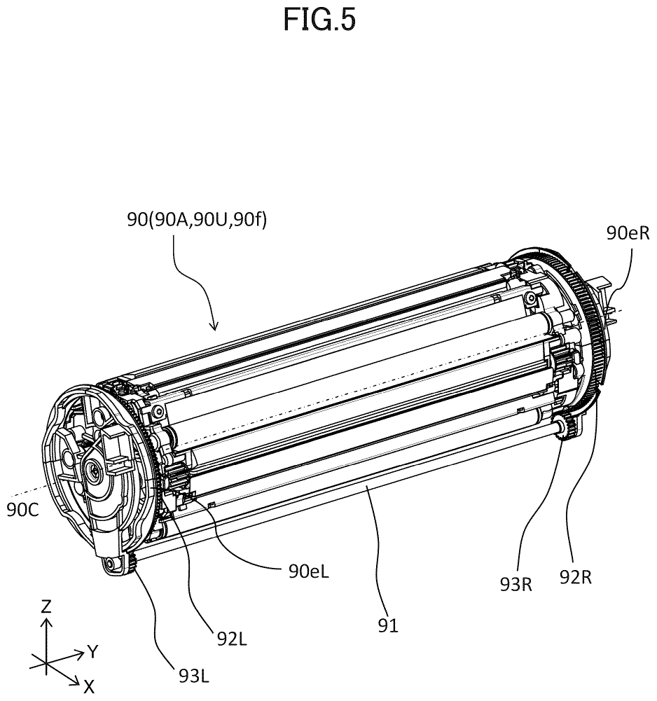

The configuration of the rotary body 90 will be described with reference to FIG. 1, FIGS. 4A and 4B, and FIG. 5. FIGS. 4A and 4B are cross-sectional views illustrating the rotary body 90 and its periphery of the image forming apparatus 1. Note that FIGS. 4A and 4B are cross-sectional views of the apparatus taken along a virtual plane perpendicular to the rotation axis 90C of the rotary body 90. FIG. 5 is a perspective view of the rotary body 90.

As described above, the toner cartridges 70y to 70k are detachably attached to the rotary body 90. When the toners in the toner cartridges 70y to 70k run out, the user can supply toners to the image forming apparatus 1 by replacing the toner cartridges 70y to 70k.

As illustrated in FIG. 1, the apparatus body 1A includes a frame 16 that accommodates the rotary body 90. The frame 16 is a body frame of the image forming apparatus 1 according to the present embodiment. The frame 16 is a casing (framework) of the apparatus body 1A formed by a frame and an exterior member, and has a substantially rectangular parallelepiped shape in the present embodiment.

The frame 16 has an opening 16a. More specifically, the frame 16 has a side surface 16b that expands in a direction intersecting the horizontal direction. The side surface 16b constitutes at least a part of an external appearance surface on the +X side of the apparatus body 1A. The opening 16a is disposed on this side surface 16b. The side surface 16b is a side surface disposed downstream of a discharge port in a discharge direction in which the sheet S on which the image is formed is discharged from the discharge port of the apparatus body 1A. The user can access the sheet accommodating portion 300 from the side surface 16b of the image forming apparatus 1 to supply the sheets S or acquire the sheets S discharged from the discharge port. Therefore, the side surface 16b can be said to be the front (front surface) of apparatus body 1A.

The toner cartridges 70y, 70m, 70c, and 70k are detachably attached to the rotary body 90 through the opening 16a. That is, it can be said that the toner cartridge 70k is an example of a first toner cartridge that accommodates a toner to be supplied to the first developing roller (developing roller 51k) and is detachably attached to the rotary (rotary body 90) through the opening 16a of the frame 16 of the apparatus body 1A. It can be said that the toner cartridge 70m is an example of a second toner cartridge that accommodates a toner to be supplied to the second developing roller (developing roller 51m) and is detachably attached to the rotary (rotary body 90) through the opening 16a of the frame 16 of the apparatus body 1A.

In the present embodiment, the toner cartridges 70y, 70m, 70c, and 70k are attached to and detached from the rotary body 90 through the opening 16a while being supported by the trays 80y to 80k. In other words, the user can attach and detach the toner cartridges 70y to 70k to and from the rotary body 90 via the trays 80y to 80k.

The opening 16a is disposed on the side surface 16b of the frame 16. In the present embodiment, the side surface 16b is a surface substantially parallel to the rotation axis 90C of the rotary body 90. Therefore, when the toner cartridge 70 is replaced, the toner cartridge 70 passes through the opening 16a in a direction intersecting (preferably, a direction orthogonal to) the rotation axis 90C.

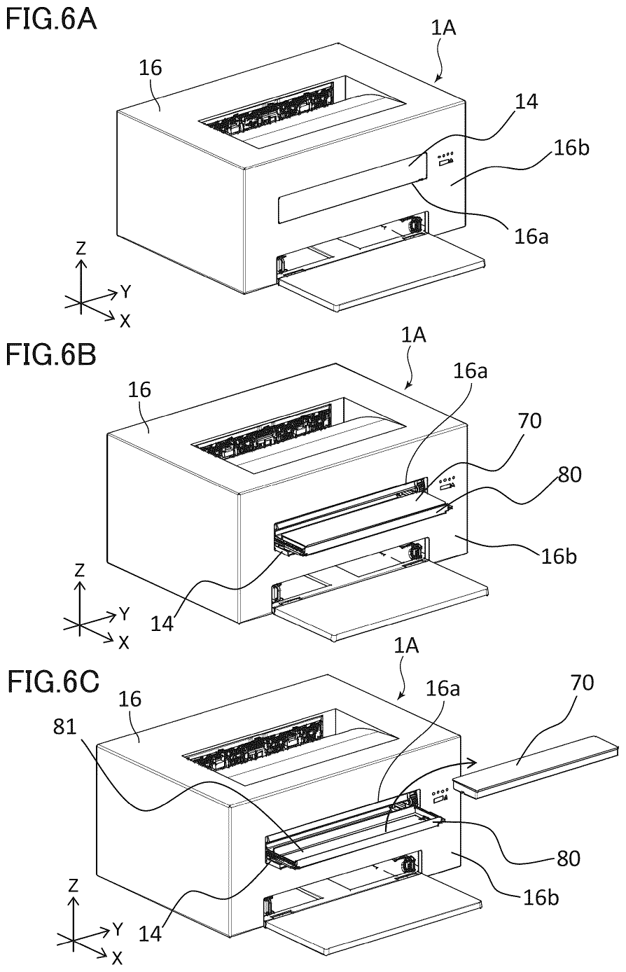

The image forming apparatus 1 includes a door 14 that covers the opening 16a of the frame 16. The door 14 is an opening/closing member movable between a closed position (see also FIG. 6A) where the opening 16a is covered and an open position (see also FIGS. 6B and 6C) where the opening 16a is exposed.

As described above, in the present embodiment, the toner cartridge 70 is configured to be attachable to and detachable from the rotary body 90 via the tray 80. Therefore, the toner cartridge 70 can be stably attached to and detached from the rotary body 90.

More specifically, the user can replace the toner cartridge 70 by attaching and detaching the toner cartridge 70 to and from the tray 80 configured to be movable with respect to the rotary body 90 (that is, with respect to the apparatus body 1A). In a configuration in which the user replaces a toner cartridge by directly inserting and removing the toner cartridge into and from the apparatus body, the user is required to insert the toner cartridge to a predetermined mounted position inside the apparatus body. In the present embodiment, the tray 80 is movable while supporting the toner cartridge 70 so that the toner cartridge 70 moves to the mounted position. Therefore, the user can replace the toner cartridge 70 by simply placing the toner cartridge 70 on the tray 80, thereby improving the operability.

Note that the toner cartridge 70 has an elongated shape with the Y direction parallel to the rotation axis 90C of the rotary body 90 as a longitudinal direction. That is, the dimension in the longitudinal direction of the toner cartridge 70 is larger than the height and the width in the cross section orthogonal to the longitudinal direction. In a case where a toner cartridge 70 having such an elongated shape is handled, by providing the opening 16a on the side surface 16b of the frame 16 substantially parallel to the longitudinal direction (Y direction) of the toner cartridge 70, the toner cartridge 70 can pass through the opening 16a with a short movement distance. For example, as compared with a case where the toner cartridge 70 is inserted and removed through an opening provided on a side surface on one side (+Y side or −Y side) of the frame 16 in the longitudinal direction of the toner cartridge 70, it is easy to replace the toner cartridge 70.

By rotating about the rotation axis 90C, the rotary body 90 can take a replacement posture in which one of the toner cartridges 70y to 70k is allowed to be detached from the rotary body 90. The posture in which the toner cartridge 70y is allowed to be detached is referred to as a yellow replacement posture. The posture in which the toner cartridge 70m is allowed to be detached is referred to as a magenta replacement posture. The posture in which the toner cartridge 70c is allowed to be detached is referred to as a cyan replacement posture.

The posture in which the toner cartridge 70k is allowed to be detached is referred to as a black replacement posture. The black replacement posture is an example of a first replacement posture in which the first toner cartridge is allowed to be detached from the rotary body 90. The yellow/magenta/cyan replacement postures are examples of a second replacement posture in which the second toner cartridge is allowed to be detached from the rotary body 90. The yellow/magenta/cyan/black replacement postures can also be referred to as first to fourth replacement postures. The assignment of these numerals is merely used for convenience of explanation, and can be appropriately changed in principle.

The rotary body 90 can take the yellow/magenta/cyan/black replacement postures sequentially by rotating clockwise in FIG. 1 about the rotation axis 90C. In the present embodiment, the posture of the rotary body 90 is alternately switched between the development posture and the replacement posture by rotating the rotary body 90 clockwise in FIG. 1 about the rotation axis 90C. For example, in FIG. 1, the rotary body 90 takes the black development posture. By rotating the rotary body 90 clockwise from this state, the posture of the rotary body 90 is switched in the order of the cyan replacement posture, the yellow development posture, the black replacement posture, the magenta development posture, the yellow replacement posture, the cyan development posture, and the magenta replacement posture. By rotating the rotary body 90 clockwise from the magenta replacement posture, the rotary body 90 returns to the black development posture. That is, the rotary body 90 can rotate clockwise by one full rotation (360°) or more.

FIG. 4A illustrates a cross section of the rotary body 90 in a state where the development posture (specifically, the yellow development posture) is taken. FIG. 4B illustrates a cross section of the rotary body 90 in a state where the replacement posture (specifically, the black replacement posture) is taken.

As illustrated in FIGS. 4A and 4B, the four trays 80y to 80k are attached to the rotary body 90. The toner cartridges 70y to 70k are held by the trays 80y to 80k, respectively. In FIGS. 4A and 4B, the trays 80y to 80k are accommodated inside the rotary body 90, and this state can be said to be a state in which the toner cartridges 70y to 70k are mounted on the developing units 50y, 50m, 50c, and 50k.

As described above, the toner cartridge 70 is movable between the mounted position and the retracted position retracted from the mounted position with respect to the developing frame 53 of the developing unit 50. That is, the first toner cartridge (toner cartridge 70k) is movable with respect to the first accommodating frame (developing frame 53k) between a first mounted position and a first retracted position. The second toner cartridge (toner cartridge 70m) is movable with respect to the second accommodating frame (developing frame 53m) between a second mounted position and a second retracted position.

In a state where the toner cartridge 70 is located at the mounted position with respect to the developing frame 53, the discharging opening 71b and the receiving opening 53b face each other as illustrated in FIG. 3. In this state, the toner cartridge 70 is configured to supply a toner to the development-side accommodating portion 53a through the receiving opening 53b (the opening of the accommodating frame).

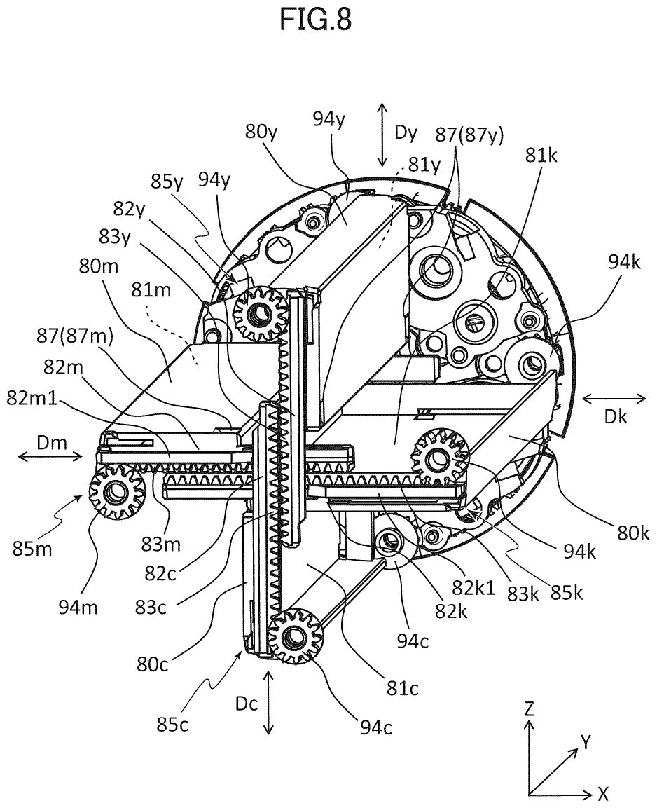

The apparatus body 1A includes a moving device 85 configured to move the toner cartridge 70 from the mounted position to the retracted position with respect to the rotary body 90 (more specifically, with respect to the developing frame 53 of the developing unit 50). The moving device 85 will be described below with reference to FIG. 8, etc. In the present embodiment, a plurality of moving devices 85y to 85k corresponding to the plurality of toner cartridges 70y to 70k are arranged in the rotary body 90. It can be said that the trays 80y to 80k are parts of the moving devices 85y to 85k.

In the present embodiment, the toner cartridge 70k accommodating the black toner is larger in size than the toner cartridges 70y to 70c accommodating the yellow toner, the magenta toner, and the cyan toner, and can accommodate a larger amount of toner. In other words, it can be said that the first toner cartridge can accommodate a first amount of toner, and the second toner cartridge can accommodate a second amount of toner, the first amount being larger than the second amount.

Specifically, the length of the black toner cartridge 70k in a first radial direction with respect to the rotation axis 90C of the rotary body 90 is larger than the length of the magenta toner cartridge 70m in a second radial direction. Here, the first radial direction is a rotation radius direction of the rotary body 90 (a radial direction of a virtual circle with the rotation axis 90C being its center), and is a direction in which the toner cartridge 70k extends with respect to the rotation axis 90C when viewed in the direction of the rotation axis 90C. The second radial direction is a rotation radius direction of the rotary body 90, and is a direction in which the toner cartridge 70m extends with respect to the rotation axis 90C when viewed in the direction of the rotation axis 90C. Similarly, the length of the black toner cartridge 70k in the first radial direction is larger than the lengths of the toner cartridges 70y to 70c in the radial directions corresponding to the other toner cartridges 70y to 70c.

Therefore, the tray 80k holding the black toner cartridge 70k is larger in size than the trays 80y to 80c holding the other toner cartridges 70y, 70m, and 70c. That is, the four toner cartridges 70y to 70k and the four trays 80y to 80k having different sizes are arranged in the rotary body 90. In other words, the toner cartridge 70k, which is an example of a first toner cartridge, and the toner cartridge 70y, which is an example of a second toner cartridge smaller in size than the first toner cartridge, are detachably attached to the rotary body 90. Accordingly, the tray 80k, which is an example of a first support member that supports the first toner cartridge, and the tray 80y, which is an example of a second support member smaller in size than the first support member, are provided in the rotary body 90. In addition, the toner cartridges 70m and 70c, which are examples of third and fourth toner cartridges smaller in size than the first toner cartridge, are detachably attached to the rotary body 90. Accordingly, the trays 80m and 80c, which are examples of third and fourth support members smaller in size than the first support member, are provided in the rotary body 90.

Here, it will be described with reference to FIG. 5 how the rotary body 90 is driven to rotate. As illustrated in FIG. 5, disk gears 92L and 92R are formed at both ends of the rotary body 90. Rotary drive gears 93L and 93R are connected to both ends of a swing shaft 91 so as to be drive-transmittable. Here, the driving force of the motor M1 is transmitted to the rotary drive gear 93R by a drive transmission mechanism. Next, the driving force is transmitted to the disk gears 92L and 92R by the rotary drive gears 93L and 93R, thereby driving the rotary body 90 to rotate. The rotary body 90 rotates clockwise in FIG. 1 about the rotation axis 90C.

The rotary body 90 is supported to be swingable about the swing shaft 91. The rotary body 90 is biased in the counterclockwise direction in FIGS. 4A and 4B about the swing shaft 91 by a biasing member (not illustrated). This direction can be said to be a direction in which each of the developing rollers 51y to 51k approaches the photosensitive drum 2. As a result, in a state where the rotary body 90 takes the development posture, each of the developing rollers 51y to 51k is in contact with the photosensitive drum 2.

On the other hand, as illustrated in FIG. 5, rotary cams 90eL and 90eR are provided at both ends of the rotary body 90. When the rotary body 90 rotates clockwise in FIGS. 4A and 4B about the rotation axis 90C, the rotary cams 90eL and 90eR are in contact with a roller 96 (FIGS. 4A and 4B) supported by the frame 16. Then, the rotary body 90 moves in the clockwise direction in FIGS. 4A and 4B around the swing shaft 91. This direction can be said to be a direction in which each of the developing rollers 51y to 51k moves away from the photosensitive drum 2. In addition, this direction can be said to be a direction in which the rotary body 90 approaches the opening 16a of the frame 16 and the door 14.

As a result, when the rotary body 90 rotates to switch its posture from the development posture to the replacement posture, the rotary body 90 swings about the swing shaft 91. In a state where the rotary body 90 takes the replacement posture, the developing roller 51 is separated from the photosensitive drum 2.

As illustrated in FIG. 4B, in the black replacement posture, the toner cartridge 70k stops at a position facing the opening 16a and the door 14 provided on the side surface 16b of the apparatus body 1A. From this state, when the tray 80k is moved in a sliding manner from the mounted position on the developing unit 50k to the outside of the rotary body 90, the user can replace the toner cartridge 70k.

### Toner Cartridge Replacing Operation

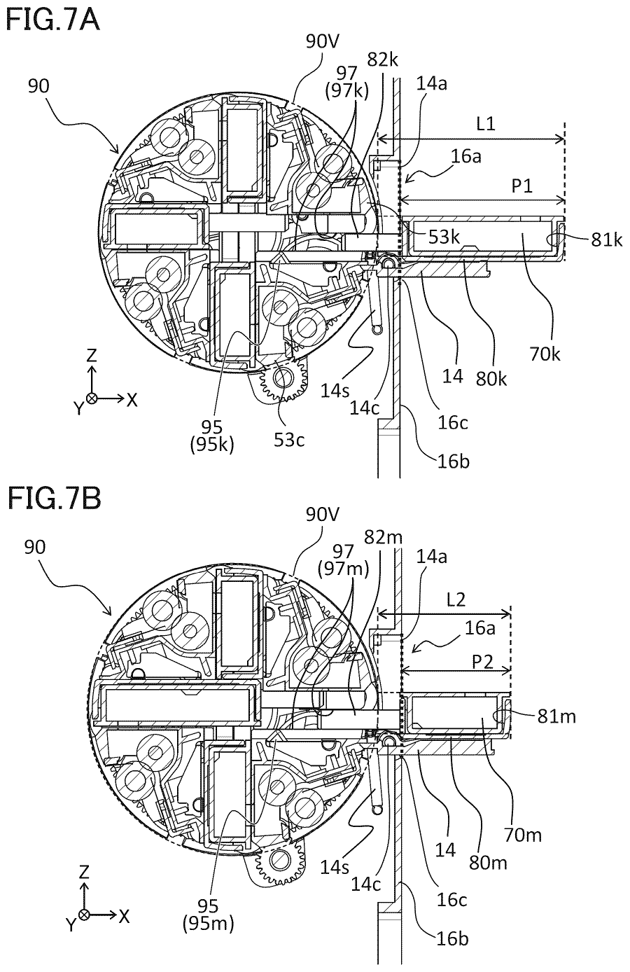

A toner cartridge replacing operation will be described with reference to FIG. 4A, FIGS. 6A to 6C, and FIGS. 7A and 7B. FIGS. 6A to 6C are external appearance views of the apparatus body 1A. FIGS. 7A and 7B are cross-sectional views of the periphery of the rotary body 90 when replacing the toner cartridge. Note that FIGS. 7A and 7B are cross-sectional views of the apparatus taken along a virtual plane perpendicular to the rotation axis 90c of the rotary body 90.

FIG. 6A illustrates an external appearance of the apparatus body 1A during an image forming operation and in a standby state. The period during the image forming operation refers to a period during which the image forming apparatus 1 executes a series of operations from feeding a sheet S to forming an image on the sheet S and then discharging the sheet S as an output sheet. The standby state refers to a state in which the image forming apparatus 1 is ready to start an image forming operation upon receiving an image formation instruction (print instruction), and is waiting for an image formation instruction from a user. As illustrated in FIG. 6A, the door 14 is closed during the image forming operation and in the standby state.

FIG. 6B illustrates an external appearance of apparatus body 1A when replacing the toner cartridge. When replacing the toner cartridge, the door 14 is opened, and the tray 80 and the toner cartridge 70 are moved to the outside of the apparatus body 1A.

The toner cartridge 70 is movable with respect to the developing frame 53 of the developing unit 50 between the mounted position and the retracted position retracted from the mounted position. In a state where the toner cartridge 70 is located at the mounted position with respect to the developing frame 53, the discharging opening 71b and the receiving opening 53b face each other as illustrated in FIG. 3. As illustrated in FIGS. 4A and 4B, the rotary body 90 is configured to rotate about the rotation axis 90C to take the development posture or the replacement posture in a state where the toner cartridge 70 is located at the mounted position.

The toner cartridge replacing operation will be described. First, the user instructs the control unit 30 (FIG. 2) of the apparatus body 1A to perform a toner cartridge replacing operation. The instruction for the toner cartridge replacing operation is performed, for example, by an input through an operation panel (operation unit) provided in the apparatus body 1A.

When the control unit 30 receives the instruction for the toner cartridge replacing operation, the rotary body 90 rotates to the replacement posture for the toner cartridge 70 to be replaced (the toner cartridge 70 that has run out of toner) and stops. That is, the control unit 30 rotates the rotary body 90 to the replacement posture for the toner cartridge designated in the instruction for the toner cartridge replacing operation (the black replacement posture for replacing the black toner cartridge 70k in FIG. 4B). In the replacement posture, the tray 80 that supports the toner cartridge 70 for which replacement is instructed faces the opening 16a of the frame 16 of the apparatus body 1A.

For example, the rotary body 90 of FIG. 4A is in the yellow development posture in which the yellow developing roller 51y faces the photosensitive drum 2. At this time, the black toner cartridge 70k and the black tray 80k do not need to face the opening 16a and the door 14. In other words, the toner cartridge 70 and the tray 80 do not need to face the opening 16a and the door 14 when the rotary body 90 is in a replacement posture other than the replacement posture for that toner cartridge or in a development posture. Therefore, the opening 16a only needs to have a size that allows each toner cartridge 70 to pass therethrough individually. When the rotary body 90 rotates clockwise in the drawing by a predetermined angle from the yellow development posture, the black toner cartridge 70k and the tray 80k face the opening 16a and the door 14 as illustrated in FIG. 4B.

Here, the wording “the tray 80 faces the opening 16a” means that the tray 80 is positioned so as to be movable to the outside of the apparatus body 1A via the opening 16a. That is, when the tray 80 faces the opening 16a, the tray 80 is moved outward in the rotation radius direction of the rotary body 90 by a movement mechanism, which will be described below, so that the tray 80 and the toner cartridge 70 supported by the tray 80 can protrude to the outside of the apparatus body 1A. In FIG. 4A, none of the trays 80y to 80k faces the opening 16a. In FIG. 4B, only the black tray 80k faces the opening 16a, and the other trays 80y to 80c do not face the opening 16a.

When the rotary body 90 is positioned in the replacement posture, the tray 80 supporting the toner cartridge 70 to be replaced is moved toward the outside of the apparatus body 1A by the motor M2.

As a result, the toner cartridge 70 to be replaced moves from the mounted position to the retracted position with respect to the rotary body 90. As illustrated in FIGS. 6B and 6C and FIGS. 7A and 7B, the tray 80 and the toner cartridge 70 to be replaced that is supported by the tray 80, protrude to the outside of the apparatus body 1A through the opening 16a.

More specifically, the tray 80 is movable with respect to the rotary body 90 between an accommodated position and a taken-out position. That is, the first tray is movable with respect to the rotary body 90 between the accommodated position and the taken-out position. In addition, the second tray is movable with respect to the rotary body 90 between the accommodated position (third position) and the taken-out position (fourth position). The accommodated position is a position where the tray 80 is accommodated in the rotary body 90. The taken-out position is a position (detached position and replaceable position) where at least a part of the tray 80 protrudes (is exposed) to the outside of the rotary body 90 and the toner cartridge 70 can be taken out from the tray 80. Examples of the accommodated position are positions of the respective trays 80y to 80k in FIGS. 4A and 4B. Examples of the taken-out position are positions of the tray 80 in FIGS. 6B and 6C, the tray 80k in FIG. 7A, and the tray 80m in FIG. 7B.

When the tray 80 is located at the accommodated position, the toner cartridge 70 attached to the tray 80 is located inside the rotary body 90 and is located at the mounted position. When the tray 80 is located at the taken-out position, the toner cartridge 70 attached to the tray 80 is located outside the rotary body 90 and is located at the retracted position.

Here, as illustrated in FIGS. 7A and 7B, the rotary body 90 has a protrusion 95 for holding the tray 80 at the accommodated position and holding the toner cartridge 70 at the mounted position. As illustrated in FIG. 8, the tray 80 has a recess 87 into which the protrusion 95 is fitted. Although protrusions 95k and 95m corresponding to the trays 80k and 80m are illustrated in FIGS. 7A and 7B, and recesses 87y and 87m of the trays 80y and 80m are illustrated in FIG. 8, the protrusion 95 and the recess 87 are provided for each of the trays 80y to 80k. The protrusion 95 is preferably biased in a direction in which it is engaged with the recess 87.

The tray 80 is locked to the rotary frame 90f by fitting the protrusion 95 into the recess 87 of the tray 80. As a result, even if the rotary body 90 rotates, the tray 80 remains located at the accommodated position, and the toner cartridge 70 is prevented from moving from the mounted position. Note that, in a case where the tray 80 is moved between the accommodated position and the taken-out position by a moving device, which will be described below, the protrusion 95 is moved by the tray 80, so that the protrusion 95 can come out of the recess 87.

In the present embodiment, the door 14 is supported so as to be pivotable with respect to the apparatus body 1A. As illustrated in FIG. 7A, the door 14 is biased by a spring 14s from the open position toward the closed position. The spring 14s is, for example, a tension spring, and biases the door 14 so as to generate a moment in the counterclockwise direction in FIGS. 7A and 7B about a support shaft 14c of the door 14.

When the tray 80 pushes the door 14, the door 14 is brought into the open state (the state in FIG. 6B). This state can also be said to be a state in which the tray 80 is supported by the door 14. At least a part of the tray 80 protruding to the outside of the apparatus body 1A is supported by the door 14, thereby making it possible to more stably support the toner cartridge 70. In other words, when the first toner cartridge (toner cartridge 70k) is located at the first retracted position, the opening/closing member (door 14) located at the open position supports the first support member (tray 80k). When the second toner cartridge (toner cartridges 70y to 70c) is located at the second retracted position, the opening/closing member (door 14) located at the open position supports the second support member (trays 80y to 80c).

The door 14 is configured to come into contact with a part of the frame 16 of the apparatus body 1A (e.g., a lower edge 16c of the opening 16a) at the open position, so as not to pivot downward beyond the open position. When the tray 80 is pulled back from the outside to the inside of the apparatus body 1A, the door 14 returns to the closed position by the biasing force of the spring 14s.

The toner cartridge 70 is detachably held on the tray 80. Therefore, as illustrated in FIG. 6C, the user can perform an operation (replacement operation) of detaching the toner cartridge 70 from the tray 80 and attaching a new toner cartridge 70 to the tray 80. When replacing a plurality of toner cartridges 70, the replacement operation can be performed by repeating the above-described operation.

FIGS. 7A and 7B illustrate cross sections of the periphery of the rotary body 90 when replacing the toner cartridge. FIG. 7A illustrates a state when replacing the black toner cartridge 70k. FIG. 7B illustrates a state when replacing the magenta toner cartridge 70m.

The image forming apparatus 1 includes moving devices 85y, 85m, 85c, and 85k (FIG. 8) that move the toner cartridges 70y, 70m, 70c, and 70k from the respective mounted positions to the respective retracted positions. The term “moving device 85”, in which the suffix is omitted, usually indicates any one of the moving devices 85y, 85m, 85c, and 85k. In the present embodiment, it can be said that the moving device 85 includes the tray 80. The moving device 85k including the tray 80k can be said to be an example of a first moving device including the first support member. The moving device 85m including the tray 80m can be said to be an example of a second moving device including the second support member.

Even in a state where the toner cartridge 70 is located at the retracted position, the tray 80 is connected to the rotary body 90 (supported by the rotary body 90). In order to easily perform the operation of detaching the toner cartridge 70 from the rotary body 90, it is preferable that the toner cartridge 70 protrudes long from the rotary body 90 at the retracted position. Since the toner cartridge 70 is configured to be attachable to and detachable from the rotary body 90 via the tray 80, the toner cartridge 70 can be stably supported by the tray 80 even if the toner cartridge 70 protrudes long from the rotary body 90.

The movement direction of the toner cartridge 70 when the toner cartridge 70 moves from the mounted position to the retracted position is referred to as a retraction direction. In the present embodiment, the retraction direction of the toner cartridge 70 is a direction intersecting the direction of the rotation axis 90C (Y direction). Therefore, as illustrated in FIGS. 7A and 7B, when viewed in the direction of the rotation axis 90C (Y direction), the retraction direction of the toner cartridge 70 is a direction orthogonal to the direction of the rotation axis 90C (Y direction). In addition, it can be said that the retraction direction of the toner cartridge 70 is a direction toward the outside in the rotation radius direction of the rotary body 90 (a direction away from the rotation axis 90C).

As illustrated in FIGS. 7A and 7B, since the user performs the operation of detaching the toner cartridge 70 from the rotary body 90, it is preferable that at least a part of the toner cartridge 70 protrudes from the rotary body 90 when detaching the toner cartridge 70. In the present embodiment, when the toner cartridge 70 is located at the retracted position, the entire toner cartridge 70 protrudes from the rotary body 90.

It can be said that, when the rotary body 90 rotates about the rotation axis 90C, the rotation locus of the rotary body 90 coincides with the circumscribed circle of the rotary body 90 with the rotation axis 90C being its center (a virtual circle 90V indicated by a broken line in FIGS. 7A and 7B). It is preferable that, when the toner cartridge 70 is located at the retracted position, half or more of the length of the toner cartridge 70 in the retraction direction is located outside the rotation locus of the rotary body 90. That is, it is preferable that, when viewed in the rotation axis direction of the rotary, half or more of the total length of the toner cartridge is located outside the rotation locus of the rotary in the movement direction of the toner cartridge from the mounted position to the retracted position, in a state where the toner cartridge is located at the retracted position. This applies to each toner cartridge 70 including the toner cartridge 70k, which is an example of a first cartridge, and the toner cartridge 70m, which is an example of a second cartridge. In the present embodiment, as illustrated in FIGS. 7A and 7B, when the toner cartridge 70 is located at the retracted position, the entire toner cartridge 70 is located outside the rotation locus (virtual circle 90V) of the rotary body 90.

Furthermore, in order to make it easy for the user to grasp the toner cartridge 70, it is preferable that, when the toner cartridge 70 is located at the retracted position, at least a part of the toner cartridge 70 is located outside the image forming apparatus 1 (outside the apparatus body 1A). Here, the outside of the apparatus refers to a space outside the image forming apparatus 1 (outside the apparatus body 1A) when the image forming apparatus 1 is used, for example, for an image forming operation on the sheet S.

In the present embodiment, the external appearance surface of the apparatus body 1A is formed by an external appearance surface of the frame 16. That is, the outside of the apparatus can also be said to be the outside of the frame 16. Therefore, the state in which at least a part of the toner cartridge 70 is located outside the apparatus can also be said to be a state in which at least a part of the toner cartridge 70 protrudes from the opening 16a of the frame 16 of the apparatus body 1A toward the outside of the frame 16.

In the present embodiment, when the door 14 is located at the closed position, the opening 16a of the frame 16 of the apparatus body 1A is covered with the door 14. Then, a part of the external appearance surface of the apparatus body 1A is formed by an external appearance surface 14a of the door 14 located at the closed position. In this case, the outside of the apparatus refers to the outside of the external appearance surface 14a of the door 14 located at the closed position. That is, while the position of the external appearance surface 14a of the door 14 located at the closed position is defined as an external appearance position, when the toner cartridge 70 is located at the retracted position, at least a part of the toner cartridge 70 is located outside the apparatus body 1A beyond this external appearance position.

In other words, at least a part of the toner cartridge 70 is located in a space outside the apparatus body 1A if the door 14 is located at the closed position. Then, at least a part of the toner cartridge 70 in the retraction direction of the toner cartridge 70 is located downstream of the external appearance position.

In addition, while the side surface 16b on which the opening 16a is provided is defined as a front surface of the apparatus body 1A, it can be said that, when the toner cartridge 70 is located at the retracted position, at least a part of the toner cartridge 70 protrudes toward the front surface side beyond the external appearance surface on the front surface side of the apparatus body 1A. In this case, the user can easily replace the toner cartridge 70 by accessing the toner cartridge 70 from the front surface side of the image forming apparatus.

Note that it is preferable that, when the toner cartridge 70 is located at the retracted position, half or more of the length of the toner cartridge 70 in the retraction direction is located outside the apparatus. That is, it is preferable that, when viewed in the rotation axis direction of the rotary, half or more of the total length of the toner cartridge is located outside the body frame in the movement direction of the toner cartridge from the mounted position to the retracted position, in a state where the toner cartridge is located at the retracted position. This applies to each toner cartridge 70 including the toner cartridge 70k, which is an example of a first cartridge, and the toner cartridge 70m, which is an example of a second cartridge. Further, it is more preferable that, when the toner cartridge 70 is located at the retracted position, the entire toner cartridge 70 is located outside the apparatus. In the present embodiment, the external appearance surface on the front surface side of the apparatus body 1A is formed by the external appearance surface 14a of the door 14 and the side surface 16b, but the configuration of the door 14 is not limited thereto. For example, the size of the door 14 may be set to a size that covers the entire side surface 16b. In this case, the external appearance surface on the front surface side of the apparatus body 1A is formed by the external appearance surface 14a of the door 14.

The tray 80 includes a cartridge holding portion 81 (see FIG. 3 and FIG. 6C) that holds the toner cartridge 70. The cartridge holding portion 81 is a mounted portion on which the toner cartridge 70 is mounted. It is preferable that, when the tray 80 is located at the taken-out position, the entire cartridge holding portion 81 is located outside the rotation locus of the rotary body 90 in the retraction direction. It is preferable that, when the tray 80 is located at the taken-out position, half or more of the length of the cartridge holding portion 81 is located outside the apparatus in the retraction direction.

Here, as described above, the toner cartridge 70k and the tray 80k are larger in size than the other toner cartridges 70y to 70c and the trays 80y to 80c. Therefore, as illustrated in FIGS. 7A and 7B, in the present embodiment, the amount of movement of the tray 80 when replacing the toner cartridge is changed in accordance with the size of the toner cartridge 70.

Specifically, as illustrated in FIG. 7A, a movement distance when the tray 80k (first support member) moves from the accommodated position (first accommodated position) to the taken-out position (first taken-out position) is defined as L1. A movement distance when the tray 80m (second support member) moves from the accommodated position (second accommodated position) to the taken-out position (second taken-out position) is defined as L2. Although FIG. 7B illustrates a state in which the toner cartridge 70m and the tray 80m have moved, movement distances when the trays 80y and 80c move from the accommodated position to the taken-out position are also defined as L2. At this time, L1 is larger than L2. In other words, it can be said that the movement distance of the first support member when the first toner cartridge moves from the first mounted position to the first retracted position is longer than the movement distance of the second support member when the second toner cartridge moves from the second mounted position to the second retracted position.

As illustrated in FIG. 7A, in a state where the tray 80k is located at the taken-out position and the toner cartridge 70k is located at the retracted position, the toner cartridge 70k protrudes to the outside of the apparatus from the external appearance surface of the apparatus body 1A by a distance P1. In the present embodiment, the tray 80k also protrudes to the outside of the apparatus from the external appearance surface of the apparatus body 1A by the distance P1.

Further, as illustrated in FIG. 7B, in a state where the tray 80m is located at the taken-out position and the toner cartridge 70m is located at the retracted position, the toner cartridge 70m protrudes to the outside of the apparatus from the external appearance surface of the apparatus body 1A by a distance P2. In the present embodiment, the tray 80m also protrudes to the outside of the apparatus from the external appearance surface of the apparatus body 1A by the distance P2. The toner cartridges 70y and 70c also protrude to the outside of the apparatus from the external appearance surface of the apparatus body 1A by the distance P2.

The distance P1 is larger than the distance P2. That is, a length by which the first toner cartridge located at the first retracted position protrudes from the opening 16a of the apparatus body 1A is defined as a first length (P1), and a length by which the second toner cartridge located at the second retracted position protrudes from the opening 16a is defined as a second length (P2). In this case, it can be said that the first length is longer than the second length.

In terms of strength, it is preferable that the distance P2 by which the toner cartridges 70y to 70c having a smaller size than the toner cartridge 70k protrude to the outside of the apparatus at the retracted position is shorter than the distance P1 by which the toner cartridge 70k protrudes to the outside of the apparatus at the retracted position. This is for the following reason. When the toner cartridge 70 is located at the retracted position, at least a part of the toner cartridge 70 protrudes to the outside of the apparatus from the outside of the rotation locus of the rotary body 90 or from the external appearance surface of the apparatus body 1A. At this time, the tray 80 supports the weight of the toner cartridge 70 while being cantilevered by the rotary body 90. Therefore, by shortening the distance P2 by which the toner cartridges 70y to 70c protrude to the outside of the apparatus at the retracted position, it is possible to reduce the load applied to the trays 80y to 80c and guiding portions 97 of the rotary body 90 that support the trays 80y to 80k. In addition, since the toner cartridges 70y to 70c are smaller in size than the toner cartridge 70k, it is possible to maintain the workability of cartridge replacement with respect to the trays 80y to 80c even if the distance P2 is shorter than the distance P1.

### Tray Arrangement in Rotary

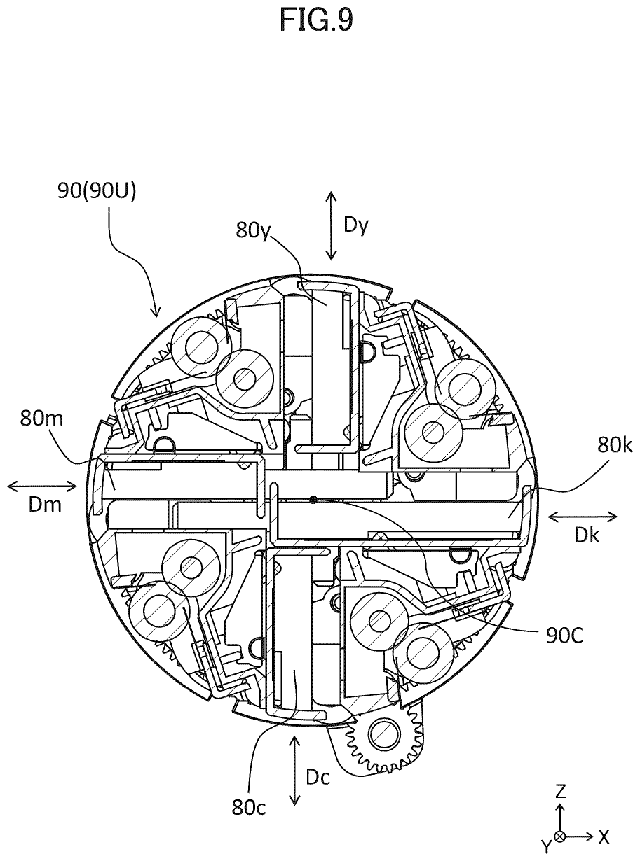

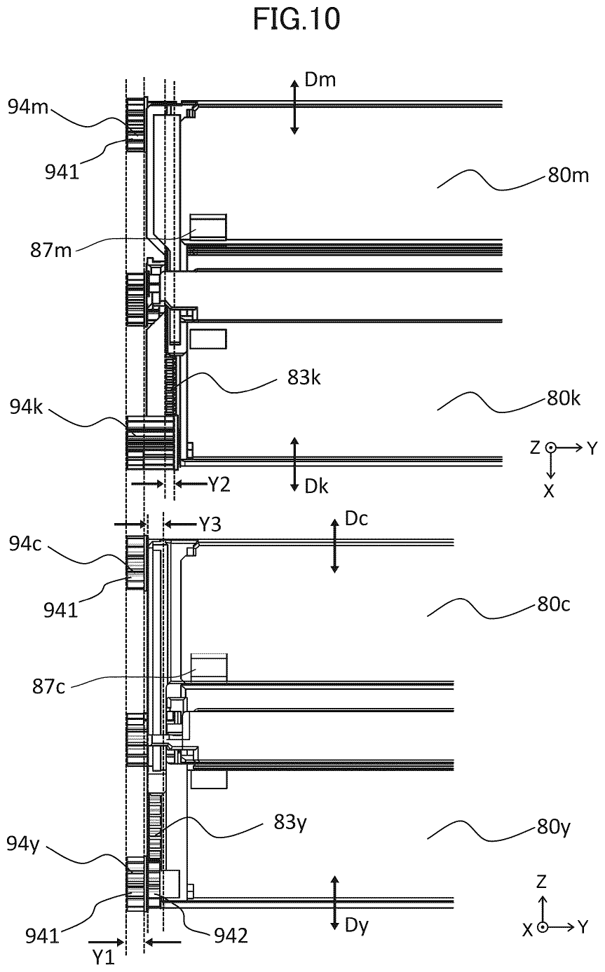

The arrangement of the trays 80y to 80k in the rotary body 90 will be described with reference to FIGS. 8, 9, and 10. FIG. 8 is a perspective view illustrating the arrangement of the trays 80y to 80k in the rotary body 90. FIG. 9 is a cross-sectional view illustrating the arrangement of the trays 80y to 80k in the rotary body 90. FIG. 10 is a view illustrating member arrangement on one end side in the Y direction of the trays 80y to 80k. Note that FIG. 9 illustrates a cross section of the rotary body 90 taken along a virtual plane perpendicular to the rotation axis 90C of the rotary body 90. In addition, the upper half portion of FIG. 10 is a view of the rotary body 90 and the trays 80m and 80k of FIG. 8 as viewed from the upper right side (+Z side) of FIG. 8, and the lower half portion of FIG. 10 is a view of the rotary body 90 and the trays 80c and 80y of FIG. 8 as viewed from the left side (−X side) of FIG. 8. As illustrated in FIG. 8, the trays 80y to 80k have cartridge holding portions 81y to 81k and guided portions 82y to 82k, respectively.

The toner cartridges 70y to 70k are mounted on the cartridge holding portions 81y to 81k, respectively. The cartridge holding portions 81y to 81k accommodate at least parts of the toner cartridges 70y to 70k mounted thereon.

The guided portions 82y to 82k are provided at both ends in the Y direction of the trays 80y to 80k, with the cartridge holding portions 81y to 81k interposed therebetween. Each of the guided portions 82y to 82k is a member elongated in a direction orthogonal to the rotation axis of the rotary body 90.

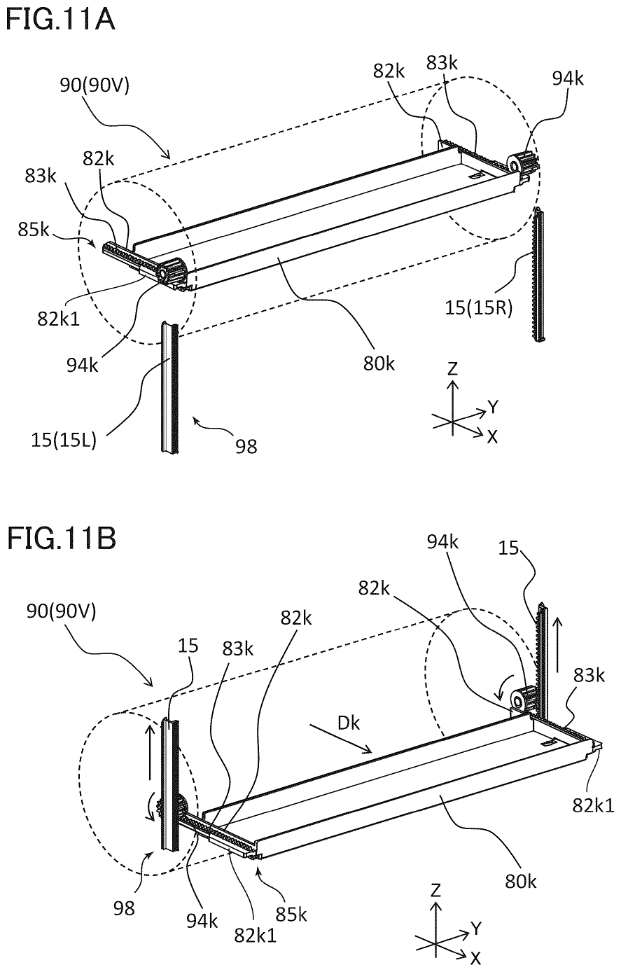

In the present embodiment, a reinforcing rib 82k1 is formed in a part of the guided portion 82k in a movement direction Dk of the tray 80k, and a reinforcing rib 82m1 is formed in a part of the guided portion 82m in a movement direction Dm of the tray 80m (see also FIGS. 11A and 11B). The reinforcing ribs 82k1 and 82m1 have rib shapes (ridges) protruding outward in the Y direction from the guided portions 82k and 82m provided at both ends in the Y direction of the trays 80k and 80m and elongated in the movement directions Dk and Dm of the trays 80k and 80m. The rigidity of the guided portions 82k and 82m is improved by the reinforcing ribs 82k1 and 82m1.

Note that, in the present embodiment, although the lengths of the reinforcing ribs 82m1 and 82k1 are limited to avoid the guided portions 82y and 82c, the reinforcing ribs 82m1 and 82k1 may be provided over the entire lengths of the guided portions 82m and 82k as long as they do not interfere with the guided portions 82y and 82c. Reinforcing ribs may be added to the guided portions 82y and 82c. When the guided portions 82m and 82k have sufficient rigidity, the reinforcing ribs 82m1 and 82k1 may not be provided.

Rack portions 83y to 83k (rack gears) are formed in the guided portions 82y to 82k. In addition, pinion gears 94y to 94k are rotatably held in the rotary body 90. The pinion gears 94y to 94k mesh with the rack portions 83y to 83k so as to be drive-transmittable.

One or more rack portions 83y are provided in the tray 80y. One or more pinion gears 94y corresponding to the one or more rack portions 83y are provided in the rotary body 90. Similarly, one or more rack portions 83m, one or more rack portions 83c, and one or more rack portions 83k are provided in the tray 80m, the tray 80c, and the tray 80k, respectively. One or more pinion gears 94m, one or more pinion gears 94c, and one or more pinion gears 94k corresponding to the one or more rack portions 83m, the one or more rack portions 83c, and the one or more rack portions 83k, respectively, are provided in the rotary body 90.

The rack portions 83y to 83k and the pinion gears 94y to 94k are parts of the moving devices 85y to 85k configured to move the toner cartridges 70y to 70k from their mounted positions to their retracted positions. Further, the rack portions 83y to 83k and the pinion gears 94y to 94k can be said to be parts of driven devices driven by the driving device 98 of the apparatus body 1A. The pinion gears 94y to 94k can be said to be rotary members (rotating members) that move the trays 80y to 80k with respect to the rotary body 90 by rotating.

The moving devices 85y to 85k are driven by the driving device 98 of the apparatus body 1A. The pinion gears 94y to 94k and the rack portions 83y to 83k function as driven units for the moving devices 85y to 85k of the rotary body 90 to receive a driving force from the driving device 98 of the apparatus body 1A. The pinion gear 94k and the rack portion 83k are examples of a first pinion gear and a first rack gear constituting at least a part of a first driven unit included in the first moving device. The pinion gear 94m and the rack portion 83m are examples of a second pinion gear and a second rack gear constituting at least a part of a second driven unit included in the second moving device.

The rotary body 90 includes guiding portions 97 (see FIGS. 7A and 7B) engaged with the respective guided portions 82y to 82k. FIG. 7A illustrates the guiding portion 97 (97k) engaged with the guided portion 82k of the tray 80k, and FIG. 7B illustrates the guiding portion 97 (97m) engaged with the guided portion 82m of the tray 80m. Similar guiding portions engaged with the guided portions 82y and 82c of the trays 80y and 80c are provided in the rotary body 90. Although the guiding portions 97 provided on one side (+Y side) in the Y direction of the rotary body 90 are illustrated in FIGS. 7A and 7B, similar guiding portions 97 are also provided on the other side (−Y side) in the Y direction of the rotary body 90.

When the tray 80 moves between the accommodated position and the taken-out position, the guiding portion 97 remains engaged with the guided portion 82 in at least a part of a movement range, and guides the tray 80 in the movement direction. In the present embodiment, the guiding portion 97 remains engaged with the guided portion 82k in the entire movement range between the accommodated position and the taken-out position of the tray 80k. In addition, in the present embodiment, the guiding portion 97 remains engaged with the guided portion 82m in the entire movement range between the accommodated position and the taken-out position of the tray 80m. As illustrated in FIGS. 8 and 9, the four trays 80y to 80k are arranged in the rotary body 90 so as to overlap each other as will be specifically described below.

When the pinion gears 94y to 94k rotate, the rack portions 83y to 83k and the trays 80y to 80k move with respect to the rotary body 90. As illustrated in FIG. 9, the four trays 80y to 80k are arranged such that their respective movement directions are rotated by 90 degrees from one another with respect to the rotary body 90. Therefore, the tray 80y and the tray 80c, and the tray 80m and the tray 80k are held so as to be movable in a sliding manner in substantially the same direction (parallel direction). The movement direction of each of the trays 80y to 80k during sliding movement is restricted by the engagement between the guided portions 82y to 82k and the guiding portions 97 described above.

Note that the trays 80y to 80k move to the outside of the apparatus through the opening 16a. When each of the trays 80y to 80k moves from the opening 16a to the outside of the apparatus, the movement directions of the trays are substantially the same direction (parallel).

As illustrated in FIG. 9, in the movement direction Dk of the tray 80k, the range in which the tray 80k is arranged overlaps the range in which the tray 80y is arranged and the range in which the tray 80c is arranged. In addition, in the movement direction Dk of the tray 80k, the range in which the tray 80k is arranged overlaps the rotation axis 90C of the rotary body 90. That is, it can be said that the toner cartridge 70k held on the cartridge holding portion 81k of the tray 80k overlaps the rotation axis 90C of the rotary body 90 (FIG. 4B).

On the other hand, in the movement direction Dm of the tray 80m, the range in which the tray 80m is arranged is shifted so as not to overlap the range in which the tray 80y is arranged and the range in which the tray 80c is arranged. Further, in a movement direction Dy of the tray 80y, the range in which the tray 80y is arranged is shifted so as not to overlap the range in which the tray 80m is arranged and the range in which the tray 80k is arranged. Similarly, in a movement direction Dc of the tray 80c, the range in which the tray 80c is arranged is shifted so as not to overlap the range in which the tray 80m is arranged and the range in which the tray 80k is arranged.

The positional relationship between the trays 80 can also be expressed as follows. When viewed in the movement direction Dy of the tray 80y, the tray 80y and the tray 80k overlap, but the tray 80y and the tray 80m do not overlap. When viewed in the movement direction Dm of the tray 80m, the tray 80m and the tray 80k overlap, but the tray 80m and the trays 80y and 80c do not overlap. When viewed in the movement direction Dc of the tray 80c, the tray 80c and the tray 80k overlap, but the tray 80c and the tray 80m do not overlap.

Here, two elements (members, parts, units, and the like) overlapping when viewed in a specific direction means that, when each element is vertically projected onto a virtual plane perpendicular to the specific direction, the projection area of one element and the projection area of the other element at least partially overlap.

As illustrated in FIGS. 8 and 10, in the direction of the rotation axis 90C (Y direction), the range in which the rack portion 83m and the guided portion 82m are arranged and the range in which rack portion 83k and the guided portion 82k are arranged at least partially overlap. That is, in the present embodiment, it can be said that, in the rotation axis direction (Y direction) of the rotary, the range in which the first rack gear (rack portion 83k) is arranged and the range in which the second rack gear (rack portion 83m) is arranged at least partially overlap. Therefore, as compared with the arrangement in which the rack portion 83m and the guided portion 82m do not overlap the rack portion 83k and the guided portion 82k, the rack portions 83m and 83k and the guided portions 82m and 82k can be arranged in a space-saving manner in the Y direction.

In the direction of the rotation axis 90C (Y direction), the range in which the rack portion 83y and the guided portion 82y are arranged and the range in which the rack portion 83c and the guided portion 82c are arranged at least partially overlap. That is, in the present embodiment, in the rotation axis direction (Y direction) of the rotary, the range in which the third rack gear (rack portion 83y) is arranged and the range in which the fourth rack gear (rack portion 83c) is arranged at least partially overlap. Therefore, as compared with the arrangement in which the rack portion 83y and the guided portion 82y do not overlap the rack portion 83c and the guided portion 82c, the rack portions 83y and 83c and the guided portions 82y and 82c can be arranged in a space-saving manner in the Y direction.

Here, a meshing position between the rack portion (rack gear) 83 and the pinion gear 94 will be described with reference to FIG. 10. The upper half portion of FIG. 10 illustrates a meshing position between the rack portion 83k and the pinion gear 94k. The lower half portion of FIG. 10 illustrates a meshing position between the rack portion 83y and the pinion gear 94y.

In the direction (Y direction) of the rotation axis 90C of the rotary body 90, a driving force transmitted from the motor M2 (FIG. 2) serving as a drive source by a transmission device, which will be described below, is transmitted to the pinion gears 94y to 94k in an area Y1 in the drawing. In an area Y2 in the drawing in the Y direction, the pinion gear 94k meshes with the rack portion 83k so as to be drive-transmittable. In an area Y3 in the drawing in the Y direction, the pinion gear 94y meshes with the rack portion 83y so as to be drive-transmittable. Similarly to the rack portion 83k, the rack portion 83m meshes with the pinion gear 94m (FIG. 8) in the area Y2 so as to be drive-transmittable. Similarly to the rack portion 83y, the rack portion 83c meshes with the pinion gear 94c (FIG. 8) in the area Y3 so as to be drive-transmittable.

Here, the area Y2 and the area Y3 are located at different positions in the Y direction (shifted in the Y direction). The area Y1 is located at a different position in the Y direction from both the area Y2 and the area Y3. That is, the area Y1 is shifted in the Y direction with respect to the area Y2 and the area Y3.

Further, in a state where the toner cartridges 70y and 70c are located at the mounted positions, the range in which the rack portion 83y is arranged and the range in which the rack portion 83c is arranged at least partially overlap in the movement direction of the rack portion 83y (the movement direction Dy of the tray 80y). In the present embodiment, since the movement directions Dy and Dc of the trays 80y and 80c are substantially the same direction (parallel), in the movement direction Dc of the tray 80c as well, the range in which the rack portion 83y is arranged and the range in which the rack portion 83c is arranged at least partially overlap. Therefore, in the state where the toner cartridges 70y and 70c are located at the mounted positions, a tooth surface of the rack portion 83y and a tooth surface of the rack portion 83c face each other in a direction (the left-right direction in FIG. 8) orthogonal to the movement directions Dy and Dc of the rack portions 83y and 83c.

Further, in a state where the toner cartridges 70m and 70k are located at the mounted positions, the range in which the rack portion 83m is arranged and the range in which the rack portion 83k is arranged at least partially overlap in the movement direction of the rack portion 83m (the movement direction Dm of the tray 80m). In the present embodiment, since the movement directions Dm and Dk of the trays 80m and 80k are substantially the same direction (parallel), the range in which the rack portion 83m is arranged and the range in which the rack portion 83k is disposed at least partially overlap in the movement direction Dk of the tray 80k as well. Therefore, in the state where the toner cartridges 70m and 70k are located at the mounted positions, a tooth surface of the rack portion 83m and a tooth surface of the rack portion 83k face each other in a direction (the up-down direction in FIG. 8) orthogonal to the movement directions Dm and Dk of the rack portion 83m and 83k.

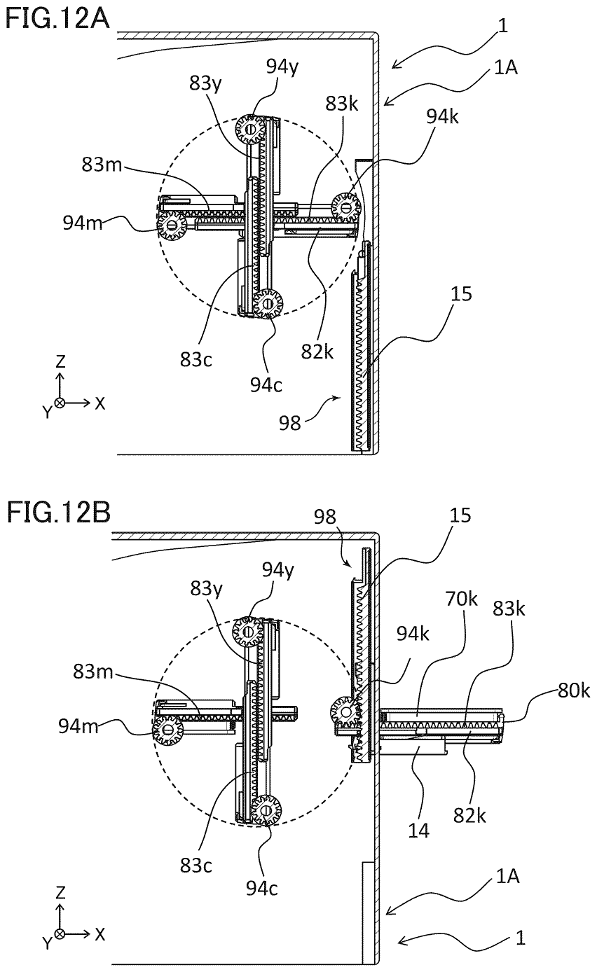

As also illustrated in FIG. 12A, which will be described below, when viewed in the direction of the rotation axis 90C (Y direction), the rack portion 83y overlaps the rack portion 83m and the rack portion 83k. When viewed in the direction of the rotation axis 90C (Y direction), the rack portion 83m overlaps the rack portion 83y and the rack portion 83c. When viewed in the direction of the rotation axis 90C (Y direction), the rack portion 83c overlaps the rack portion 83m and the rack portion 83k. When viewed in the direction of the rotation axis 90C (Y direction), the rack portion 83k overlaps the rack portion 83y and the rack portion 83c. In other words, it can be said that, in the rotation axis direction (Y direction) of the rotary, the range in which the first rack gear (rack portion 83k) is arranged and the range in which the second rack gear (rack portion 83y) is arranged do not overlap each other. In addition, it can be said that, when viewed in the rotation axis direction (Y direction) of the rotary, the first rack gear (rack portion 83k) and the second rack gear (rack portion 83y) overlap in a state where the first toner cartridge 70k is located at the first mounted position and the second toner cartridge 70y is located at the second mounted position.

In this manner, since the position where the rack portions 83k and 83m are disposed is different from the position where the rack portions 83y and 83c are disposed in the Y direction, the rack portions 83y and 83c and the rack portions 83m and 83k can be disposed so as to overlap each other when viewed in the Y direction.

As a result, the four trays can be arranged in the rotary body 90 in a space-saving manner, thereby reducing the size of the rotary body 90 in the rotation radius direction. That is, if the trays 80y to 80k are arranged such that the rack portions 83 do not overlap each other when viewed in the Y direction while the movement distances of the trays 80y to 80k are equal to those in the present embodiment, the area required for arranging the four rack portions when viewed in the Y direction increases. As compared with such a configuration, by arranging the plurality of rack portions 83 such that their positions in the Y direction are shifted, and the rack portions 83 overlap each other when viewed in the Y direction, the area for arranging the rack portions 83 when viewed in the Y direction can be reduced.

Further, in the present embodiment, the four rack portions 83y to 83k are arranged in two pairs, each including two rack portions, with their positions shifted in the Y direction. That is, it can be said that, in the rotation axis direction (Y direction) of the rotary, the ranges in which the first rack gear and the second rack gear are arranged overlap, and the ranges in which the third rack gear and the fourth rack gear are arranged overlap. In addition, it can be said that, in the Y direction, the ranges in which the first rack gear and the second rack gear are arranged and the ranges in which the third rack gear and the fourth rack gear are arranged do not overlap. As a result, it is possible to reduce the size of the rotary body 90 in the Y direction as compared with that in a case where the positions of the four rack portions 83y to 83k are each shifted in the Y direction.

### Tray Movement Configuration

A configuration related to the movement of the trays 80y to 80k arranged in the rotary body 90 will be described with reference to FIGS. 11A and 11B and FIGS. 12A and 12B. FIGS. 11A and 11B are perspective views illustrating the configuration related to the movement of the tray 80k. FIGS. 12A and 12B are cross-sectional views illustrating the configuration related to the movement of the tray 80k.

In the present embodiment, the trays 80y to 80k are all driven by the driving force of the motor M2 transmitted to the pinion gears 94y to 94k through the drive racks 15L and 15R serving as transmission devices. Here, the configuration for moving the tray 80k with respect to the rotary body 90 will be described, and the configurations for moving the trays 80y to 80c with respect to the rotary body 90, which are substantially the same as the configuration for moving the tray 80k, will not be described.

FIG. 11A illustrates a state in which the tray 80k is located inside the rotary body 90 (that is, a state in which the toner cartridge 70k is mounted on the developing unit 50k). That is, FIG. 11A illustrates a state in which the tray 80k is located at the accommodated position, and corresponds to a state in which the toner cartridge 70k is located at the mounted position with respect to the developing frame 53k (FIG. 4A). FIG. 11B illustrates a state in which the tray 80k has moved to the outside of the rotary body 90 in a sliding manner. That is, FIG. 11B illustrates a state in which the tray 80k is located at the taken-out position, and corresponds to a state in which the toner cartridge 70k is located at the retracted position with respect to the developing frame 53k (FIG. 4A).

The apparatus body 1A according to the present embodiment includes drive racks 15L and 15R serving as drive gears that drive the pinion gears 94. Each of the drive racks 15L and 15R is driven by the motor M2 via the transmission unit 15t. As illustrated in FIG. 11A, in a state where the tray 80k is located inside the rotary body 90 (that is, in a state where the toner cartridge 70k is mounted on the developing unit 50k), the drive racks 15L and 15R are located at disengaged positions away from the pinion gear 94k. The drive racks 15L and 15R move from the disengaged positions and become engaged with the pinion gear 94k such that the tray 80k moves from the accommodated position to the taken-out position, and the toner cartridge 70k moves from the mounted position to the retracted position.

As described above, two rack portions 83k are formed at both ends in the Y direction of the tray 80k. Two pinion gears 94k and two drive racks 15L and 15R are arranged at positions corresponding to the rack portions 83k at both ends, respectively. That is, the apparatus body 1A according to the present embodiment includes drive racks 15L and 15R serving as first and second drive gears. It can be said that the drive rack 15L is an example of a first drive gear, and the drive rack 15R is an example of a second drive gear.

However, the assignment of these numerals is merely used for convenience of explanation, and can be appropriately changed in principle. When it is not necessary to distinguish between the drive racks 15L and 15R, they will be referred to as “drive racks 15”.

The rack portions 83 according to the present embodiment are configured as a pair of rack gears, and the pinion gears 94 according to the present embodiment are configured as a pair of pinion gears. In the present embodiment, the pair of rack gears and the pair of pinion gears are arranged on one end side and the other end side in the Y direction of the support member (tray 80), but may be arranged at other positions. It can be said that the rack portions 83k and the pinion gears 94k of the moving device 85k corresponding to the tray 80k are examples of a first rack gear pair and a first pinion gear pair, respectively.

It can be said that the rack portions 83y to 83c and the pinion gears 94y to 94c of the moving devices 85y to 85c corresponding to the other trays 80y to 80c are examples of a second rack gear pair and a second pinion gear pair, respectively.

One of the pair of rack gears meshes with one of the pair of pinion gears, and the other of the pair of rack gears meshes with the other of the pair of pinion gears. At least one of the pair of pinion gears is driven by the drive rack 15L serving as a first drive rack. In the present embodiment, both the pair of pinion gears are simultaneously driven by the drive racks 15L and 15R serving as a first drive rack and a second drive rack. As a result, it is difficult for the tray 80 to rotate, enabling the toner cartridge 70 to move stably. The tray 80 may have one rack portion 83, and may be moved by one drive rack 15 via one pinion gear 94.

The tray 80k is held so as to be movable in a sliding manner with respect to the rotary body 90 in a direction (that is, the movement direction Dk) parallel to the guided portion 82k. The drive rack 15 is held so as to be movable in a sliding manner with respect to the apparatus body 1A in a direction intersecting the movement direction Dk of the tray 80k. The drive rack 15 is configured to move in a sliding manner (reciprocate) with respect to the apparatus body 1A in a first movement direction (upward in the vertical direction in the present embodiment) and a second movement direction (downward in the vertical direction in the present embodiment) opposite to the first movement direction. That is, the movement direction of the drive rack 15 according to the present embodiment is a direction (preferably, a direction orthogonal to) intersecting both the movement direction Dk of the tray 80k and the direction (Y direction) of the rotation axis 90C of the rotary body 90.

The tray moving operation of moving the tray 80k in a sliding manner between the accommodated position and the taken-out position will be described with reference to FIGS. 11A and 11B. The tray moving operation for the tray 80k is performed by the motor M2 (FIG. 2), the transmission unit 15t, the drive rack 15, the pinion gear 94k, and the rack portion 83k.

First, a tray moving operation (tray pull-out operation) when the toner cartridge 70k is detached from the rotary body 90 will be described. In a state before the tray pull-out operation is started, the drive rack 15 is located below the position where it meshes with the pinion gear 94k (FIG. 11A). In addition, as described above, in the operation of replacing the toner cartridge 70k, the rotary body 90 takes the replacement posture for the toner cartridge 70k (FIG. 4B).

When the tray pull-out operation is started, the drive rack 15 is moved in a sliding manner upward of the apparatus body 1A by the driving force of the motor M2. During the movement of the drive rack 15, the drive rack 15 meshes with the pinion gear 94k, and the pinion gear 94k is driven to rotate.

As illustrated in FIG. 11B, as the pinion gear 94k is driven to rotate in a direction indicated by an arrow in the drawing, a driving force is input to the rack portion 83k meshing with the pinion gear 94k. As a result, the tray 80k is pushed out of the apparatus and moves from the accommodated position to the taken-out position with respect to the rotary body 90. At this time, the tray 80k is guided in a predetermined movement direction Dk by the engagement between the guided portion 82k and the guiding portion 97k (FIG. 7A) of the rotary body 90. As a result of the tray 80k moving from the accommodated position to the taken-out position, the toner cartridge 70k is moved from the mounted position to the retracted position with respect to the developing unit 50k.

In a state where the tray 80k is located at the taken-out position and the toner cartridge 70k is located at the retracted position, the user can attach and detach the toner cartridge 70k to and from the tray 80k.

A tray moving operation (tray pull-in operation and tray insertion operation) when the toner cartridge 70 is attached to the rotary body 90 is performed through a process reverse to that for the tray pull-out operation. For example, when the user operates a predetermined operation unit, the tray pull-in operation is started. When the tray pull-in operation is started, the drive rack 15 is moved in a sliding manner downward of the apparatus body 1A by the driving force of the motor M2. Here, the rotation direction of the motor M2 in the tray pull-in operation is a direction opposite to that in the tray pull-out operation.

As the pinion gear 94k is driven to rotate in a direction opposite to the direction indicated by the arrow in FIG. 11B, a driving force is input to the rack portion 83k meshing with the pinion gear 94k. As a result, the tray 80k is pulled into the apparatus, and moves from the taken-out position to the accommodated position with respect to the rotary body 90.

The tray 80k is guided in the movement direction Dk (a direction opposite to the direction indicated by the arrow in FIG. 11B) by the engagement between the guided portion 82k and the guiding portion 97k (FIG. 7A) of the rotary body 90. As a result of the tray 80k moving from the taken-out position to the accommodated position, the toner cartridge 70k is moved from the retracted position to the mounted position with respect to the developing unit 50k.

Although the movement of the black tray 80k and the toner cartridge 70k has been described above, the other trays 80y to 80c and the other toner cartridges 70y to 70c are also moved by a similar mechanism. That is, in the replacement postures for the respective toner cartridges, the drive rack 15 transmits the driving force to the pinion gears 94y to 94c.

The driving device 98 for driving the moving device 85 provided in the rotary body 90 is constituted by the motor M2 provided in the apparatus body 1A and the transmission device including the drive racks 15 (15L and 15R) and the transmission unit 15t.

As described above, in the present embodiment, the plurality of moving devices 85y to 85k corresponding to the plurality of toner cartridges 70y to 70k are arranged in the rotary body 90. The driving device 98 of the apparatus body 1A is a common driving device that drives the plurality of moving devices 85y to 85k (the plurality of driven devices) of the rotary body 90.

In the present embodiment, the drive target of the driving device 98 is switched by the rotation of the rotary body 90. In other words, the driving device according to the present embodiment includes the drive rack 15 serving as a transmission member that transmits a driving force from the drive source. The driving device can take a state in which the transmission member is engaged with the first driven unit (pinion gear 94k) so as to be drive-transmittable and a state in which the transmission member is engaged with the second driven unit (pinion gear 94m) so as to be drive-transmittable. In addition, the driving device can take a state in which the transmission member is separated from the first driven unit and the second driven unit.

As described above, the pinion gears 94y to 94k are held on the rotary body 90. Therefore, it is preferable that, when the rotary body 90 rotates, the engagement between the pinion gears 94y to 94k and the drive rack 15 is released.

FIG. 12A illustrates a state in which the tray 80k is located inside the rotary body 90 (a state in which the tray 80k is located at the accommodated position). FIG. 12B illustrates a state in which the tray 80k has moved to the outside of the rotary body 90 (a state in which the tray 80k has moved to the taken-out position).

As illustrated in FIG. 12A, when the tray 80k is located inside the rotary body 90, the drive rack 15 is located at a lower portion in the apparatus body 1A. At this time, the drive rack 15 is retracted from the pinion gear 94k. Therefore, the rotary body 90 can be rotated without being obstructed by the drive rack 15. More specifically, the drive rack 15 can be retracted out of the rotation locus of the rotary body 90 indicated by a dotted line in FIGS. 12A and 12B.

As described above, by driving the motor M2 to rotate in the forward and reverse directions, the tray 80 attached to the rotary body 90 can be moved from the accommodated position to the taken-out position and from the taken-out position to the accommodated position with respect to the rotary body 90. That is, the driving device according to the present embodiment not only can drive each moving device of the rotary such that the toner cartridge moves from the mounted position to the retracted position, but also can drive each moving device such that the toner cartridge moves from the retracted position to the mounted position.

Here, as described above, in the present embodiment, the amount of movement of the tray 80 when replacing the toner cartridge is changed in accordance with the size of the toner cartridge 70. Specifically, as illustrated in FIGS. 7A and 7B, the movement distance L1 when the black tray 80k moves from the accommodated position to the taken-out position is longer than the movement distance L2 when the other trays 80y to 80c move from the accommodated positions to the taken-out positions.

Therefore, in the present embodiment, when the toner cartridges 70y to 70k are moved from the mounted positions to the retracted positions, the value obtained by dividing the speed of the rack portion 83k by the speed of the drive rack 15 is larger than the value obtained by dividing the speed of the rack portions 83y to 83c by the speed of the drive rack 15.

For example, as illustrated in FIG. 10, the pinion gear 94y is a stepped gear, and a pitch circle radius of a small-diameter gear 942 that meshes with the rack portion 83y is smaller than a pitch circle radius of a large-diameter gear 941 that meshes with the drive rack 15. Similarly, the pinion gears 94m and 94c are stepped gears. On the other hand, the pinion gear 94k has the same pitch circle radius at a portion that meshes with the drive rack 15 and at a portion that meshes with the rack portion 83k. At this time, the pitch circle radius of the pinion gear 94k can be the same as the pitch circle radius of the large-diameter gears 941 of the pinion gears 94y to 94c. According to this configuration, even though the drive rack 15 moves by the same distance, the movement distance of the rack portion 83k can be larger than the movement distance of the other rack portions 83y to 83c. That is, the movement distance L1 when the black tray 80k moves from the accommodated position to the taken-out position can be longer than the movement distance L2 when the other trays 80y to 80c move from the accommodated positions to the taken-out positions.

Further, since the pinion gears 94y to 94c are stepped gears, the movement distance L1 of the tray 80k can be larger than the movement distance L2 of the other trays 80y to 80c while the pinion gears 94y to 94k receive a driving force from the same drive rack 15.

Instead of (or in combination with) the configuration in which the pinion gears 94y to 94c are stepped gears, the pinion gear 94k may be a stepped gear. In this case, a portion of the pinion gear 94k that meshes with the drive rack 15 may be a small-diameter gear, and a portion of the pinion gear 94k that meshes with the rack portion 83k may be a large-diameter gear having a larger pitch circle radius than the small-diameter gear. In addition, the stepped gear is an example of a speed reduction mechanism, and may be replaced with a known speed reduction mechanism by which an amount of movement of a member on an output side (tray 80 side) is smaller than an amount of movement of a member on an input side (drive source side).

In addition, the amount of movement of the drive rack 15 when the toner cartridge 70k moves from the mounted position to the retracted position may be larger than the amount of movement of the drive rack 15 when toner cartridges 70y to 70c move from the mounted positions to the retracted positions.

Meanwhile, the shorter the distance by which the toner cartridge 70 moves from the mounted position to the retracted position, the shorter the time for the toner cartridge 70 to move, and the shorter the time for the user to wait for the movement of the toner cartridge 70. In the configuration in which the amount of movement of the drive rack 15 with respect to the toner cartridge 70k is larger than the amount of movement of the drive rack 15 with respect to the toner cartridges 70y to 70c as described above, it is possible to shorten the time for the user to wait for the movement of the toner cartridges 70y to 70c.

With the above-described configuration, the movement distance L1 can be longer than the movement distance L2. These configurations can also be used in combination.

In the configuration described above, the driven unit includes the pinion gear 94 that meshes with both the drive rack 15 and the rack portion 83. However, the driven unit may include a gear that meshes with the drive rack 15 and a gear that meshes with the rack portion 83.

The configuration of the moving device 85 that moves the tray 80 is not limited to a so-called rack and pinion configuration. For example, the member corresponding to the pinion gear 94 may be replaced with a roller that rotates when driven by the motor M2, and the tray 80 may be moved by friction between the roller and the tray 80.

In a case where a roller that rotates when driven by the motor M2 is used, the roller and the toner cartridge 70 may be brought into contact with each other. In this case, the toner cartridges 70y to 70k can be directly attached to and detached from the rotary body 90 without passing through the trays 80y to 80k. In this case, the moving device 85 is constituted by the roller.

### Left and Right Connecting Configuration of Tray Drive Mechanism

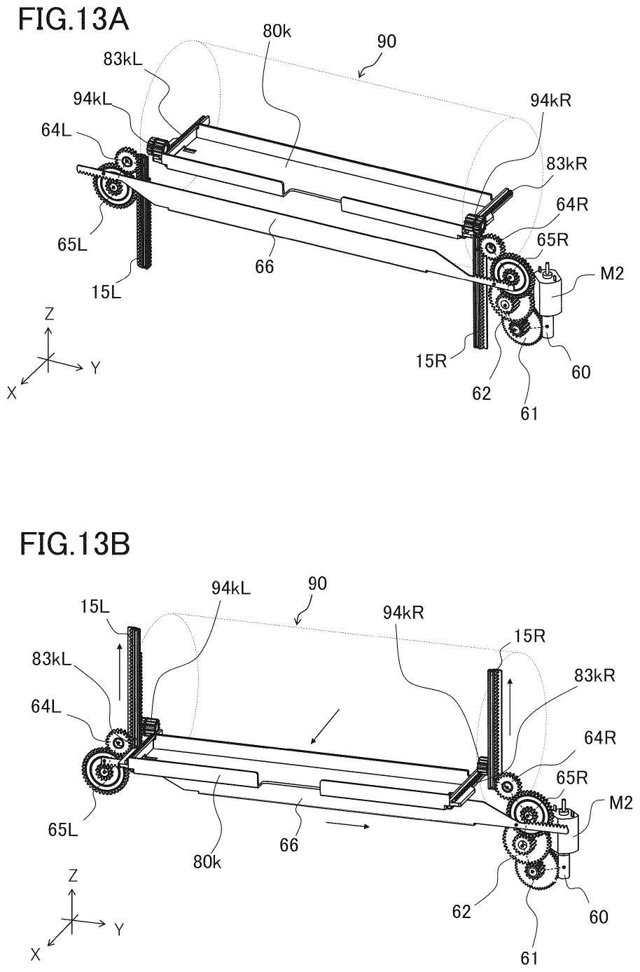

A drive mechanism for moving the tray 80 disposed in the rotary body 90 will be described with reference to FIGS. 13A and 13B. Here, a drive mechanism for moving the tray 80k with respect to the rotary body 90 will be described, and drive mechanisms for moving the trays 80y to 80c, which are substantially the same as the drive mechanism for moving the tray 80k, will not be described.

FIGS. 13A and 13B are perspective views illustrating a configuration of a drive mechanism for the tray 80. FIG. 13A illustrates a state in which the tray 80k is located inside the rotary body 90 (a state in which the tray 80k is located at the accommodated position). FIG. 13B illustrates a state in which the tray 80k has moved to the outside of the rotary body 90 (a state in which the tray 80k is located at the taken-out position). As illustrated in FIGS. 13A and 13B, the drive mechanism for the tray 80k includes a motor M2, a worm gear 60, stepped gears 61 and 62, drive rack input gears 64L and 64R, stepped gears 65L and 65R, and a left-right connecting rack 66.

An operation of the drive mechanism when the tray 80k is moved from the accommodated position (FIG. 13A) to the taken-out position (FIG. 13B) will be described. When the motor M2 is driven to rotate, its driving force is transmitted to the worm gear 60, the stepped gear 61, the stepped gear 62, the stepped gear 65R, and the drive rack input gear 64R in this order. The drive rack 15R is moved in a sliding manner upward (in the +Z direction) of the apparatus body 1A by the drive rack input gear 64R to which the driving force is transmitted from the stepped gear 65R. Here, for convenience of explanation, when the apparatus body 1A is viewed from the +X direction (when viewed from the front surface), the +Y direction side is referred to as a right side, and the −Y direction side is referred to as a left side.

In addition, the left-right connecting rack 66 is moved in a sliding manner rightward (in the +Y direction) of the apparatus body 1A by the stepped gear 65R. The driving force is transmitted to the stepped gear 65L and the drive rack input gear 64L in this order by the left-right connecting rack 66 moved in a sliding manner in the +Y direction, and the drive rack 15L is moved in a sliding manner upward (in the +Z direction) of the apparatus body 1A by the drive rack input gear 64L.

The drive racks 15L and 15R mesh with pinion gears 94kL and 94kR, respectively, in the process of moving upward of the apparatus body 1A, and the pinion gears 94kL and 94kR are driven to rotate. The driving force is transmitted from the pinion gears 94kL and 94kR to rack portions 83kL and 83kR of the tray 80k, respectively, and the tray 80k moves toward the taken-out position outside the rotary body 90.

### Lock Mechanism for Rotary Body

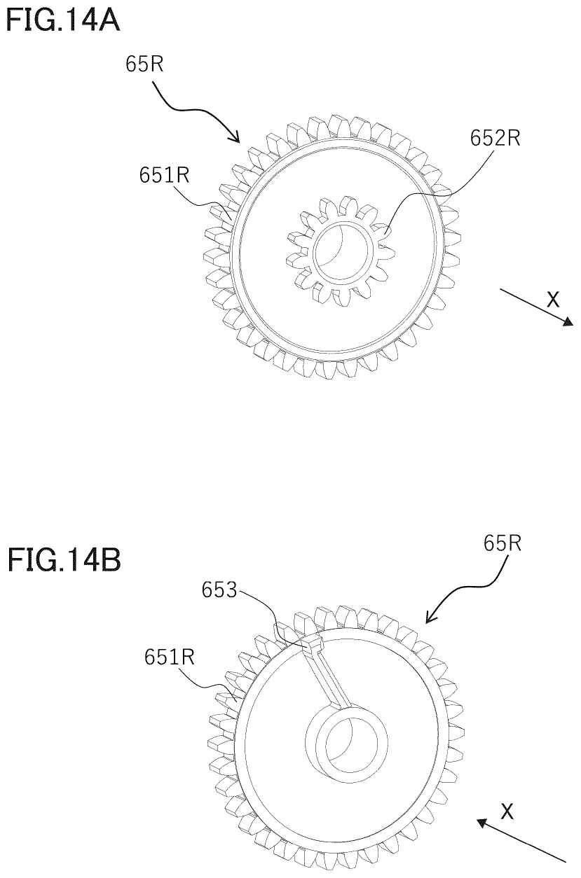

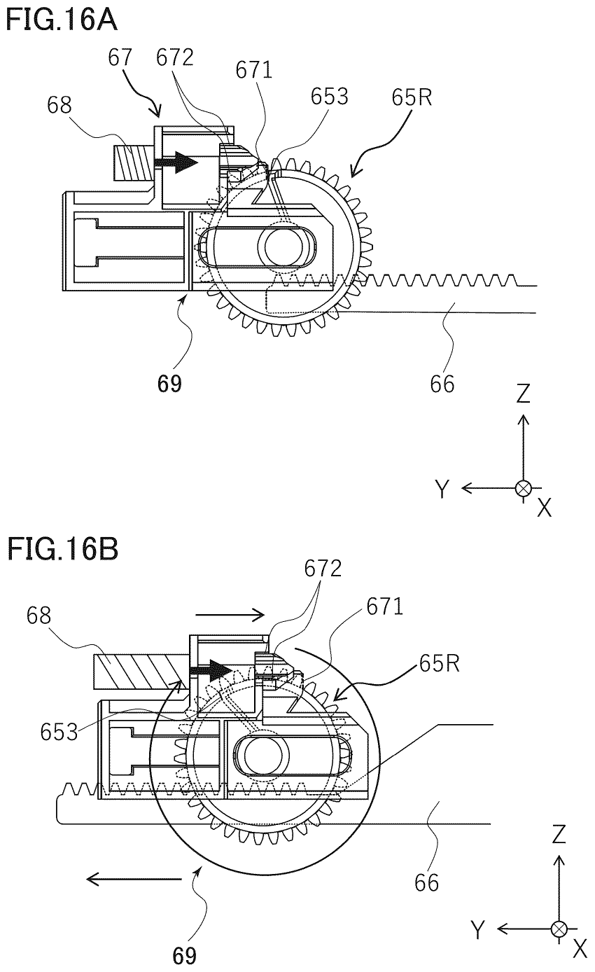

Next, a lock mechanism 69 (see FIG. 16A) for the rotary body 90 will be described with reference to FIGS. 14A to 17B. The lock mechanism 69 restricts the rotation of the rotary body 90 about the rotation axis 90C when the rotary body 90 takes the replacement posture.

Meanwhile, in the present embodiment, since the pinion gear 94 and the drive rack 15 described above mesh with each other when the tray 80 is moved from the accommodated position to the taken-out position, it is preferable that the pinion gear 94 is accurately positioned at a position for meshing with the drive rack 15.

One of the factors that cause the pinion gear 94 to deviate from the meshing position is a variation in position of the rotary body 90 in the yellow/magenta/cyan/black replacement posture. When the pinion gear 94 meshes with the drive rack 15, a tooth surface of the pinion gear 94 receives a force from a tooth surface of the drive rack 15. If the rotary body 90 rotates about the rotation axis 90C by this force, the pinion gear 94 may move from the meshing position. In addition, if the user touches the rotary body 90 and rotates the rotary body 90 in a state where the tray 80 is located at the taken-out position, the pinion gear 94 may move from the meshing position.

Therefore, in the present embodiment, the lock mechanism 69 that locks the rotary body 90 in the rotation direction in the replacement posture is provided. As will be described below, the lock mechanism 69 operates in the process of moving the tray 80 from the accommodated position to the taken-out position to lock the rotary body 90.

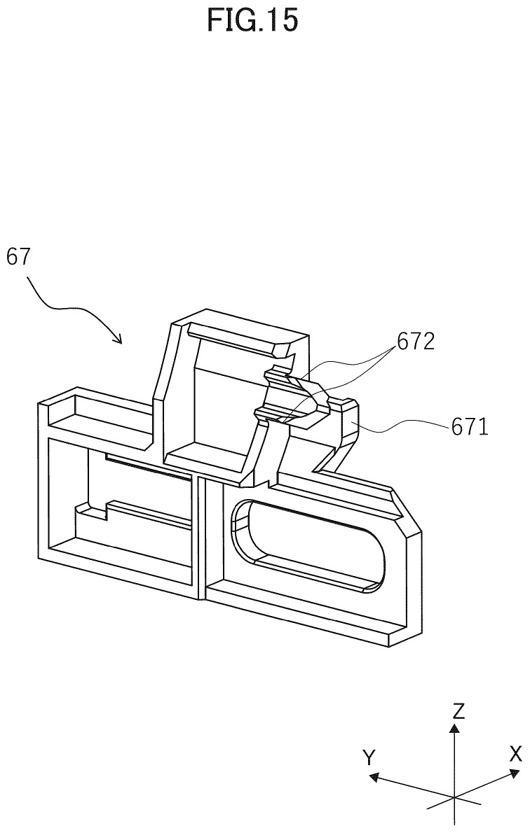

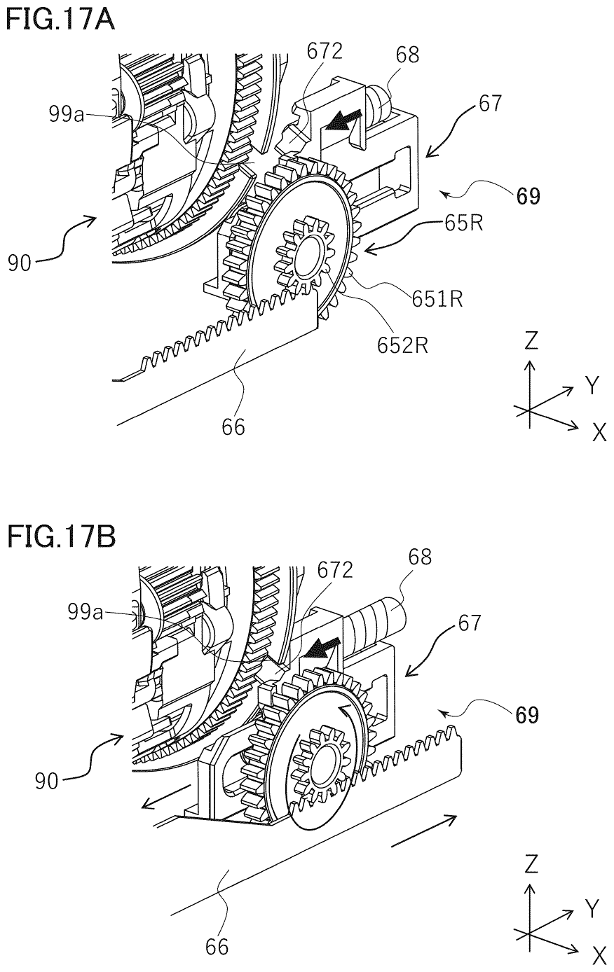

FIGS. 14A and 14B are perspective views illustrating the stepped gear 65R. FIG. 15 is a perspective view illustrating a lock member 67. FIGS. 16A and 16B are front views illustrating an operation of the lock mechanism 69. FIGS. 17A and 17B are perspective views illustrating an operation of the lock mechanism 69. As illustrated in FIGS. 14A and 14B, the stepped gear 65R includes a large-diameter gear 651R, a small-diameter gear 652R that rotates integrally with the large-diameter gear 651R and has fewer teeth than the large-diameter gear 651R, and a pressing portion 653 provided integrally with the large-diameter gear 651R. The pressing portion 653 constitutes a part of the lock mechanism 69, which will be described below.

The lock member 67 illustrated in FIG. 15 also constitutes a part of the lock mechanism 69 (see FIG. 16A). The lock member 67 is supported so as to be movable in the Y direction with respect to the apparatus body 1A, and includes a pressed portion 671 and an engaging portion 672. The pressed portion 671 is configured to be able to contact the pressing portion 653 of the stepped gear 65R.

Next, the operations of the lock mechanism 69 will be described with reference to FIGS. 16A to 17B. FIGS. 16A and 17A illustrate an unlocked state in which the lock mechanism 69 does not lock the rotary body 90, and FIGS. 16B and 17B illustrate a locked state in which the lock mechanism 69 locks the rotary body 90. As illustrated in FIGS. 16A and 17A, the lock mechanism 69 includes the pressing portion 653 of the stepped gear 65R, the lock member 67, and a biasing member 68. The biasing member 68 is provided in the apparatus body 1A and biases the lock member 67 in the −Y direction.

When the tray 80 is located at the accommodated position, the lock mechanism 69 is in the unlocked state, and the rotary body 90 is not locked by the lock mechanism 69. That is, the rotary body 90 is in a state where it is rotatable about the rotation axis 90C. The rotary body 90 has four engaged portions 99a with which the engaging portion 672 of the lock member 67 can be engaged. The engaging portion 672 of the lock member 67 can be engaged with one of the four engaged portions 99a when the rotary body 90 takes the corresponding one of the yellow/magenta/cyan/black replacement postures. When the engaging portion 672 is engaged with the engaged portion 99a, the rotation of the rotary body 90 about the rotation axis 90C is restricted.

When the rotary body 90 is in one of the yellow/magenta/cyan/black replacement postures and the tray 80 is located at the accommodated position, the pressing portion 653 of the stepped gear 65R contacts the pressed portion 671 of the lock member 67. As a result, the movement of the lock member 67 biased in the −Y direction by the biasing member 68 is restricted. At this time, as illustrated in FIG. 17A, the engaging portion 672 of the lock member 67 is separated from the engaged portion 99a of the rotary body 90 not to lock the rotary body 90.

The stepped gear 65R, in which the pressing portion 653 is provided, is a part of the transmission unit 15t for transmitting the driving force from the motor M2 to the drive rack 15 during the tray moving operation. That is, the stepped gear 65R rotates when a tray moving operation is performed to move the tray 80 in a sliding manner between the accommodated position and the taken-out position. In the present embodiment, when the motor M2 is driven to move the tray 80 from the accommodated position to the taken-out position, the stepped gear 65R rotates in the clockwise direction in FIG. 16B.

Then, the pressing portion 653 of the stepped gear 65R also rotates in the clockwise direction and moves in the −Y direction. Accordingly, the lock member 67 moves in a sliding manner in the −Y direction due to the biasing force of the biasing member 68. Then, as illustrated in FIG. 17B, the engaging portion 672 of the lock member 67 is engaged with the engaged portion 99a of the rotary body 90 to lock the rotary body 90. After the engaging portion 672 and the engaged portion 99a are engaged with each other, the drive rack 15 and the pinion gear 94 are engaged with each other. Even in a state where the drive rack 15 and the pinion gear 94 are engaged with each other and the tray 80 is located at the taken-out position, the rotary body 90 is locked by the lock mechanism 69.

Further, when the tray 80 moves from the taken-out position to the accommodated position, the engagement between the engaging portion 672 and the engaged portion 99a is released after the engagement between the drive rack 15 and the pinion gear 94 is released. By doing so, the drive rack 15 and the pinion gear 94 can mesh with each other in a state where the rotation of the rotary body 90 is restricted.

As described above, the rotary body 90 is locked in the replacement posture by the lock mechanism 69 of the rotary body 90 in a state where the tray 80 is located at the taken-out position. Therefore, it is possible to suppress an occurrence of poor meshing between the pinion gear 94 and the drive rack 15 during the tray moving operation.

### Configuration for Drive Transmission to Rotary Body and Conveyance Unit

As described with reference to FIG. 2, the apparatus body 1A includes motors M1, M2, and M3, and members driven by the motors M1, M2, and M3 can be arbitrarily set. Hereinafter, a configuration in which the motor M1 also serves as a drive source for the rotary body 90 and a conveyance unit 350 will be described. The conveyance unit 350 includes a conveyance roller pair 320, and the conveyance roller pair 320 includes a conveyance roller 321 and a driven roller 322 that rotates following the conveyance roller 321.

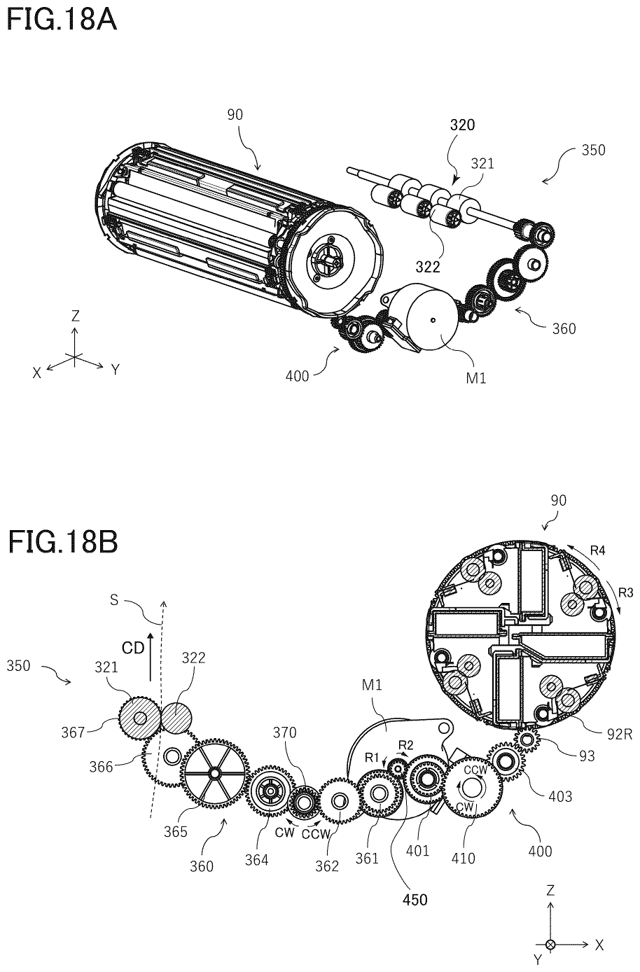

FIGS. 18A and 18B are views illustrating a configuration for drive transmission from the motor M1 to the rotary body 90 and the conveyance unit 350. As illustrated in FIGS. 18A and 18B, the apparatus body 1A includes a rotary drive train 400 serving as a first drive transmission unit capable of transmitting driving force from the motor M1 to the rotary body 90 serving as a first output part. In addition, the apparatus body 1A includes a conveyance roller drive train 360 serving as a second drive transmission unit capable of transmitting driving force from the motor M1 to the conveyance roller 321 serving as a second output part of the conveyance unit 350.

FIG. 18B is a cross-sectional view illustrating the rotary body 90, the conveyance roller 321, the rotary drive train 400, and the conveyance roller drive train 360 when the frame 16 is viewed from the left side. As illustrated in FIG. 18B, a driving force output from the motor M1 is transmitted to the rotary drive train 400 and the conveyance roller drive train 360 via a pinion gear 450 fixed to an output shaft of the motor M1. The rotary drive train 400 includes a rotary drive stepped gear 401, a rotary drive ratchet gear (ratchet and first switching portion) 410, a rotary drive idler gear 403, and a rotary drive gear 93. When driving force is input from the rotary drive gear 93 to a disc gear 92R of the rotary body 90, the rotary body 90 rotates.

On the other hand, the conveyance roller drive train 360 includes conveyance drive stepped gears 361 and 365, conveyance drive idler gears 362, 364, and 366, a conveyance drive ratchet gear (ratchet and second switching portion) 370, and a conveyance roller gear 367. When driving force is input from the conveyance roller gear 367 to the conveyance roller 321, the conveyance roller 321 rotates. For example, the conveyance roller gear 367 is fixed to a roller shaft to which the conveyance roller 321 is fixed. When the conveyance roller 321 rotates, the driven roller 322 rotates following the conveyance roller 321. As a result, the sheet S nipped by the conveyance roller 321 and the driven roller 322 is conveyed downstream in the sheet conveyance direction CD.

### Rotary Drive Ratchet Gear

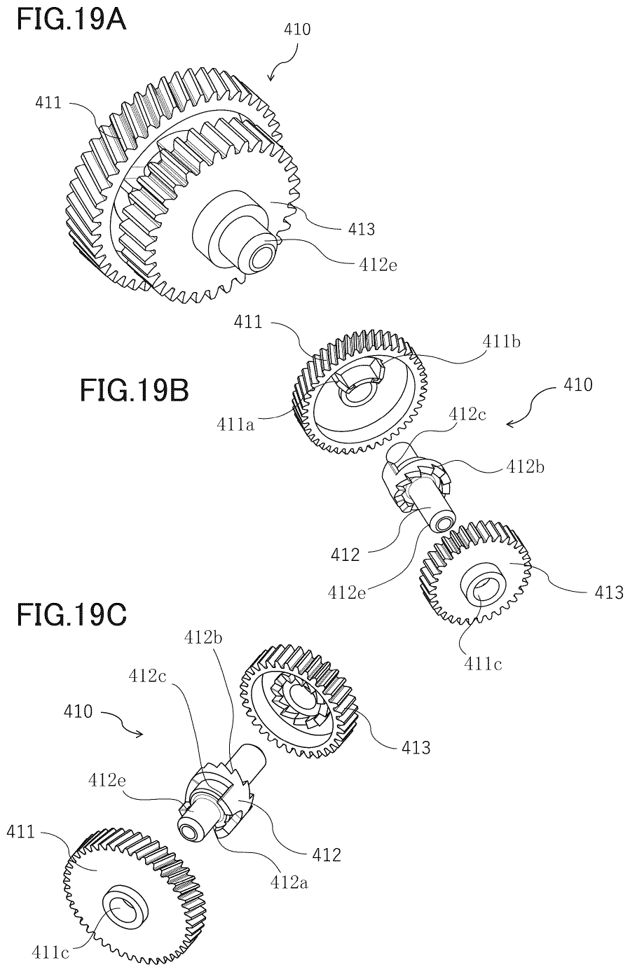

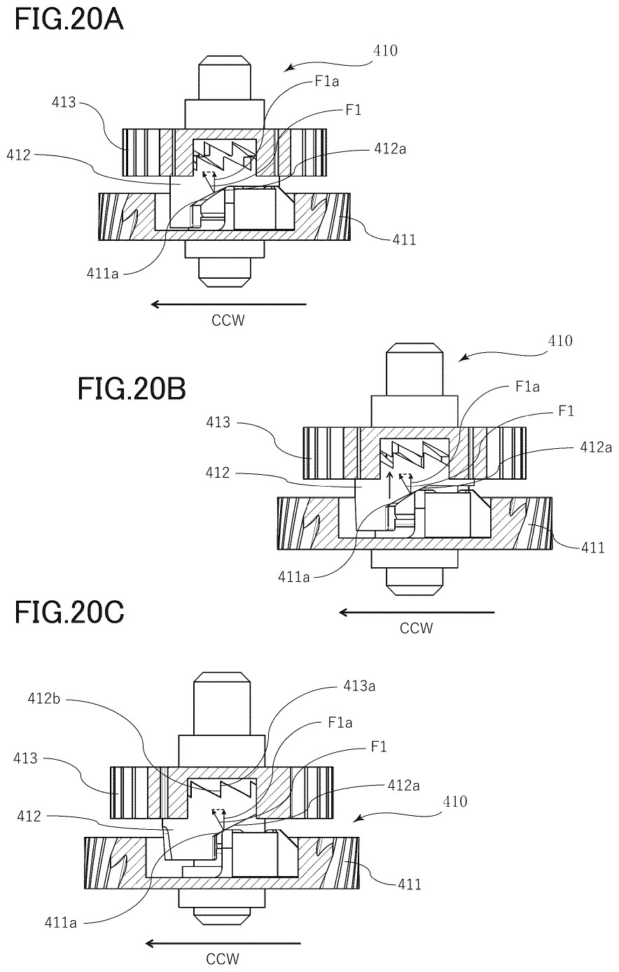

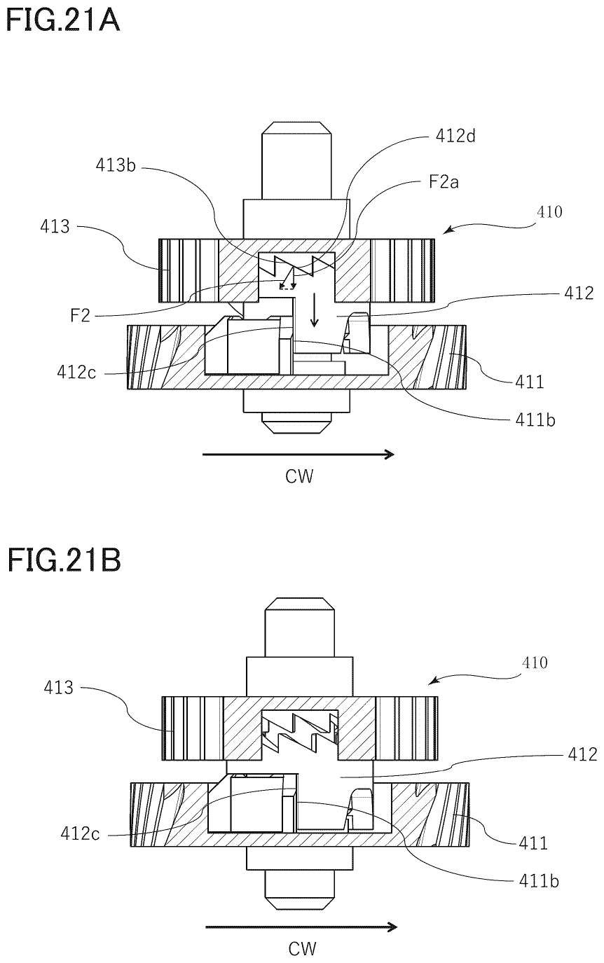

Next, a configuration of the rotary drive ratchet gear 410 will be described with reference to FIG. 19A to FIG. 21B. FIGS. 19A to 19C are perspective views illustrating the rotary drive ratchet gear 410. FIGS. 20A to 20C are views illustrating an engaging operation of the rotary drive ratchet gear 410. FIGS. 21A and 21B are views illustrating a separation operation of the rotary drive ratchet gear 410.

As illustrated in FIGS. 19A to 19C, the rotary drive ratchet gear 410 includes an input part 411, a slide engagement part 412, and an output part 413. The output part 413 meshes with the rotary drive idler gear 403. When a driving force of the motor M1 is transmitted from the input part 411 to the output part 413, the driving force of the motor M1 is transmitted to the rotary body 90 via the rotary drive idler gear 403 and the rotary drive gear 93. When the input part 411 rotates in the CCW direction (counterclockwise direction) in FIG. 18B, the slide engagement part 412 and the output part 413 are engaged with each other, and the rotary drive ratchet gear 410 serving as a first ratchet and a ratchet is in a first transmission state in which the driving force from the motor M1 is transmitted toward the rotary body 90. That is, the rotary drive ratchet gear 410 is in the first transmission state when the motor M1 rotates in a first direction R1 so that the input part 411 rotates in the CCW direction. The rotation direction of the motor M1 is the same as the rotation direction of the pinion gear 450 fixed to the output shaft of the motor M1.

In addition, when the input part 411 rotates in the CW direction (clockwise direction) in FIG. 18B, the slide engagement part 412 and the output part 413 are not engaged with each other, and the rotary drive ratchet gear 410 is in a first non-transmission state in which the drive from the motor M1 is not transmitted toward the rotary body 90. That is, the rotary drive ratchet gear 410 is in the first non-transmission state when the motor M1 rotates in a second direction R2 opposite to the first direction R1 so that the input part 411 rotates in the CW direction. It can be said that, when the rotary drive ratchet gear 410 is in the first transmission state, the rotary drive train 400 is also in the first transmission state, and when the rotary drive ratchet gear 410 is in the first non-transmission state, the rotary drive train 400 is also in the first non-transmission state.

As illustrated in FIGS. 19A and 19B, the input part 411 includes pressing surfaces 411a and 411b and a hole 411c, and the pressing surfaces 411a and 411b are disposed at different positions in the rotation direction of the input part 411. A shaft 412e of the slide engagement part 412 passes through the hole 411c. As illustrated in FIGS. 19B and 19C, the slide engagement part 412 serving as a second rotating member has a pressed surface 412a pressed by the pressing surface 411a of the input part 411, a gear engagement surface 412b, and a pressed surface 412c pressed by the pressing surface 411b of the input part 411. The output part 413 serving as a first rotating member has a gear engagement surface 413a that can be engaged with the gear engagement surface 412b of the slide engagement part 412. The slide engagement part 412 and the output part 413 have saw-shaped teeth facing each other, and the gear engagement surfaces 412b and 413a are portions of these teeth capable of transmitting a driving force by engaging with each other. In addition, gear inclined surfaces 412d (see FIG. 21A) extending so as to be inclined with respect to the circumferential direction of the rotary drive ratchet gear 410 are formed in the teeth of the slide engagement part 412. Similarly, gear inclined surfaces 413b (see FIG. 21A) extending so as to be inclined with respect to the circumferential direction of the rotary drive ratchet gear 410 are formed in the teeth of the output part 413.

FIG. 20A illustrates a state before the engaging operation of the rotary drive ratchet gear 410 is started, that is, before the motor M1 rotates in the first direction R1. At this time, the slide engagement part 412 is located at a disengaged position where it does not rotate integrally with the output part 413. As described above, when the motor M1 rotates in the first direction R1, the input part 411 rotates in the CCW direction. When the motor M1 rotates in the first direction R1, as illustrated in FIG. 20A, the pressing surface 411a of the input part 411 comes into contact with the pressed surface 412a of the slide engagement part 412, and a force F1 is transmitted from the input part 411 to the slide engagement part 412. Due to a component F1a of the force F1, the slide engagement part 412 moves in a direction approaching the output part 413 as illustrated in FIG. 20B.

Then, when the movement of the slide engagement part 412 is completed, as illustrated in FIG. 20C, the gear engagement surface 412b of the slide engagement part 412 and the gear engagement surface 413a of the output part 413 are engaged with each other, and the rotation of the input part 411 is transmitted to the output part 413 via the slide engagement part 412. At this time, the slide engagement part 412 is located at an engaged position where it is engaged with the input part 411 and the output part 413 so as to rotate integrally.

Next, the separation operation of the rotary drive ratchet gear 410 will be described with reference to FIGS. 21A and 21B. FIG. 21A illustrates a state before the separation operation of the rotary drive ratchet gear 410 is started, that is, before the motor M1 rotates in the second direction R2. As described above, when the motor M1 rotates in the second direction R2, the input part 411 rotates in the CW direction. When the motor M1 rotates in the second direction R2, as illustrated in FIG. 21A, the pressing surface 411b of the input part 411 comes into contact with the pressed surface 412c of the slide engagement part 412. Thereafter, the gear inclined surfaces 412d of the slide engagement part 412 come into contact with the gear inclined surfaces 413b of the output part 413, and the slide engagement part 412 receives a force F2 from the output part 413.

Due to a component F2a of the force F2, the slide engagement part 412 moves in a direction away from the output part 413 as illustrated in FIG. 21B. That is, as the gear inclined surfaces 412d slide on the gear inclined surfaces 413b of the output part 413, the slide engagement part 412 moves to a position where it does not transmit its rotation to the output part 413. At this time, the output part 413 is stopped because the rotary body 90 disposed downstream of the output part 413 in the drive transmission direction acts as a load when the output part 413 is rotated.

### Conveyance Drive Ratchet Gear

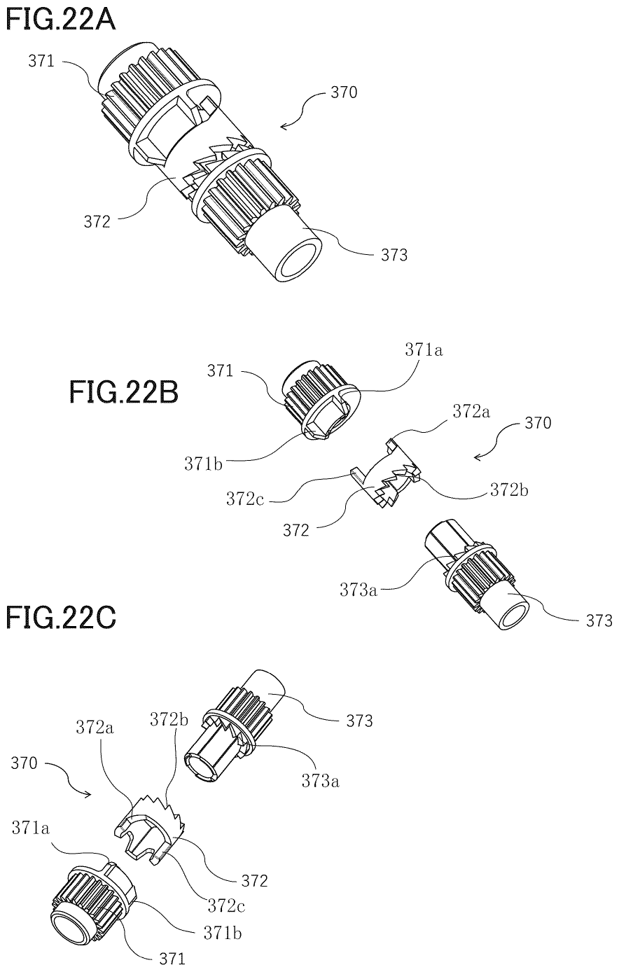

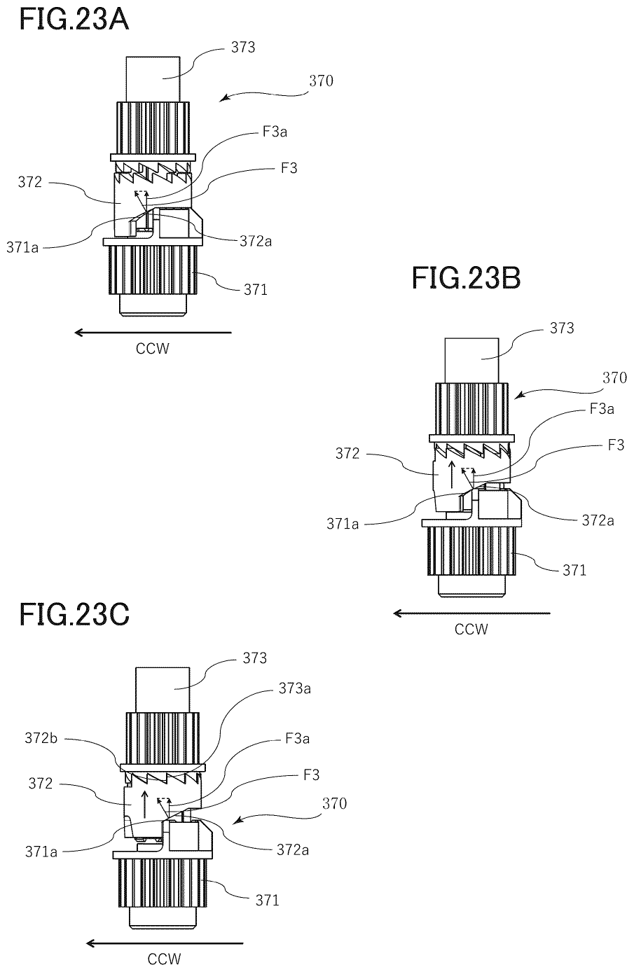

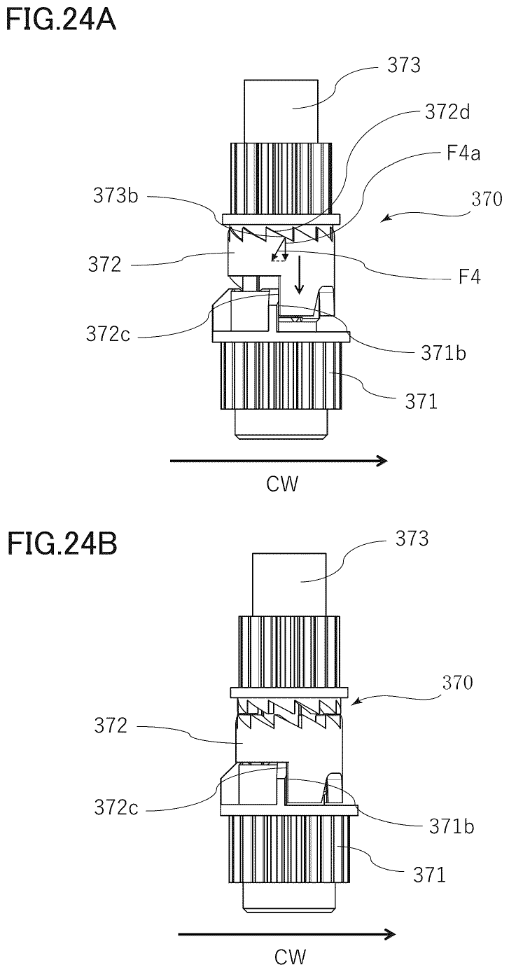

Next, a configuration of the conveyance drive ratchet gear 370 will be described with reference to FIG. 22A to FIG. 24B. FIGS. 22A to 22C are perspective views illustrating the conveyance drive ratchet gear 370. FIGS. 23A to 23C are views illustrating an engaging operation of the conveyance drive ratchet gear 370. FIGS. 24A and 24B are views illustrating a separation operation of the conveyance drive ratchet gear 370.

As illustrated in FIGS. 22A to 22C, the conveyance drive ratchet gear 370 serving as a second ratchet includes an input part 371, a slide engagement part 372, and an output part 373. When a driving force of the motor M1 is transmitted from the input part 371 to the output part 373, the driving force of the motor M1 is transmitted to the conveyance roller 321. When the input part 371 rotates in the CCW direction (counterclockwise direction) in FIG. 18B, the slide engagement part 372 and the output part 373 are engaged with each other, and the conveyance drive ratchet gear 370 is in a second transmission state in which the drive from the motor M1 is transmitted toward the conveyance roller 321 of the conveyance unit 350. That is, the conveyance drive ratchet gear 370 is in the second transmission state when the motor M1 rotates in the second direction R2 so that the input part 371 rotates in the CCW direction.

In addition, when the input part 371 rotates in the CW direction (clockwise direction) in FIG. 18B, the slide engagement part 372 and the output part 373 are not engaged with each other, and the conveyance drive ratchet gear 370 is in a second non-transmission state in which the driving force from the motor M1 is not transmitted toward the conveyance roller 321. That is, the conveyance drive ratchet gear 370 is in the second non-transmission state when the motor M1 rotates in the first direction R1 so that the input part 371 rotates in the CW direction. It can be said that, when the conveyance drive ratchet gear 370 is in the second transmission state, the conveyance roller drive train 360 is also in the second transmission state, and when the conveyance drive ratchet gear 370 is in the second non-transmission state, the conveyance roller drive train 360 is also in the second non-transmission state.

As illustrated in FIG. 22B, input part 371 has pressing surfaces 371a and 371b, and the pressing surfaces 371a and 371b are disposed at different positions in the rotation direction of the input part 371. As illustrated in FIGS. 22B and 22C, the slide engagement part 372 has a pressed surface 372a pressed by the pressing surface 371a of the input part 371, a gear engagement surface 372b, and a pressed surface 372c pressed by the pressing surface 371b of the input part 371. The output part 373 has a gear engagement surface 373a that can be engaged with the gear engagement surface 372b of the slide engagement part 372. The slide engagement part 372 and the output part 373 have saw-shaped teeth facing each other, and the gear engagement surfaces 372b and 373a are portions of these teeth capable of transmitting a driving force by engaging with each other. In addition, gear inclined surfaces 372d (see FIG. 24A) extending so as to be inclined with respect to the circumferential direction of the conveyance drive ratchet gear 370 are formed in the teeth of the slide engagement part 372. Similarly, gear inclined surfaces 373b (see FIG. 24A) extending so as to be inclined with respect to the circumferential direction of the conveyance drive ratchet gear 370 are formed in the teeth of the output part 373.

FIG. 23A illustrates a state before the engaging operation of the conveyance drive ratchet gear 370 is started, that is, before the motor M1 rotates in the second direction R2. As described above, when the motor M1 rotates in the second direction R2, the input part 371 rotates in the CCW direction. When the motor M1 rotates in the second direction R2, as illustrated in FIG. 23A, the pressing surface 371a of the input part 371 comes into contact with the pressed surface 372a of the slide engagement part 372, and a force F3 is transmitted from the input part 371 to the slide engagement part 372. Due to a component F3a of the force F3, the slide engagement part 372 moves in a direction approaching the output part 373 as illustrated in FIG. 23B.

Then, when the movement of the slide engagement part 372 is completed, as illustrated in FIG. 23C, the gear engagement surface 372b of the slide engagement part 372 and the gear engagement surface 373a of the output part 373 are engaged with each other, and the rotation of the input part 371 is transmitted to the output part 373 via the slide engagement part 372. At this time, the slide engagement part 372 rotates integrally with the input part 371 and the output part 373.

Next, the separation operation of the conveyance drive ratchet gear 370 will be described with reference to FIGS. 24A and 24B. FIG. 24A illustrates a state before the separation operation of the conveyance drive ratchet gear 370 is started, that is, before the motor M1 rotates in the first direction R1. As described above, when the motor M1 rotates in the first direction R1, the input part 371 rotates in the CW direction. When the motor M1 rotates in the first direction R1, as illustrated in FIG. 24A, the pressing surface 371b of the input part 371 comes into contact with the pressed surface 372c of the slide engagement part 372. Thereafter, the gear inclined surfaces 372d of the slide engagement part 372 come into contact with the gear inclined surfaces 373b of the output part 373, and the slide engagement part 372 receives a force F4 from the output part 373.

Due to a component F4a of the force F4, the slide engagement part 372 moves in a direction away from the output part 373 as illustrated in FIG. 24B. That is, as the gear inclined surfaces 372d slide on the gear inclined surfaces 373b of the output part 373, the slide engagement part 372 moves to a position where it does not transmit its rotation to the output part 373. At this time, the output part 373 is stopped because the conveyance roller 321 disposed downstream of the output part 373 in the drive transmission direction acts as a load when the output part 373 is rotated.

As described above, when the motor M1 rotates in the first direction R1, the rotary drive ratchet gear 410 is in the first transmission state, so that the rotary body 90 rotates about the rotation axis 90C, and the conveyance drive ratchet gear 370 is in the second non-transmission state, so that the conveyance roller 321 does not rotate. On the other hand, when the motor M1 rotates in the second direction R2, the rotary drive ratchet gear 410 is in the first non-transmission state, so that the rotary body 90 does not rotate, and the conveyance drive ratchet gear 370 is in the second transmission state, so that the conveyance roller 321 rotates. In a state where a restriction lever 430, which will be described below, is located at a restricting position, the operation of the rotary body 90 when the motor M1 rotates in the second direction R2 is different from that described above.

### Configuration for Reverse Rotation of Rotary Body

With the above-described configuration for drive transmission to the rotary body 90, the rotary body 90 rotates in a third direction R3 (clockwise) when the motor M1 rotates in the first direction R1, but the rotary body 90 does not rotate when the motor M1 rotates in the second direction R2. However, in some cases, it is desirable that the rotary body 90 can rotate both clockwise and counterclockwise. For example, this is the case when reading memory tags 72y to 72k attached to the toner cartridges 70y to 70k.

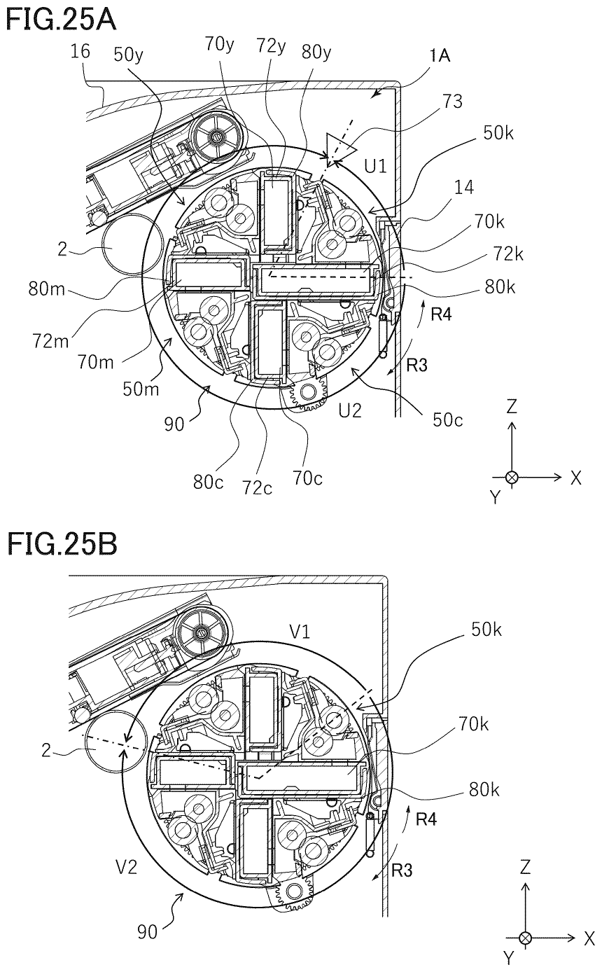

FIG. 25A is a cross-sectional view illustrating the memory tags 72y to 72k. As illustrated in FIG. 25A, for example, a memory tag reading unit 73 provided in the apparatus body 1A is located at an upper right end of the rotary body 90. Then, a case where the memory tags 72y to 72k are read immediately after the toner cartridges 70y to 70k are replaced will be considered. A movement distance U1 when the rotary body 90 is rotated in a fourth direction R4 (counterclockwise) from replacing positions of the toner cartridges 70y to 70k to the position of the memory tag reading unit 73 is shorter than a movement distance U2 when the rotary body 90 is rotated in the third direction R3 (clockwise). That is, by rotating the rotary body 90 in the fourth direction R4, it is possible to shorten the time from the replacement of the toner cartridges 70y to 70k to the reading of the memory tags 72y to 72k.

FIG. 25B is a cross-sectional view illustrating a movement distance when the rotary body 90 is rotated from the replacing position to the developing position. As illustrated in FIG. 25B, assuming that a monochrome image is printed with a black toner immediately after the toner cartridge 70k is replaced, the movement distance when the rotary body 90 is rotated in the fourth direction R4 (counterclockwise) from the replacing position to the developing position of the toner cartridge 70k is defined as a movement distance V1. The movement distance V1 is shorter than the movement distance V2 when the rotary body 90 is rotated in the third direction R3 (clockwise) from the replacing position to the developing position of the toner cartridge 70k. That is, by rotating the rotary body 90 in the fourth direction R4, it is possible to shorten the time from the replacement of the toner cartridge 70k to the start of the formation of the monochrome image. After moving the toner cartridge 70k from the replacing position to the developing position, the image forming apparatus 1 starts an operation of feeding the sheet S and forms an image on the sheet S.

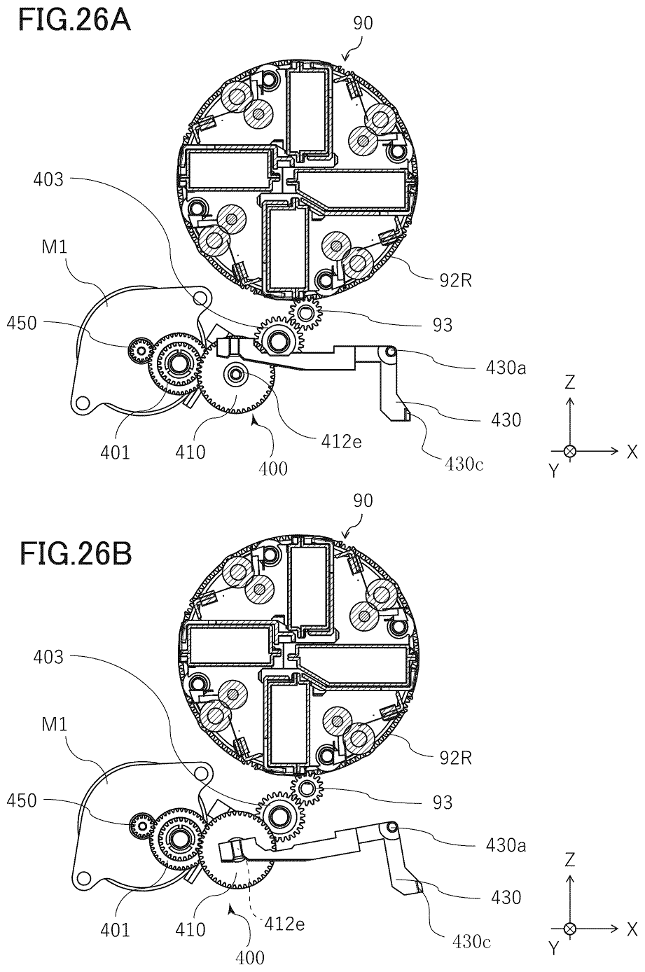

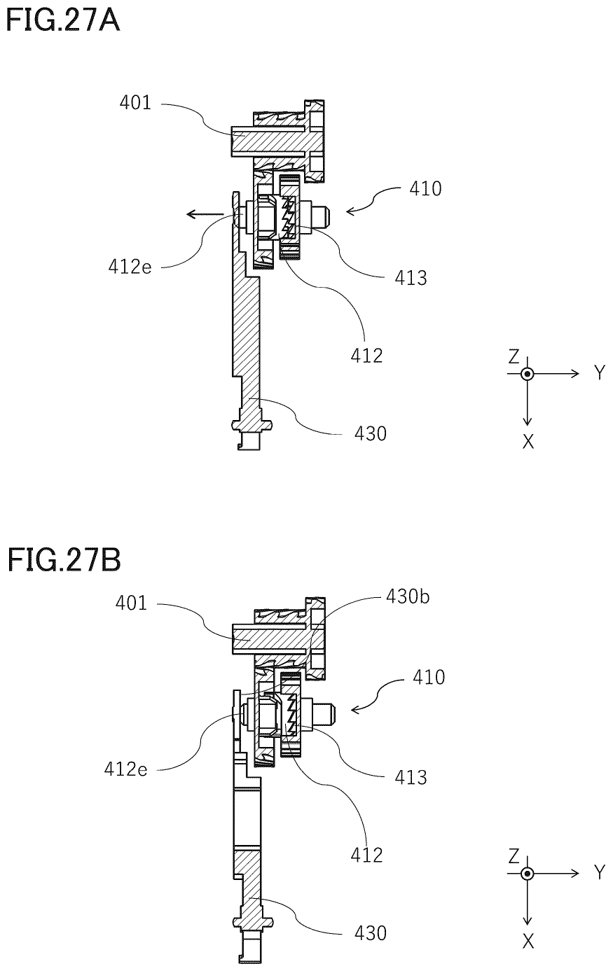

FIGS. 26A and 26B are cross-sectional views illustrating the restriction lever 430. FIGS. 27A and 27B are cross-sectional views illustrating an operation of the restriction lever 430. As illustrated in FIG. 26A, the restriction lever 430 is provided in the rotary drive train 400 according to the present embodiment. The restriction lever 430 serving as a restriction member is configured to be pivotable about a pivot shaft 430a extending in the Y direction, and is movable between an allowing position illustrated in FIG. 26A and a restricting position illustrated in FIG. 26B. As illustrated in FIG. 26A, the restriction lever 430 located at the allowing position does not overlap the shaft 412e of the slide engagement part 412 when viewed in the Y direction. On the other hand, as illustrated in FIG. 26B, the restriction lever 430 located at the restricting position overlaps the shaft 412e of the slide engagement part 412 when viewed in the Y direction.

More specifically, as illustrated in FIGS. 26A and 27A, the restriction lever 430 allows the slide engagement part 412 of the rotary drive ratchet gear 410 to be separated from the output part 413 at the allowing position. In other words, the restriction lever 430 allows the rotary drive ratchet gear 410 to transition to the first transmission state at the allowing position. This is because the restriction lever 430 is retracted upward (in the +Z direction) from the shaft 412e at the allowing position. That is, the restriction lever 430 does not overlap a movement locus when the slide engagement part 412 moves from the engaged position (the position illustrated in FIG. 20C) where it is engaged with the output part 413 to the disengaged position (the position illustrated in FIG. 20A) where it is not engaged with the output part 413 at the allowing position.

As illustrated in FIG. 27A, when the restriction lever 430 is located at the allowing position and the motor M1 rotates in the second direction R2, the slide engagement part 412 is separated from the output part 413 and moves to the disengaged position. As a result, the rotary drive ratchet gear 410 is in the first non-transmission state.

On the other hand, as illustrated in FIG. 27B, when the restriction lever 430 is located at the restricting position and the motor M1 rotates in the second direction R2, the shaft 412e of the slide engagement part 412 tries to move away from the output part 413 but hits the restriction lever 430. Therefore, the movement of the slide engagement part 412 from the engaged position to the disengaged position is restricted, and the rotary drive ratchet gear 410 is maintained in the first transmission state. That is, the rotary drive ratchet gear 410 is maintained in the state in which the driving force of the motor M1 is transmitted from the input part 411 to the output part 413. At this time, the input part 411 rotates in the CW direction in FIG. 18B, and the rotary body 90 rotates in the fourth direction R4 (counterclockwise).

Note that, when the motor M1 rotates in the first direction R1, the rotary drive ratchet gear 410 is in the first transmission state regardless of the position of the restriction lever 430. Therefore, the rotary body 90 rotates in the third direction R3 (clockwise).

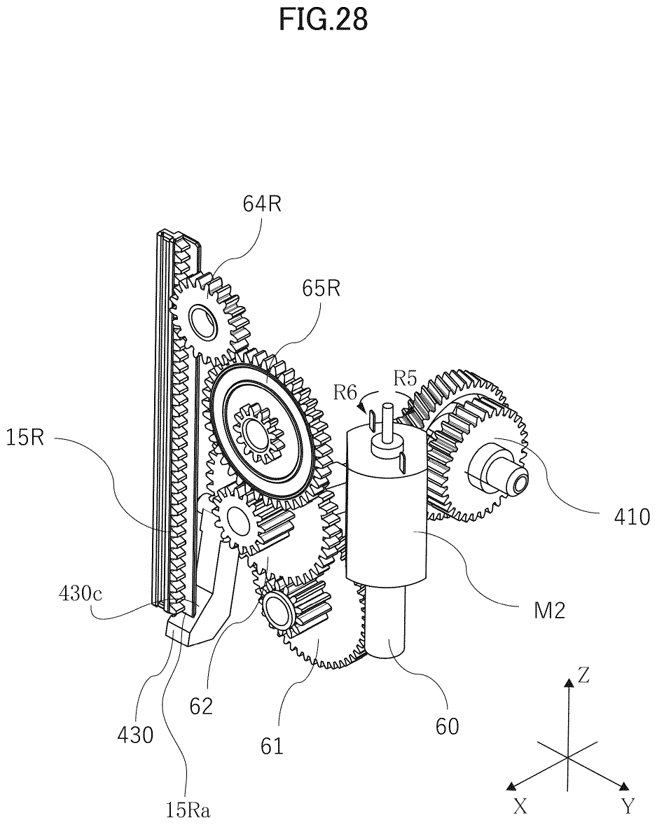

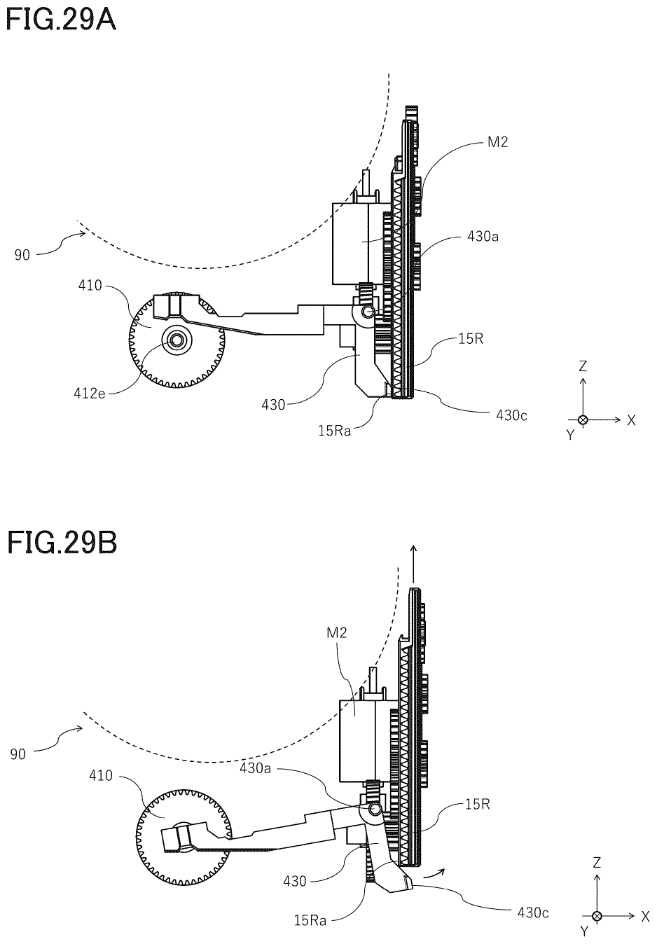

Next, a configuration for moving the restriction lever 430 between the allowing position and the restricting position will be described with reference to FIG. 28 to FIG. 29B. FIG. 28 is a perspective view illustrating a configuration around the restriction lever 430. FIGS. 29A and 29B are front views illustrating how the restriction lever 430 moves between the allowing position and the restricting position. In the present embodiment, the restriction lever 430 is moved using the drive mechanism for moving the tray 80 described with reference to FIGS. 13A and 13B.

As illustrated in FIG. 28, when the motor M2 is driven to rotate in a fifth direction R5, the drive rack 15R serving as a moving member is moved in a sliding manner upward (in the +Z direction) via the worm gear 60, the stepped gear 61, the stepped gear 62, the stepped gear 65R, and the drive rack input gear 64R. The drive rack 15R is engaged with the pinion gear 94R to drive the pinion gear 94R serving as a drive receiving member. As the pinion gear 94R is driven by the drive rack 15R, the tray 80 moves between the accommodated position and the taken-out position.

A pressing surface 15Ra capable of pressing a pressed surface 430c of the restriction lever 430 is provided at a lower end of the drive rack 15R. The position of the center of gravity of the restriction lever 430 is set so that the restriction lever 430 is biased from the allowing position toward the restricting position by its own weight. That is, the center of gravity of the restriction lever 430 is located on the −X side with respect to the center of the pivot shaft 430a illustrated in FIG. 29A. When the motor M2 rotates in the fifth direction R5, the tray 80 moves from the accommodated position toward the taken-out position, and when the motor M2 rotates in a sixth direction R6 opposite to the fifth direction, the tray 80 moves from the taken-out position toward the accommodated position.

In a state where the tray 80 is located at the accommodated position before the motor M2 is driven, the drive rack 15R is located at a first position illustrated in FIG. 29A. At this time, the pressing surface 15Ra of the drive rack 15R comes into contact with the pressed surface 430c of the restriction lever 430 to restrict movement of the restriction lever 430 from the allowing position to the restricting position. When the motor M2 is driven to rotate in the fifth direction R5, the drive rack 15R moves upward in a sliding manner, and the restriction lever 430 pivots from the allowing position to the restricting position in conjunction with the movement of the drive rack 15R as illustrated in FIG. 29B. In FIGS. 29A and 29B, the drive rack 15R is located outside a rotation locus of the rotary body 90 indicated by a broken line, and therefore, the drive rack 15R and the rotary body 90 do not interfere with each other.

When the motor M2 is driven to rotate in the sixth direction R6 in a state where the restriction lever 430 is located at the restricting position illustrated in FIG. 29B, the drive rack 15R is moved downward (in the −Z direction) in a sliding manner. As a result, the pressing surface 15Ra of the drive rack 15R presses the pressed surface 430c of the restriction lever 430, and the restriction lever 430 is pivotable from the restricting position to the allowing position. That is, it can be said that the motor M2 can drive the restriction lever 430 between the allowing position and the restricting position.

Here, the timing at which the restriction lever 430 switches from the allowing position to the restricting position, the timing at which the rotation of the rotary body 90 is locked, and the timing at which the drive rack 15R and the pinion gear 94kR come into contact with each other during the movement of the tray 80k will be described. Here, the configuration for the tray 80k will be described, and the configurations for the tray 80y to the tray 80c, which have substantially the same configuration as the tray 80k, will not be described. Although the drive racks 15, the lock members 67, and the pinion gears 94k are present on both the left and right sides in the Y direction of the apparatus body 1A, for convenience of explanation, only the ones present on the positive side (right side) in the Y axis direction will be described here.

A movement distance of the drive rack 15R when the restriction lever 430 is switched from the allowing position to the restricting position is defined as Z1, a movement distance of the drive rack 15R when the rotation of the rotary body 90 is locked is defined as Z2, and a movement distance of the drive rack 15R when the drive rack 15R and the pinion gear 94kR come into contact with each other is defined as Z3. The movement distances Z1, Z2, and Z3 are based on the time point at which the drive rack 15R is located at the first position. That is, the movement distances Z1, Z2, and Z3 are based on a state in which the tray 80 is located at the accommodated position before the motor M2 is driven. The movement distances Z1, Z2, and Z3 satisfy Z1<Z2<Z3.

When the motor M2 rotates in the fifth direction R5 and the drive rack 15R moves upward (in the +Z direction), the restriction lever 430 is switched from the allowing position to the restricting position at a time point when the drive rack 15R has advanced by the movement distance Z1. The position where the drive rack 15R has advanced by the movement distance Z1 from the first position in this manner is defined as a second position. In the present embodiment, the restriction lever 430 is positioned at the restricting position by hitting the drive rack 15R located at the second position. At this time, the lock of the rotation of the rotary body 90 by the lock member 67 and the contact between the drive rack 15R and the pinion gear 94kR have not yet started. That is, before the tray 80 starts to move from the accommodated position toward the taken-out position, the restriction lever 430 moves from the allowing position to the restricting position.

When the rotary body 90 is in the replacement posture at a time point when the drive rack 15R has advanced by the movement distance Z2, the engaging portion 672 of the lock member 67 is engaged with the engaged portion 99a of the rotary body 90 as described above, thereby restricting (locking) the rotation of the rotary body 90. That is, before the tray 80 starts to move from the accommodated position toward the taken-out position, the lock member 67 moves from a separated position where it is separated from the rotary body 90 to a locking position where it is restricting the rotation of the rotary body 90.

At a time point when the drive rack 15R has advanced by the movement distance Z3, the drive rack 15R (force applying part) and the pinion gear (force receiving part) 94kR are engaged with each other. In this state, the motor M2 further rotates in the fifth direction R5 and the drive rack 15R further moves upward, thereby moving the tray 80k from the accommodated position toward the taken-out position. On the other hand, when the motor M2 rotates in the sixth direction R6 to move the tray 80k from the taken-out position to the accommodated position, the drive rack 15R is separated from the pinion gear 94kR to release the lock of the rotation of the lock member 67, and then the restriction lever 430 moves from the restricting position to the allowing position.

It is preferable that, when the rotary body 90 is rotated in the fourth direction R4, the motor M2 is stopped in a state where the restriction lever 430 is located at the restricting position and the rotation of the rotary body 90 is not restricted (locked) by the lock member 67. By rotating the motor M1 in the second direction R2 in this state, the rotary body 90 can be rotated in the fourth direction R4.

With the above-described configuration, the rotary drive train 400 according to the present embodiment can transition to a first state, a second state, and a third state. When the motor M1 rotates in the first direction R1, the rotary drive train 400 is in the first state, and transmits the driving force from the motor M1 to the rotary body 90 so that the rotary body 90 rotates in the third direction R3. When the motor M1 rotates in the first direction R1, the rotary drive ratchet gear 410 is in the first transmission state regardless of the position of the restriction lever 430. When the rotary drive train 400 is in the first state, the conveyance roller drive train 360 is in the second non-transmission state, and the conveyance roller 321 does not rotate. Therefore, the load on the motor M1 can be reduced.

When the motor M1 rotates in the second direction R2, the rotary drive train 400 can transition to the second state in which the driving force from the motor M1 is not transmitted to the rotary body 90 or to the third state in which the driving force from the first motor is transmitted to the rotary so that the rotary body 90 rotates in the fourth direction R4. At this time, when the restriction lever 430 is located at the allowing position, the rotary drive ratchet gear 410 is in the first non-transmission state, so that the rotary drive train 400 is in the second state. When the rotary drive train 400 is in the second state, the conveyance roller drive train 360 is in the second transmission state. That is, when the motor M1 rotates in the second direction R2, the driving force from the motor M1 is transmitted to the conveyance roller 321. As a result, when the sheet S is in contact with the conveyance roller 321, the conveyance roller 321 conveys the sheet S downstream in the sheet conveyance direction CD. The rotation direction of the conveyance roller 321 at this time can be referred to as a conveyance rotation direction. That is, when the motor M1 rotates in the second direction R2, the conveyance roller drive train 360 transmits the driving force from the motor M1 to the conveyance roller 321, and the conveyance roller 321 rotates in the conveyance rotation direction.

On the other hand, when the restriction lever 430 is located at the restricting position, the motor M1 rotates in the second direction R2, and the rotary drive ratchet gear 410 is in the first transmission state, so that the rotary drive train 400 is in the third state. When the rotary drive train 400 is in the third state, the conveyance roller drive train 360 is in the second transmission state. At this time, the conveyance roller 321 rotates in the conveyance rotation direction. However, when the rotary body 90 rotates in the fourth direction R4, the conveyance roller 321 is separated from the sheet S, and therefore, the rotation of the conveyance roller 321 does not affect the conveyance of the sheet S.

In this manner, by rotating the motor M1 forward or backward in the first direction R1 or the second direction R2, it is possible to select whether to rotate the rotary body 90 in the third direction R3 or in the fourth direction R4, thereby reducing the number of motors and reducing the cost. In addition, since the drive rack 15R for moving the tray 80 is used when switching the restriction lever 430 between the allowing position and the restricting position, the number of motors and the number of parts can be reduced, thereby reducing the cost.

The rotary body 90 rotates in the third direction R3 when switching the color of the toner image formed on the photosensitive drum 2. On the other hand, as described above, the rotary body 90 is configured to be rotatable also in the fourth direction R4 opposite to the third direction R3. By rotating the rotary body 90 in the fourth direction R4, for example, the memory tag 72 attached to the replaced toner cartridge 70 can be read quickly. In this manner, after the toner cartridge 70 is mounted on the developing frame 53 and before the image forming operation on the sheet S is started, the rotary body 90 rotates in the fourth direction R4. In addition, by rotating the rotary body 90 in the fourth direction R4, it is possible to shorten the time from the replacement of the toner cartridge 70k to the start of the formation of the monochrome image.

When the motor M2 is rotated in the sixth direction R6 to move the tray 80 from the taken-out position to the accommodated position, first, the pinion gear 94R rotates in conjunction with the movement of the drive rack 15R, and the tray 80 is located at the accommodated position. When the motor M2 is further rotated in the sixth direction R6, the drive rack 15R is separated from the pinion gear 94R. Then, the lock member 67 is separated from the rotary body 90, and the lock of the rotation of the rotary body 90 by the lock member 67 is released.

Then, by rotating the motor M1 in the second direction R2 in a state where the lock of the rotation of the rotary body 90 by the lock member 67 is released and the restriction lever 430 is located at the restricting position, the rotary body 90 can be rotated in the fourth direction R4. When the motor M2 is further rotated in the sixth direction R6 after the rotary body 90 is rotated in the fourth direction R4, the drive rack 15R further moves downward, and the restriction lever 430 moves from the restricting position to the allowing position.

### System Configuration of Image Forming Apparatus

Next, a system configuration of the image forming apparatus 1 will be described with reference to FIG. 30. FIG. 30 is a block diagram for explaining the system configuration of the image forming apparatus 1. As illustrated in FIG. 30, the image forming apparatus 1 includes a control unit 30 and hardware 3030. The control unit 30 includes a video interface unit 3021 and a CPU 3022, and can communicate with a controller unit 3000 and a host computer 3002 via the video interface unit 3021.

The CPU 3022 can acquire a detection result from the conveyance sensor 20 via a sheet detection unit 3026, and can control the motor M1 via a drive control unit 3024. In addition, the CPU 3022 can perform toner image formation on the intermediate transfer belt 10a in the above-described image forming operation via an image formation control unit 3023, and perform a conveyance operation of conveying the sheet S toward the secondary transfer roller 12 via a sheet conveyance control unit 3025.

The secondary transfer roller 12 and the cleaning device 13 are configured to be able to be brought into contact with or separated from the intermediate transfer belt 10a by an actuator such as a solenoid. The secondary transfer roller 12 and the cleaning device 13 may be configured to be movable by one actuator, or may be configured to be movable by separate actuators. Hereinafter, an operation in which the secondary transfer roller 12 and the cleaning device 13 are brought into contact with or separated from the intermediate transfer belt 10a is referred to as a contacting/separating operation. The CPU 3022 can perform an operation of contacting/separating the secondary transfer roller 12 via a secondary transfer roller contacting/separating control unit 3027, and can perform an operation of contacting/separating the cleaning device 13 via a cleaning device contacting/separating control unit 3028.

The drive control unit 3024 can designate the rotation direction of the motor M1 to drive the motor M1. When the motor M1 is driven in the first direction R1, the driving force can be transmitted to the rotary body 90, and when the motor M1 is driven in the second direction R2, the driving force can be transmitted to the pickup roller 310, the feed roller 311, the separation roller 312, and the conveyance roller pair 320. That is, the pickup roller 310, the feed roller 311, the separation roller 312, and the conveyance roller pair 320 are examples of a conveyance unit driven by the motor M1. The operation in which the pickup roller 310, the feed roller 311, the separation roller 312, and the conveyance roller pair 320 convey the sheet S in the sheet conveyance direction CD toward the secondary transfer roller 12 can be referred to as a conveyance operation. As described above, the photosensitive drum 2, the developing units 50y, 50m, 50c, and 50k, the secondary transfer roller 12, the belt driving roller 10b, and the fixing unit 40 are driven by the motor M3.

### Comparative Example

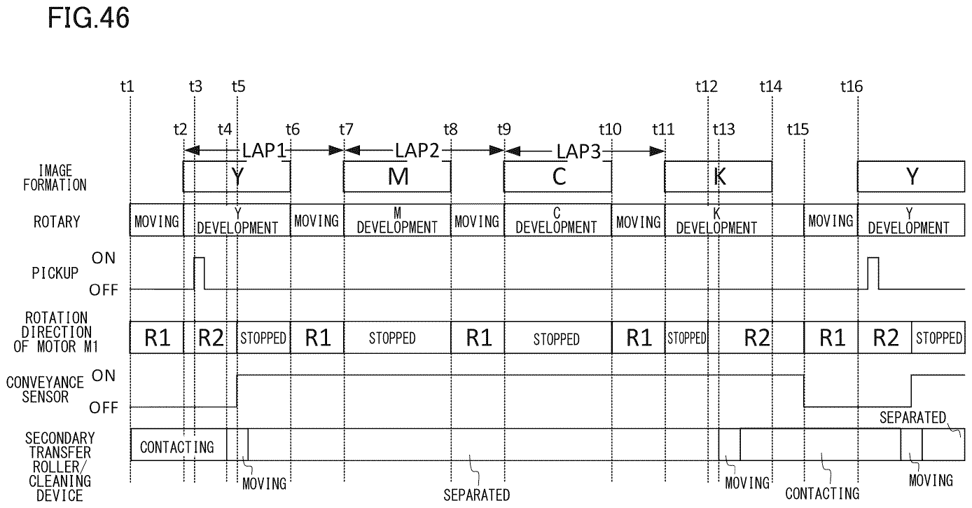

Next, an image forming operation for forming a color image and a conveyance operation according to a comparative example will be described with reference to FIG. 46. FIG. 46 is a timing chart for explaining an image forming operation and a conveyance operation according to a comparative example. In the present comparative example, the sheet S is fed immediately after the rotary body 90 is moved to the yellow development posture.

In each timing chart in the following description, “image formation”, “rotary”, “pickup”, “rotation direction of motor M1”, “conveyance sensor”, and “secondary transfer roller/cleaning device” are taken on the vertical axis.

Concerning the “image formation”, “Y”, “M”, “C”, and “K” indicate that operations of forming yellow, magenta, cyan, and black toner images on the photosensitive drum 2 are being performed, respectively. The operation of forming the toner image on the photosensitive drum 2 is started from, for example, an operation in which the scanner 4 forms an electrostatic latent image on the surface of the photosensitive drum 2, and is completed when the toner image formed on the photosensitive drum 2 is entirely transferred to the intermediate transfer belt 10a by the primary transfer roller 11. For example, the operation of forming the black image is started from an operation in which the scanner 4 forms a predetermined electrostatic latent image on the photosensitive drum 2.

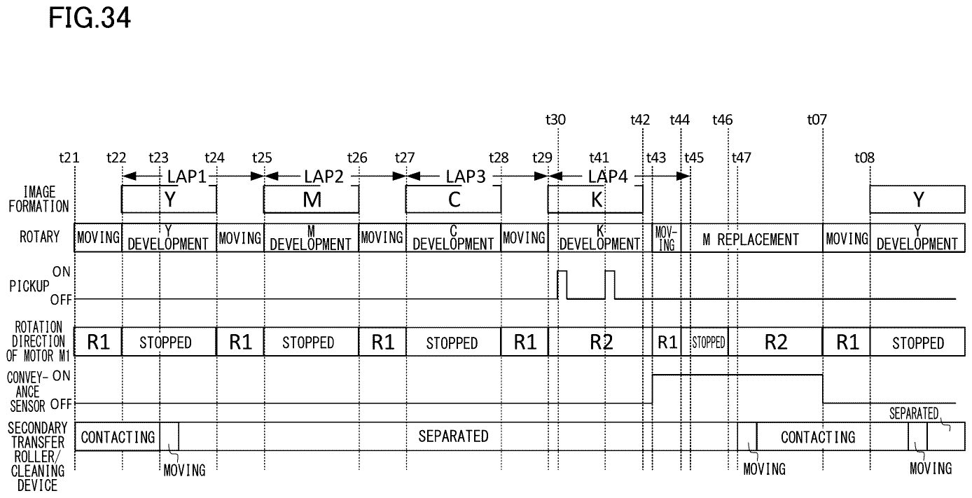

The “rotary” indicates which posture the rotary body 90 takes. For example, concerning the “rotary”, “Y development”, “M development”, “C development”, and “K development” indicate that the rotary body 90 takes the yellow development posture, the magenta development posture, the cyan development posture, and the black development posture, respectively. In addition, “moving” indicates that the rotary body 90 is rotating between the development postures. Note that “M replacement” in FIG. 34 indicates that the rotary body 90 takes the magenta replacement posture.

The “pickup” indicates a start timing of a feeding operation in which the sheet S is fed by the pickup roller 310. As described above, when the motor M1 is driven in the second direction R2, the driving force is transmitted to the pickup roller 310. In the present embodiment, for example, the pickup roller 310 is configured to be able to be brought into contact with or separated from the uppermost sheet S accommodated in the sheet accommodating portion 300.

The start timing of the feeding operation is a timing at which the pickup roller 310 comes into contact with the uppermost sheet S accommodated in the sheet accommodating portion 300 in a state where the driving force from the motor M1 has been transmitted to the pickup roller 310. For example, the pickup roller 310 may be swingably supported by an arm member, and may be configured to be brought into contact with or separated from the uppermost sheet S accommodated in the sheet accommodating portion 300 as the arm member swings. Further, a pivotable intermediate plate on which the sheets S are supported is provided in the sheet accommodating portion 300, and the sheet accommodating portion 300 may be configured to cause the uppermost sheet S accommodated therein to be brought into contact with or separated from the pickup roller 310 as the intermediate plate pivots.

The “secondary transfer roller/cleaning device” indicates whether the secondary transfer roller 12 and the cleaning device 13 are located at the contacting positions or at the separated positions. The secondary transfer roller 12 and the cleaning device 13 are in contact with the intermediate transfer belt 10a at the contacting positions, and are separated from the intermediate transfer belt 10a at the separated positions. In addition, “moving” between “contacting” and “separated” indicates that the secondary transfer roller 12 and the cleaning device 13 are moving between the contacting positions and the separated positions.

As illustrated in FIG. 46, the control unit 30 moves the rotary body 90 to the yellow development posture to start yellow image formation at time t1. At this time, the control unit 30 drives the motor M1 in the first direction R1. Then, when the movement of the rotary body 90 to the yellow development posture is completed at time t2, the control unit 30 starts a yellow image forming operation and drives the motor M1 from the first direction R1 to the second direction R2. Then, after the speed of the motor M1 is stabilized, the control unit 30 performs a feeding operation as a conveyance operation performed by the pickup roller 310 at time t3.

In an image forming operation of forming a color image, the image forming apparatus 1 transfers yellow, magenta, cyan, and black toner images to the intermediate transfer belt 10a so as to overlap each other. At this time, if the secondary transfer roller 12 and the cleaning device 13 are in contact with the intermediate transfer belt 10a, a color image cannot be appropriately formed on the intermediate transfer belt 10a. For this reason, in the present embodiment, the image forming operation for each color is performed in a state where the secondary transfer roller 12 and the cleaning device 13 are separated from the intermediate transfer belt 10a.

Therefore, at time t4, the control unit 30 moves the secondary transfer roller 12 and the cleaning device 13 from the contacting positions to the separated positions. Here, the timing at which the secondary transfer roller 12 and the cleaning device 13 are moved from the contacting positions to the separated positions needs to be before the yellow toner image formed on the intermediate transfer belt 10a reaches the secondary transfer portion.

Then, when the conveyance sensor 20 detects the leading edge of the sheet at time t5, the control unit 30 stops the driving of the motor M1. That is, the driving of the motor M1 is stopped after the sheet S is conveyed until it reaches the conveyance sensor 20. When the yellow image forming operation is completed at time t6, the control unit 30 drives the motor M1 in the first direction R1 to rotate the rotary body 90 toward the magenta development posture. When the rotary body 90 moves to the magenta development posture at time t7, the control unit 30 stops the motor M1 and starts a magenta image forming operation. Note that LAP1 corresponds to a time from the start of yellow image formation to the start of magenta image formation, and the intermediate transfer belt 10a makes one cycle during LAP1. Similarly, each of LAP2 and LAP3 corresponds to a time during which the intermediate transfer belt 10a makes one cycle.

Similarly, when the magenta image forming operation is completed at time t8, the control unit 30 drives the motor M1 in the first direction R1 to rotate the rotary body 90 toward the cyan development posture. When the rotary body 90 moves to the cyan development posture at time t9, the control unit 30 stops the motor M1 and starts a cyan image forming operation. When the cyan image forming operation is completed at time t10, the control unit 30 drives the motor M1 in the first direction R1 to rotate the rotary body 90 toward the black development posture. When the rotary body 90 moves to the black development posture at time t11, the control unit 30 stops the motor M1 and starts a black image forming operation.

The control unit 30 drives the motor M1 in the second direction R2 at time t12, which is a predetermined time after the black image forming operation is started, and starts to move the secondary transfer roller 12 and the cleaning device 13 to the contacting positions at time t13. By driving the motor M1 in the second direction R2, the sheet S is conveyed in the sheet conveyance direction CD by the conveyance roller pair 320, etc. That is, the conveyance of the sheet S is resumed. Even at time t14 when the black image forming operation is completed, the motor M1 is driven in the second direction R2 to convey the sheet S, and the rotary body 90 maintains the black development posture.

Then, when the conveyance sensor 20 detects the trailing edge of the sheet S at time t15, the control unit 30 controls the motor M1 to be driven from the second direction R2 to the first direction R1. As a result, the rotary body 90 rotates to the yellow development posture for an image forming operation on a next sheet. When the conveyance sensor 20 detects the trailing edge of the sheet S, the sheet S is conveyed by the secondary transfer roller 12, the belt driving roller 10b, the fixing unit 40, and the like driven by the motor M3. Therefore, after the conveyance sensor 20 detects the trailing edge of the sheet S, it is not necessary to drive the motor M1 in the second direction R2 in order to discharge the sheet S to the outside of the image forming apparatus 1. When the rotary body 90 moves to the yellow development posture at time t16, the control unit 30 stops the driving of the motor M1 and starts a yellow image forming operation.

In the above-described comparative example, the rotary body 90 is rotated in three divided times until the conveyance of the sheet S is resumed at time t12 after the conveyance sensor 20 detects the leading edge of the sheet S at time t5. That is, by rotating the motor M1 in the first direction R1 between time t6 and time t7, between time t8 and time t9, and between time t10 and time t11, the rotary body 90 rotates.

Therefore, when the conveyance of the sheet S is resumed at time t12, the conveyance drive ratchet gear 370 described with reference to FIG. 18B and FIG. 22A to FIG. 24B is switched from the second non-transmission state to the second transmission state. At this time, after the motor M1 is driven in the second direction R2, in order for the conveyance drive ratchet gear 370 to switch from the second non-transmission state to the second transmission state, the slide engagement part 372 needs to move until it is engaged with the output part 373. That is, after the motor M1 is driven in the second direction R2 until the conveyance drive ratchet gear 370 is switched from the second non-transmission state to the second transmission state, there is a time lag corresponding to a time for movement until the slide engagement part 372 is engaged with the output part 373. Since the timing at which the driving force of the motor M1 is transmitted to the conveyance roller pair 320 shifts by this time lag, the timing at which the conveyance of the sheet S is resumed at time t12 also shifts.

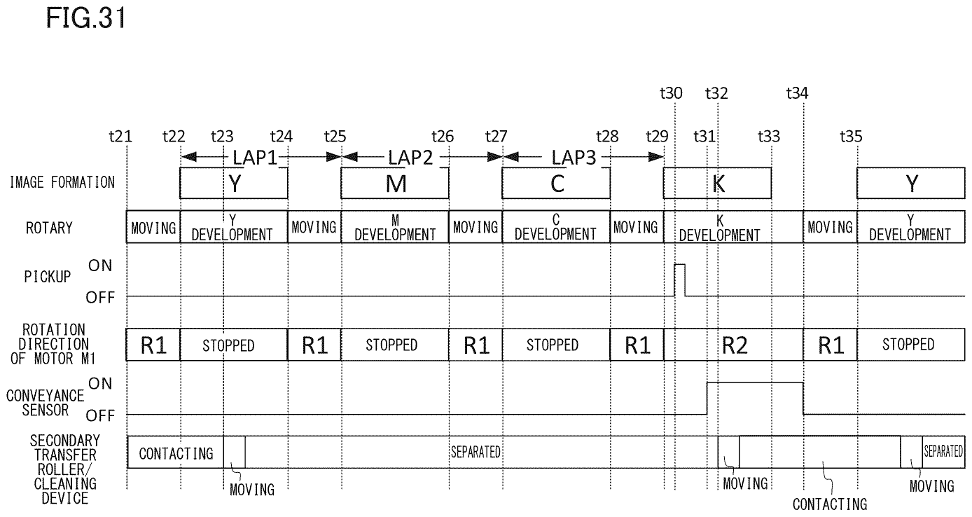

Therefore, the timing at which the sheet reaches the secondary transfer portion varies, and the toner image formed on the intermediate transfer belt 10a cannot be transferred to a desired position of the sheet S in the secondary transfer portion. In order to solve such a problem, in the present embodiment, an image forming operation illustrated in FIG. 31 is executed.

### Image Forming Operation and Conveyance Operation According to First Embodiment

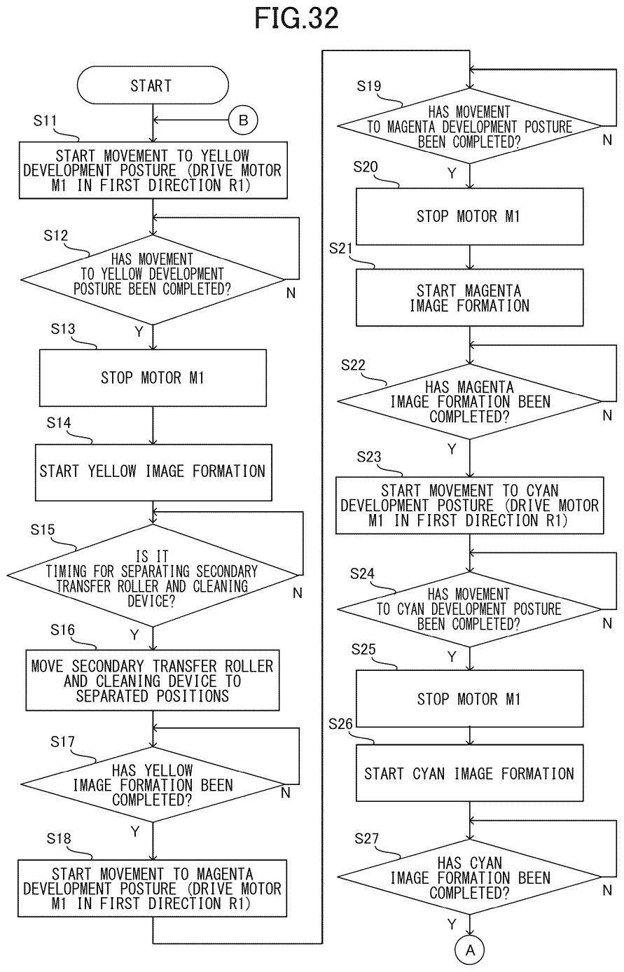

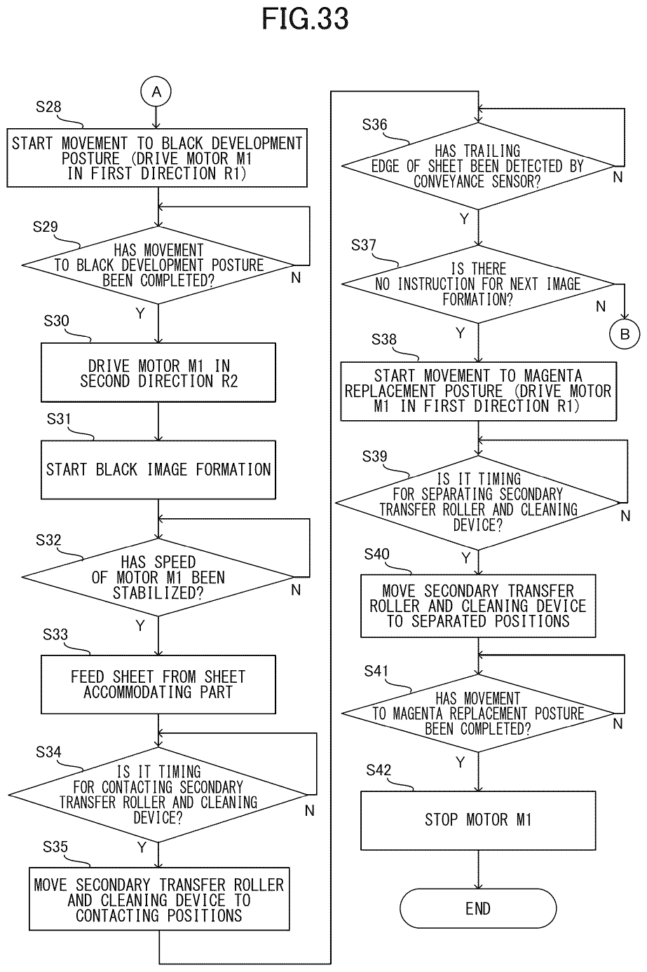

FIG. 31 is a timing chart for explaining an image forming operation and a conveyance operation according to the present embodiment. In the present embodiment, the sheet S is fed after the rotary body 90 is moved to the black development posture. FIGS. 32 and 33 are flowcharts illustrating the image forming operation and the conveyance operation.

As illustrated in FIGS. 31 and 32, the control unit 30 moves the rotary body 90 toward the yellow development posture to start yellow image formation at time t21 (S11). At this time, the control unit 30 drives the motor M1 in the first direction R1. Next, the control unit 30 determines whether the movement of the rotary body 90 to the yellow development posture has been completed (S12). When it is determined that the movement of the rotary body 90 to the yellow development posture has been completed (S12:Y), the control unit 30 stops the driving of the motor M1 and starts yellow image formation at time t22 (S13 and S14).

Next, the control unit 30 determines whether it is a separating timing for moving the secondary transfer roller 12 and the cleaning device 13 from the contacting positions to the separated positions (S15). When it is determined that it is a separating timing at which a predetermined time has elapsed from the start of the yellow image forming operation (S15:Y), the control unit 30 moves the secondary transfer roller 12 and the cleaning device 13 from the contacting positions toward the separated positions at time t23 (S16). Then, the control unit 30 determines whether the yellow image formation has been completed (S17).

When it is determined that the yellow image formation has been completed (S17:Y), the control unit 30 moves the rotary body 90 toward the magenta development posture to start magenta image formation at time t24 (S18). At this time, the control unit 30 drives the motor M1 in the first direction R1. Next, the control unit 30 determines whether the movement of the rotary body 90 to the magenta development posture has been completed (S19). When it is determined that the movement of the rotary body 90 to the magenta development posture has been completed (S19:Y), the control unit 30 stops the driving of the motor M1 and starts magenta image formation at time t25 (S20 and S21). The start of the magenta image formation is executed at a timing when LAP1 has elapsed from the start of the yellow image formation. Each of LAP1, LAP2, and LAP3 corresponds to a time during which the intermediate transfer belt 10a makes one cycle. Then, the control unit determines whether the magenta image formation has been completed (S22).

When it is determined that the magenta image formation has been completed (S22:Y), the control unit 30 moves the rotary body 90 toward the cyan development posture to start cyan image formation at time t26 (S23). At this time, the control unit 30 drives the motor M1 in the first direction R1. Next, the control unit 30 determines whether the movement of the rotary body 90 to the cyan development posture has been completed (S24). When it is determined that the movement of the rotary body 90 to the cyan development posture has been completed (S24:Y), the control unit 30 stops the driving of the motor M1 and starts cyan image formation at time t27 (S25 and S26). Then, the control unit determines whether the cyan image formation has been completed (S27).

When it is determined that the cyan image formation has been completed (S27:Y), the control unit 30 moves the rotary body 90 toward the black development posture to start black image formation at time t28, as illustrated in FIGS. 31 and 33 (S28). At this time, the control unit 30 drives the motor M1 in the first direction R1. Next, the control unit 30 determines whether the movement of the rotary body 90 to the black development posture has been completed (S29). When it is determined that the movement of the rotary body 90 to the black development posture has been completed (S29:Y), the control unit 30 drives the motor M1 in the second direction R2 and starts black image formation at time t29 (S30 and S31).

Next, the control unit 30 determines whether the speed of the motor M1 has been stabilized (S32). Note that the speed of the motor M1 having been stabilized may be determined, for example, based on the fact that a predetermined time has elapsed since the motor M1 started to be driven in the second direction R2, or the fact that a rated current has flowed through the motor M1. When it is determined that the speed of the motor M1 has been stabilized (S32:Y), the control unit 30 feeds a sheet S from the sheet accommodating portion 300, that is, executes a feeding operation, at time t30 (S33). By executing the feeding operation, the sheet S is conveyed in the sheet conveyance direction CD toward the secondary transfer portion, and the conveyance sensor 20 detects the leading edge of the sheet at time t31. Even when the conveyance sensor 20 detects the leading edge of the sheet, the conveyance of the sheet S is continued, and accordingly, the motor M1 continues to be driven in the second direction R2. That is, the rotary body 90 maintains the black development posture.

Next, the control unit 30 determines whether it is a contacting timing for moving the secondary transfer roller 12 and the cleaning device 13 from the separated positions to the contacting positions (S34). When it is determined that it is a contacting timing at which a predetermined time has elapsed from the start of the black image forming operation (S34:Y), the control unit 30 moves the secondary transfer roller 12 and the cleaning device 13 from the separated positions toward the contacting positions at time t32 (S35). Here, the timing at which the secondary transfer roller 12 and the cleaning device 13 are moved to the contacting positions needs to be before the full-color toner image formed on the intermediate transfer belt 10a reaches the secondary transfer portion. Even when the black image formation is completed at time t33, the motor M1 continues to be driven in the second direction R2 in order to convey the sheet S.

Then, the control unit 30 determines whether the trailing edge of the sheet S has been detected by the conveyance sensor 20 (S36). For example, when it is determined that the trailing edge of the sheet S has been detected by the conveyance sensor 20 at time t34 (S36:Y), the control unit 30 determines whether there is no instruction for a next image forming operation from the host computer 3002 (S37). When the trailing edge of the sheet S is detected by the conveyance sensor 20, the leading edge of the sheet S is passing through the secondary transfer portion. That is, the motor M1 is controlled to continue to be driven in the second direction R2 at least until the sheet S reaches the secondary transfer roller 12.

When there is an instruction for a next image forming operation from the host computer 3002 (S37:N), the control unit 30 moves the rotary body 90 toward the yellow development posture to start image formation on a next sheet at time t34 (S11). When the rotary body 90 moves to the yellow development posture at time t35, the control unit 30 stops the driving of the motor M1 and starts a yellow image forming operation. Note that the timing chart illustrated in FIG. 31 exemplifies a case where there is an instruction for a next image forming operation from the host computer 3002.

On the other hand, when there is no instruction for a next image forming operation from the host computer 3002 (S37:Y), the control unit 30 moves the rotary body 90 toward the magenta replacement posture (S38). At this time, the control unit 30 drives the motor M1 in the first direction R1. The magenta replacement posture, which is a non-development posture, is a posture immediately before the black development posture in the clockwise direction of FIG. 1, which is the normal rotation direction of the rotary body 90. That is, for example, when there is an instruction for a next monochrome image forming operation from the host computer 3002, the rotary body 90 can be immediately moved to the black development posture.

When the rotary body 90 is located in the magenta replacement posture, all of the developing rollers 51y, 51m, 51c, and 51k are separated from the photosensitive drum 2. In other words, when the rotary body 90 is located in the magenta replacement posture, none of the developing rollers 51y, 51m, 51c, and 51k faces the photosensitive drum 2. Therefore, the wear of the developing rollers 51y, 51m, 51c, and 51k and the photosensitive drum 2 can be suppressed, thereby extending the life of the image forming apparatus 1.

Next, the control unit 30 determines whether it is a timing for separating the secondary transfer roller 12 and the cleaning device 13 (S39). When it is determined that it is a separating timing at which a predetermined time has elapsed since the conveyance sensor 20 detected the trailing edge of the sheet S (S39:Y), the control unit 30 moves the secondary transfer roller 12 and the cleaning device 13 from the contacting positions toward the separated positions (S40).

Further, the control unit 30 determines whether the movement of the rotary body 90 to the magenta replacement posture has been completed (S41). When it is determined that the movement of the rotary body 90 to the magenta replacement posture has been completed (S41:Y), the control unit 30 stops the driving of the motor M1. Then, the image forming operation and the conveyance operation illustrated in FIGS. 32 and 33 are completed.

In this manner, in the present embodiment, the motor M1 continues to be driven in the second direction R2 until the conveyance sensor 20 detects the trailing edge of the sheet S at time t34 after the conveyance sensor 20 detects the leading edge of the sheet S at time t31. In other words, after the conveyance sensor 20 detects the leading edge of the sheet S, the motor M1 is controlled to continue to be driven in the second direction R2 at least until the sheet S reaches the secondary transfer roller 12.

For this reason, after the leading edge of the sheet S is detected by the conveyance sensor 20, the conveyance drive ratchet gear 370 continues to maintain the second transmission state. In this manner, since the conveyance drive ratchet gear 370 does not transition between the second transmission state and the second non-transmission state, the timing at which the driving force is transmitted from the motor M1 to the conveyance roller pair 320 does not shift. After the leading edge of the sheet S passes through the conveyance sensor 20, the sheet S is conveyed to the secondary transfer portion by the conveyance roller pair 320. In this manner, the leading edge position of the sheet S can be accurately managed by the conveyance roller pair 320, thereby suppressing a variation in timing at which the sheet S reaches the secondary transfer portion, and transferring the toner image to a desired position of the sheet S in the secondary transfer portion. Therefore, the quality of the output sheet can be improved.

In order to realize the control described with reference to FIGS. 31 to 33, it is necessary to convey the sheet S such that the leading edge of the sheet S reaches the secondary transfer roller 12 in accordance with the timing at which the leading edge of the color image formed on the intermediate transfer belt 10a reaches the secondary transfer roller 12.

Here, a distance until the leading edge of the image reaches the secondary transfer roller 12 after the exposure of the photosensitive drum 2 for the image forming operation is started is defined as Dimage, and a time until the speed is stabilized after the motor M1 is driven in the second direction R2 is defined as TM1. Further, a distance until the leading edge of the sheet S reaches the secondary transfer roller 12 after the operation of feeding the sheet S is started is defined as Dsheet, a driving speed of the intermediate transfer belt 10a is defined as Sbelt, and a conveyance speed of the sheet S is defined as Ssheet. At this time, in order to convey the sheet S such that the leading edge of the sheet S reaches the secondary transfer roller 12 in accordance with the timing at which the leading edge of the color image formed on the intermediate transfer belt 10a reaches the secondary transfer roller 12, the following relational expression needs to be satisfied.

$$( Dimage \div Sbelt ) \geq ( TM 1 + ( Dsheet \div Ssheet ) ) \qquad ( Mathematical Formula 1 )$$

As described above, in the present embodiment, the control unit 30 controls the motor M1 in the image forming operation such that the sheet S is detected by the conveyance sensor 20 after moving the rotary body 90 to the black development posture, which is a predetermined development posture. The black development posture is a development posture to which the rotary body 90 moves last when forming a color image, among the yellow development posture, the magenta development posture, the cyan development posture, and the black development posture as a plurality of development postures. Therefore, after the sheet S is detected by the conveyance sensor 20, the motor M1 is not driven in the first direction R1 in order to drive the rotary body 90. That is, after moving the rotary body 90 to the black development posture, the control unit 30 starts a conveyance operation (pickup operation), and then controls the motor M1 to continue rotating in the second direction R2 until the sheet S reaches the secondary transfer roller 12.

Therefore, the rotation direction of the motor M1 is not switched between the first direction R1 and the second direction R2 until the sheet S reaches the secondary transfer portion after the sheet S reaches the conveyance sensor 20. As a result, after the leading edge of the sheet S is detected by the conveyance sensor 20, the conveyance drive ratchet gear 370 continues to maintain the second transmission state, thereby suppressing a variation in timing at which the sheet S reaches the secondary transfer portion, and transferring the toner image to a desired position of the sheet S in the secondary transfer portion.

Further, in the present embodiment, after the rotary body 90 is moved to the black development posture, the operation of feeding the sheet S is started by the pickup roller 310, and thereafter, the motor M1 continues to be driven in the second direction R2 at least until the sheet S reaches the secondary transfer portion. Therefore, the sheet S fed by the pickup roller 310 is conveyed to the secondary transfer portion without being stopped by the feed roller 311, the separation roller 312, and the conveyance roller pair 320. As a result, it is possible to suppress a variation in timing at which the sheet S reaches the secondary transfer portion, and transfer the toner image to a desired position of the sheet S in the secondary transfer portion. Even if yellow, magenta, or cyan image formation fails for some reason, it is not necessary to wastefully consume the sheet S.

### Second Embodiment

Next, an image forming apparatus according to the second embodiment will be described. In the second embodiment, the image forming operation and the conveyance operation according to the first embodiment are changed. Specifically, the image forming operation and the conveyance operation according to the second embodiment include a retry operation, which will be described below. Note that the image forming apparatus 1 may perform the image forming operation and the conveyance operation described below in the second embodiment only when the retry operation is necessary, and may perform the image forming operation and the conveyance operation described in the first embodiment when the retry operation is not necessary. Therefore, configurations similar to those of the first embodiment will not be illustrated or will be described with the same reference signs being given in the drawings.

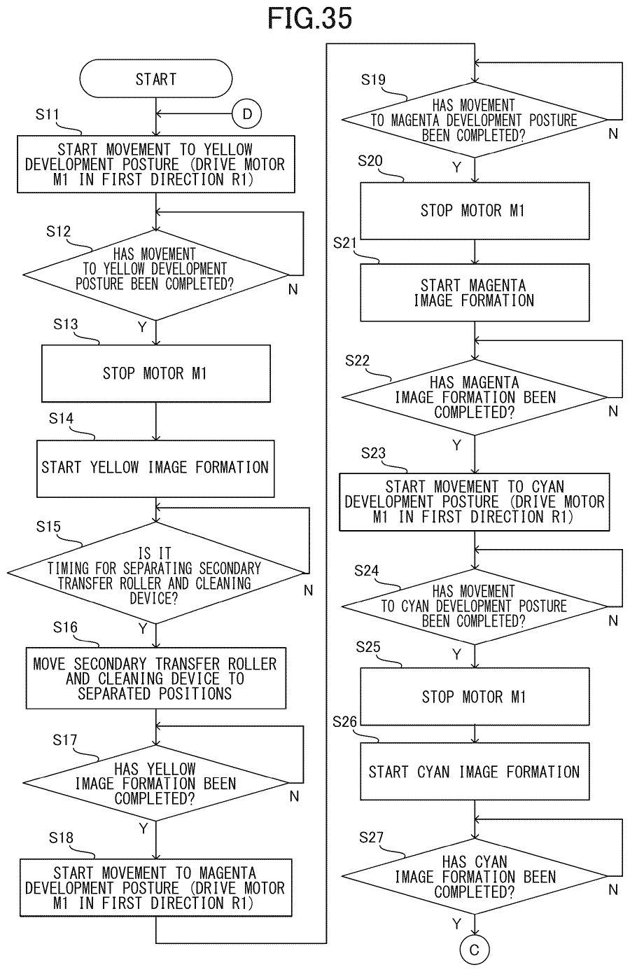

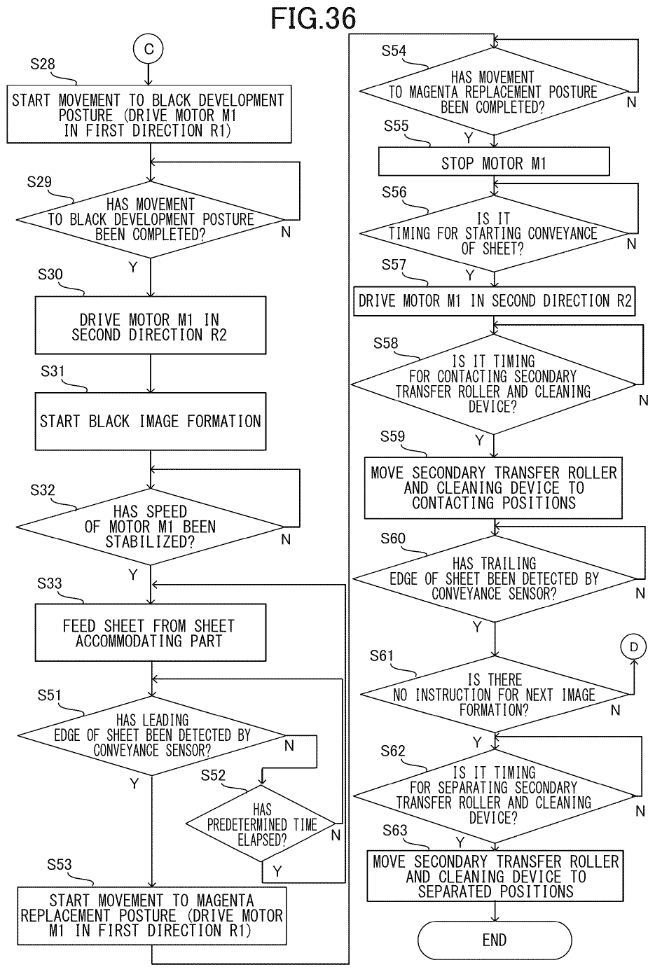

FIG. 34 is a timing chart for explaining an image forming operation and a conveyance operation according to the second embodiment. In the present embodiment as well, the sheet S is fed after the rotary body 90 is moved to the black development posture. FIGS. 35 and 36 are flowcharts illustrating the image forming operation and the conveyance operation.

From time t21 to time t30 in FIG. 34, the same image forming operation and conveyance operation as those from time t21 to time t30 in FIG. 31 are performed. In addition, in S11 to S33 of FIGS. 35 and 36, the same processing is executed as that in S11 to S33 of FIGS. 32 and 33. That is, the same operation is executed from the start of the image forming operation to the start of the feeding operation (pickup operation) between the first and second embodiments. Therefore, the description thereof will be omitted.

As illustrated in FIGS. 34 to 36, after the feeding operation is executed by the pickup roller 310 at time t30, the control unit 30 determines whether the conveyance sensor 20 has detected the sheet S (S51). When the conveyance sensor 20 has not detected the sheet S (S51:N), the control unit 30 determines whether a predetermined time has elapsed since the feeding operation was performed (S52).

When the predetermined time has not elapsed since the feeding operation was performed (S52:N), the processing returns to step S51. When the predetermined time has elapsed since the feeding operation was performed (S52:Y), the processing returns to step S33, and the feeding operation is executed again by the pickup roller 310. In this manner, unless the conveyance sensor 20 detects the sheet S, the control unit 30 loops steps S33, S51, and S52 and executes a retry operation of performing the feeding operation again. In the example of the timing chart illustrated in FIG. 34, the control unit 30 executes the retry operation only once at time t41. However, the retry operation may be performed twice or more.

After the black image forming operation has been completed at time t42, when the conveyance sensor 20 detects the sheet S at time t43 (S51:Y), the control unit 30 moves the rotary body 90 toward the magenta replacement posture (S53). At this time, the control unit 30 drives the motor M1 in the first direction R1. That is, in the present embodiment, when the conveyance sensor 20 detects the leading edge of the sheet S at time t43, the rotation direction of the motor M1 is switched from the second direction R2 to the first direction R1, and accordingly, the conveyance of the sheet S by the conveyance roller pair 320 is temporarily stopped.

Next, the control unit 30 determines whether the movement of the rotary body 90 to the magenta replacement posture has been completed (S54). When it is determined that the movement of the rotary body 90 to the magenta replacement posture has been completed (S54:Y), the control unit 30 stops the driving of the motor M1 at time t44 (S55).

Next, the control unit 30 determines whether it is a timing for starting (resuming) the conveyance of the sheet S (S56). When it is determined that it is a timing for starting the conveyance of the sheet S (S56:Y), the control unit 30 drives the motor M1 in the second direction R2 at time t46 (S57). Then, the control unit 30 determines whether it is a timing for contacting the secondary transfer roller 12 and the cleaning device 13 (S58). When it is determined that it is a contacting timing (S58:Y), the control unit 30 moves the secondary transfer roller 12 and the cleaning device 13 from the separated positions toward the contacting positions at time t47 (S59).

Next, the control unit 30 determines whether the trailing edge of the sheet S has been detected by the conveyance sensor 20 (S60). When the trailing edge of the sheet S has been detected by the conveyance sensor 20 (S60:Y), the control unit 30 determines whether there is no instruction for a next image forming operation from the host computer 3002 (S61). When there is an instruction for a next image forming operation from the host computer 3002 (S61:N), the control unit 30 moves the rotary body 90 toward the yellow development posture to start image formation on a next sheet at time t48 (S11). When the rotary body 90 moves to the yellow development posture at time t49, the control unit 30 stops the driving of the motor M1 and starts a yellow image forming operation. Note that the timing chart illustrated in FIG. 34 exemplifies a case where there is an instruction for a next image forming operation from the host computer 3002.

On the other hand, when there is no instruction for a next image forming operation from the host computer 3002 (S61:Y), the control unit 30 determines whether it is a timing for separating the secondary transfer roller 12 and the cleaning device 13 (S62). When it is determined that it is a separating timing at which a predetermined time has elapsed since the conveyance sensor 20 detected the trailing edge of the sheet S (S62:Y), the control unit 30 moves the secondary transfer roller 12 and the cleaning device 13 from the contacting positions toward the separated positions (S63). Then, the image forming operation and the conveyance operation illustrated in FIGS. 35 and 36 are completed.

As described above, in the present embodiment, even though the feeding operation is executed at time t30, if the conveyance sensor 20 cannot detect the leading edge of the sheet S within the predetermined time, the retry operation, which is a re-feeding operation, is executed by the pickup roller 310. As a result, the waste of the sheet S and the toner can be suppressed.

When such a retry operation is executed, the control unit 30 moves the rotary body 90 to the magenta replacement posture. As a result, the photosensitive drum 2 does not contact the developing rollers 51y, 51m, 51c, and 51k of the rotary body 90. Therefore, the wear of the developing rollers 51y, 51m, 51c, and 51k and the photosensitive drum 2 can be suppressed, thereby extending the life of the image forming apparatus 1. In the present embodiment, the black image forming operation is started before the leading edge of the sheet S is detected by the conveyance sensor 20.

In the present embodiment, even if the timing at which the sheet S is detected by the conveyance sensor 20 is delayed, the secondary transfer roller 12 and the cleaning device 13 are maintained at the separated positions at least until time t45 when LAP4 in FIG. 34 has elapsed. LAP4 corresponds to a time from the start of black image formation until the intermediate transfer belt 10a makes one cycle. Therefore, even though the black toner image is transferred from the photosensitive drum 2 to the intermediate transfer belt 10a, the color toner images formed on the intermediate transfer belt 10a do not come into contact with the secondary transfer roller 12 and the cleaning device 13 during LAP4.

Then, after LAP4 has elapsed, the control unit 30 moves the secondary transfer roller 12 and the cleaning device 13 from the separated positions toward the contacting positions at time t47. In other words, the control unit 30 moves the secondary transfer roller 12 and the cleaning device 13 to the contacting positions after the conveyance sensor 20 detects the leading edge of the sheet S and after the rotary body 90 is rotated from the black development posture to the magenta replacement posture. Therefore, after the intermediate transfer belt 10a runs idle during LAP4 in a state where the color toner images are held on the intermediate transfer belt 10a, the color toner images formed on the intermediate transfer belt 10a can be transferred onto the sheet S in the secondary transfer portion. In this manner, a time for executing the retry operation can be secured. In order to perform the retry operation, the timing for determining whether to perform the retry operation needs to be set to be before the timing at which the secondary transfer roller 12 starts to move toward the contacting position.

Here, a distance until the leading edge of the image reaches the secondary transfer roller 12 after the exposure of the photosensitive drum 2 for the image forming operation is started is defined as Dimage, and a time until the speed is stabilized after the motor M1 is driven in the second direction R2 is defined as TM1. Further, a distance until the leading edge of the sheet S reaches the secondary transfer roller 12 after the operation of feeding the sheet S is started is defined as Dsns, a driving speed of the intermediate transfer belt 10a is defined as Sbelt, and a conveyance speed of the sheet S is defined as Ssheet. In addition, a time required to move the secondary transfer roller 12 from the separated position to the contacting position is defined as T2_on. At this time, in order to perform the retry operation, the following relational expression needs to be satisfied.

$$( TM 1 + ( Dsns \div Ssheet ) ) < ( ( Dimage \div Sbelt ) - T2\_on ) \qquad ( Mathematical Formula 2 )$$

In the present embodiment as well, similarly to the first embodiment, the control unit 30 controls the motor M1 in the image forming operation such that the sheet S is detected by the conveyance sensor 20 after moving the rotary body 90 to the black development posture, which is a predetermined development posture. For example, if the rotary body 90 changes its posture many times after the sheet S is detected by the conveyance sensor 20 and before the image is transferred onto the sheet in the secondary transfer portion, there is a possibility that the leading edge position of the sheet S may shift due to vibration when the rotary body 90 rotates. On the other hand, in the present embodiment, after the sheet S is detected by the conveyance sensor 20, the number of times the motor M1 is driven to drive the rotary body 90 can be reduced. As a result, it is possible to suppress a variation in timing at which the sheet S reaches the secondary transfer portion, and transfer the toner image to a desired position of the sheet S in the secondary transfer portion. In addition, since the operation of feeding the sheet S is started after the rotary body 90 moves to the black development posture, it is not necessary to wastefully consume the sheet S even if yellow, magenta, or cyan image formation fails for some reason.

### Third Embodiment

Next, an image forming apparatus according to the third embodiment will be described. In the third embodiment, the image forming operation and the conveyance operation according to the second embodiment are changed. Specifically, in a case where the image forming apparatus 1 has a configuration in which the relational expression (Mathematical Formula 2) described in the second embodiment is not satisfied, an image forming operation and a conveyance operation are executed in the third embodiment so that a retry operation can be executed. Note that the image forming apparatus 1 may perform the image forming operation and the conveyance operation described below in the third embodiment only when the retry operation is necessary, and may perform the image forming operation and the conveyance operation described in the first embodiment when the retry operation is not necessary. Therefore, configurations similar to those of the first and second embodiments will not be illustrated or will be described with the same reference signs being given in the drawings.

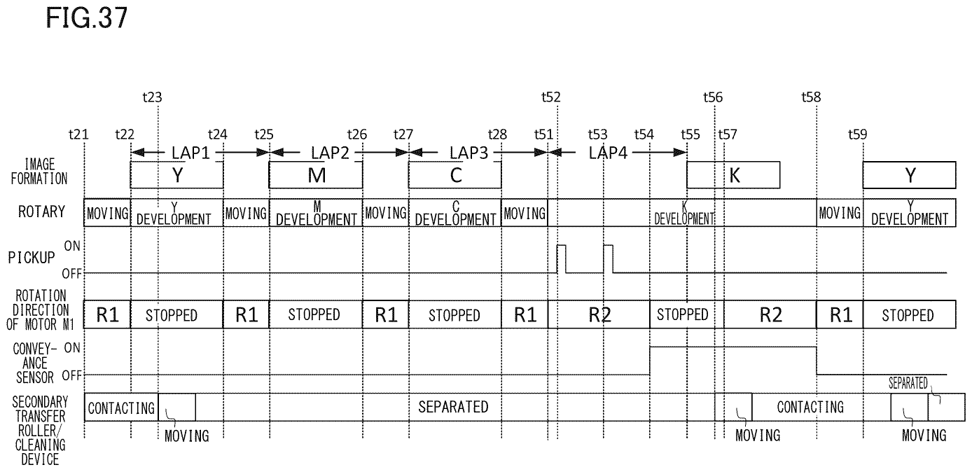

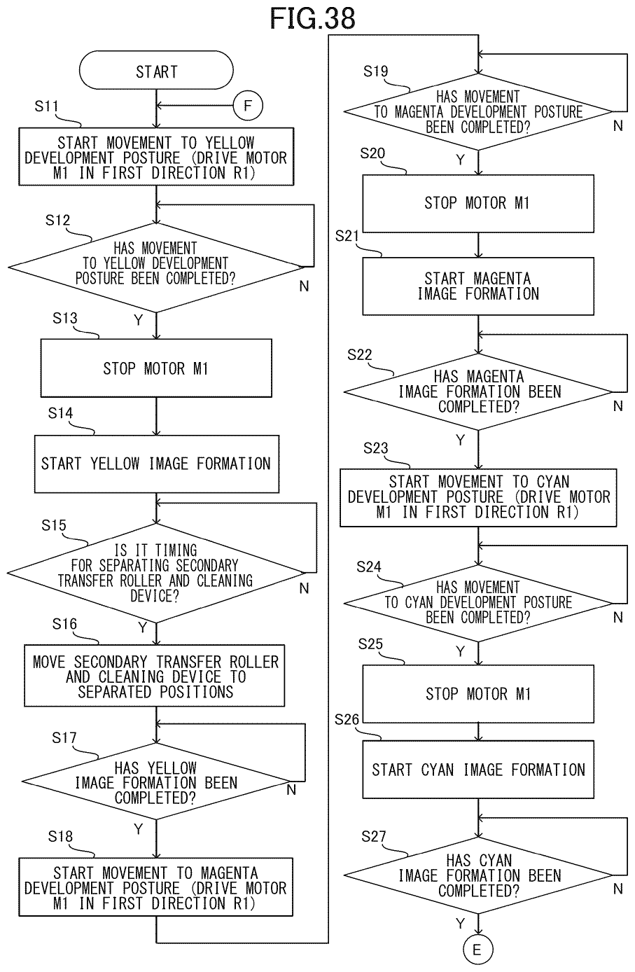

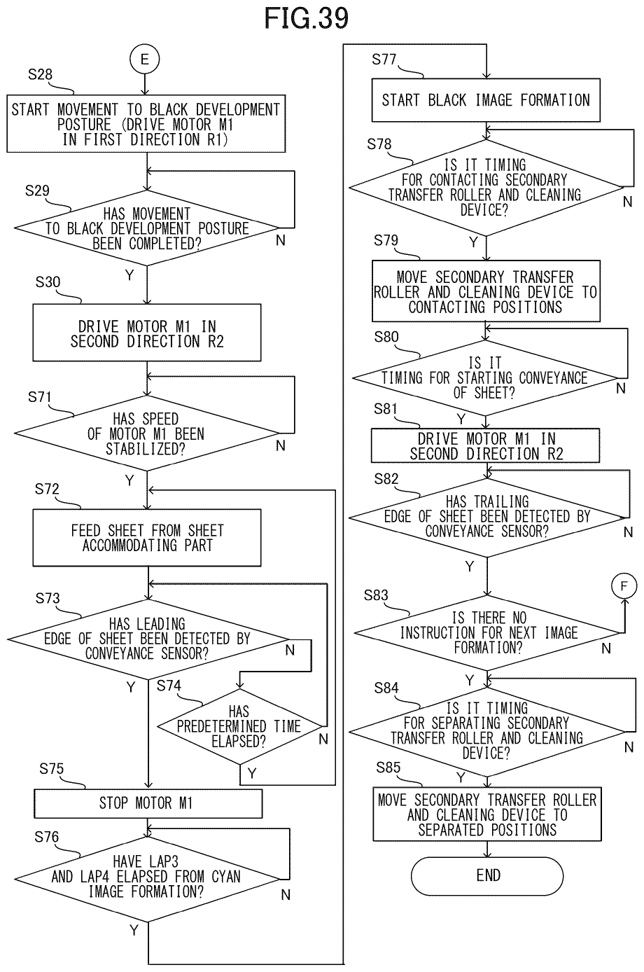

FIG. 37 is a timing chart for explaining an image forming operation and a conveyance operation according to the third embodiment. In the present embodiment as well, the sheet S is fed after the rotary body 90 is moved to the black development posture. FIGS. 38 and 39 are flowcharts illustrating the image forming operation and the conveyance operation.

From time t21 to time t28 in FIG. 37, the same image forming operation and conveyance operation as those from time t21 to time t28 in FIG. 34 are performed. In addition, in S11 to S30 of FIGS. 38 and 39, the same processing is executed as that in S11 to S30 of FIGS. 35 and 36. That is, the same operation is executed from the start of the image forming operation to the completion of the cyan image formation between the second and third embodiments. Therefore, the description thereof will be omitted.

As illustrated in FIGS. 37 to 39, after the cyan image formation has been completed at time t28, the control unit 30 moves the rotary body 90 toward the black development posture to start the black image formation (S28). At this time, the control unit 30 drives the motor M1 in the first direction R1. Next, the control unit 30 determines whether the movement of the rotary body 90 to the black development posture has been completed (S29). When it is determined that the movement of the rotary body 90 to the black development posture has been completed (S29:Y), the control unit 30 drives the motor M1 in the second direction R2 at time t51 (S30). In the present embodiment, at this time, the black image forming operation is not started.

Next, the control unit 30 determines whether the speed of the motor M1 has been stabilized (S71). When it is determined that the speed of the motor M1 has been stabilized (S71:Y), the control unit 30 feeds a sheet S from the sheet accommodating portion 300, that is, executes a feeding operation, at time t52 (S72). Next, the control unit 30 determines whether the conveyance sensor 20 has detected the sheet S (S73). When the conveyance sensor 20 has not detected the sheet S (S73:N), the control unit 30 determines whether a predetermined time has elapsed since the feeding operation was performed (S74).

When the predetermined time has not elapsed since the feeding operation was performed (S74:N), the processing returns to step S73. When the predetermined time has elapsed since the feeding operation was performed (S74:Y), the processing returns to step S72, and the feeding operation is executed again by the pickup roller 310. In this manner, unless the conveyance sensor 20 detects the sheet S, the control unit 30 loops step S72, S73, and S74 and executes a retry operation of performing the feeding operation again. In the example of the timing chart illustrated in FIG. 37, the control unit 30 executes the retry operation only once at time t53. However, the retry operation may be performed twice or more.

When the conveyance sensor 20 has detected the sheet S at time t54 (S73:Y), the control unit 30 stops the driving of the motor M1 (S75). That is, in the present embodiment, when the conveyance sensor 20 detects the leading edge of the sheet S at time t54, the driving of the motor M1 is stopped, and accordingly, the conveyance of the sheet S by the conveyance roller pair 320 is temporarily stopped. Next, the control unit 30 determines whether LAP3 and LAP4 have elapsed from the start of cyan image formation (S76). The sum of LAP3 and LAP4 corresponds to a time during which the intermediate transfer belt 10a rotates by two cycles. When it is determined that LAP3 and LAP4 have elapsed from the start of cyan image formation (S76:Y), the control unit 30 starts black image formation at time t55 (S77). That is, in the present embodiment, the black image forming operation is started after the leading edge of the sheet S is detected by the conveyance sensor 20.

Next, the control unit 30 determines whether it is a timing for contacting the secondary transfer roller 12 and the cleaning device 13 (S78). When it is determined that it is a contacting timing (S78:Y), the control unit 30 moves the secondary transfer roller 12 and the cleaning device 13 from the separated positions toward the contacting positions at time t56 (S79). Further, the control unit 30 determines whether it is a timing for starting (resuming) the conveyance of the sheet S (S80). When it is determined that it is a timing for starting the conveyance of the sheet S (S80:Y), the control unit 30 drives the motor M1 in the second direction R2 at time t57 (S81).

Next, the control unit 30 determines whether the trailing edge of the sheet S has been detected by the conveyance sensor 20 (S82). When the trailing edge of the sheet S has been detected by the conveyance sensor 20 (S82:Y), the control unit 30 determines whether there is no instruction for a next image forming operation from the host computer 3002 (S83). When there is an instruction for a next image forming operation from the host computer 3002 (S83:N), the control unit 30 moves the rotary body 90 toward the yellow development posture to start image formation on a next sheet at time t58 (S11). When the rotary body 90 moves to the yellow development posture at time t59, the control unit 30 stops the driving of the motor M1 and starts a yellow image forming operation. Note that the timing chart illustrated in FIG. 37 exemplifies a case where there is an instruction for a next image forming operation from the host computer 3002.

On the other hand, when there is no instruction for a next image forming operation from the host computer 3002 (S83:Y), the control unit 30 determines whether it is a timing for separating the secondary transfer roller 12 and the cleaning device 13 (S84). When it is determined that it is a separating timing at which a predetermined time has elapsed since the conveyance sensor 20 detected the trailing edge of the sheet S (S84:Y), the control unit 30 moves the secondary transfer roller 12 and the cleaning device 13 from the contacting positions toward the separated positions (S85). Then, the image forming operation and the conveyance operation illustrated in FIGS. 38 and 39 are completed.

As described above, in the present embodiment, even though the feeding operation is executed at time t52, if the conveyance sensor 20 cannot detect the leading edge of the sheet S within the predetermined time, the retry operation, which is a re-feeding operation, is executed by the pickup roller 310. As a result, the waste of the sheet S and the toner can be suppressed.

In the present embodiment, the black image forming operation is not started until the conveyance sensor 20 detects the leading edge of the sheet S. More specifically, the control unit 30 starts the black image forming operation after LAP3 and LAP4, which correspond to a time for two cycles of the intermediate transfer belt 10a, have elapsed from the start of cyan image formation.

In the present embodiment, the secondary transfer roller 12 and the cleaning device 13 are maintained at the separated positions at least until time t55 when LAP3 and LAP4 in FIG. 37 have elapsed. Therefore, the yellow, magenta, and cyan toner images formed on the intermediate transfer belt 10a do not come into contact with the secondary transfer roller 12 and the cleaning device 13 during LAP4.

Then, after LAP4 has elapsed, the control unit 30 starts the black image forming operation at time t55, and then moves the secondary transfer roller 12 and the cleaning device 13 from the separated positions toward the contacting positions at time t56. In other words, the control unit 30 moves the secondary transfer roller 12 and the cleaning device 13 to the contacting positions after the conveyance sensor 20 detects the leading edge of the sheet S and after the black image forming operation is started. Therefore, after the intermediate transfer belt 10a runs idle during LAP4 in a state where the yellow, magenta, and cyan toner images are held on the intermediate transfer belt 10a, the black toner image borne on the photosensitive drum 2 is transferred to the intermediate transfer belt 10a. Then, the color toner images formed on the intermediate transfer belt 10a can be transferred onto the sheet S in the secondary transfer portion.

In this manner, a time for executing the retry operation can be secured. In addition, in a case where the image forming apparatus 1 has a configuration in which the relational expression (Mathematical Formula 2) of the second embodiment is not satisfied, even if the arrival of the sheet S to the conveyance sensor 20 is delayed, the retry operation can be performed by delaying the timing for performing the black image forming operation.

In the present embodiment as well, similarly to the first embodiment, the control unit 30 controls the motor M1 in the image forming operation such that the sheet S is detected by the conveyance sensor 20 after moving the rotary body 90 to the black development posture, which is a predetermined development posture. For example, if the rotary body 90 changes its posture many times after the sheet S is detected by the conveyance sensor 20 and before the image is transferred onto the sheet in the secondary transfer portion, there is a possibility that the leading edge position of the sheet S may shift due to vibration when the rotary body 90 rotates. On the other hand, in the present embodiment, after the sheet S is detected by the conveyance sensor 20, the number of times the motor M1 is driven to drive the rotary body 90 can be reduced. In addition, the rotation direction of the motor M1 is not switched to the first direction R1 until the sheet S reaches the secondary transfer roller 12 after the sheet S is detected by the conveyance sensor 20. As a result, it is possible to suppress a variation in timing at which the sheet S reaches the secondary transfer portion, and transfer the toner image to a desired position of the sheet S in the secondary transfer portion. In addition, since the operation of feeding the sheet S is started after the rotary body 90 moves to the black development posture, it is not necessary to wastefully consume the sheet S even if yellow, magenta, or cyan image formation fails for some reason.

In the configuration described in the present embodiment, even when the sheet S is normally conveyed without performing the retry operation, it is necessary to delay the black image forming operation by one cycle (LAP4 in FIG. 37) of the intermediate transfer belt 10a, which reduces productivity. Therefore, the configuration described in the first embodiment may be adopted for a normal image forming operation, and the configuration described in the present embodiment may be provided as a help mode and implemented under a specific condition. Examples of the specific condition include a case where a user designates the help mode and a case where special paper (such as paper of poor quality that is prone to paper conveyance failure) is used. Additional examples of the specific condition include a case where rollers (pickup roller 310, feed roller 311, separation roller 312, and conveyance roller pair 320) that convey the sheet S deteriorate. Note that the specific condition is not limited thereto, and the configuration described in the present embodiment may be implemented under other conditions.

### Fourth Embodiment

Next, an image forming apparatus according to the fourth embodiment will be described. In the fourth embodiment, the image forming operation and the conveyance operation according to the second embodiment are changed. Specifically, the fourth embodiment has a configuration for shortening the distance Dsns so as to reduce the value on the left side of (Mathematical Formula 2), which is the relational expression described in the second embodiment. As a result, the relational expression (Mathematical Formula 2) is easily satisfied, and the condition under which the retry operation can be performed is relaxed. Therefore, configurations similar to those of the second embodiment will not be illustrated or will be described with the same reference signs being given in the drawings.

### Overall Configuration of Image Forming Apparatus

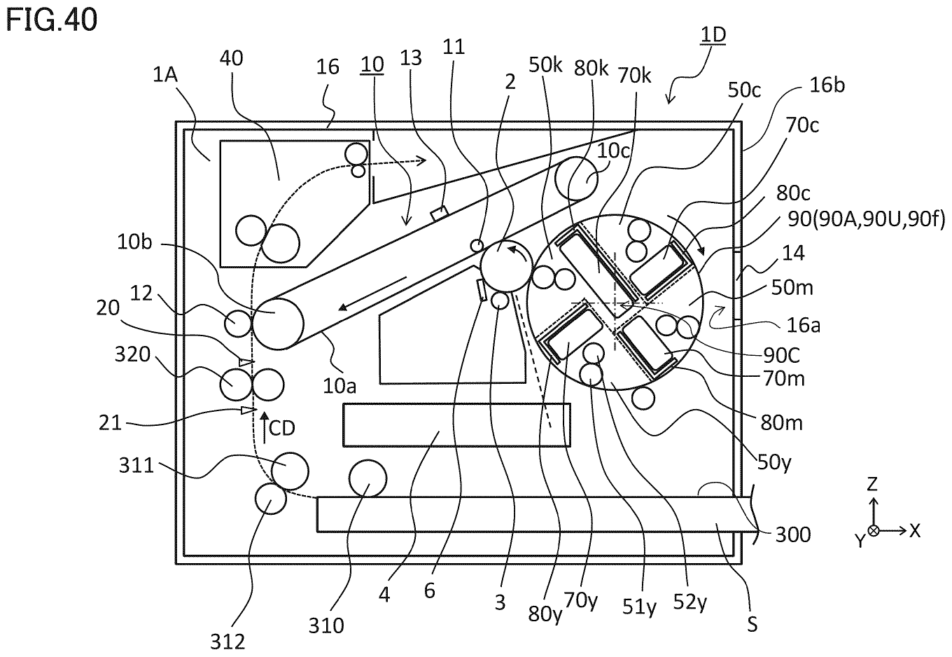

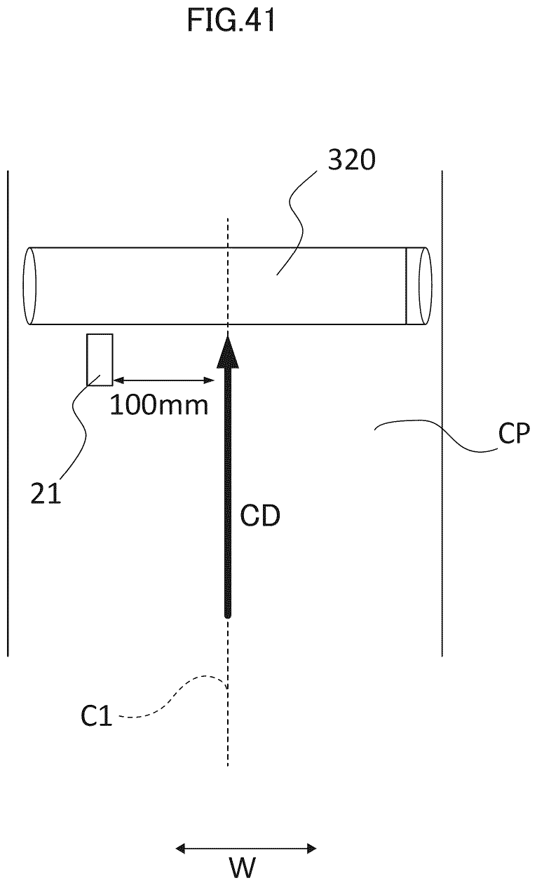

First, an overall configuration of an image forming apparatus 1D according to the fourth embodiment will be described with reference to FIGS. 40 and 41. FIG. 40 is a schematic view illustrating a cross-sectional configuration of the image forming apparatus 1D according to the fourth embodiment. FIG. 41 is a schematic view illustrating a width sensor 21.

As illustrated in FIG. 40, the image forming apparatus 1D includes a width sensor 21 serving as a width detection unit. As illustrated in FIGS. 40 and 41, the width sensor 21 is disposed upstream of the conveyance sensor 20 in the sheet conveyance direction CD. In the present embodiment, the width sensor 21 is disposed upstream of the conveyance roller pair 320 in the sheet conveyance direction CD, but may be disposed between the conveyance roller pair 320 and the conveyance sensor 20.

The width sensor 21 is disposed at a position shifted by 100 mm from the center C1 of the conveyance path CP in the width direction W orthogonal to the sheet conveyance direction CD. In the present embodiment, the sheet S is conveyed such that the center C1 of the conveyance path CP and the center of the sheet S coincide with each other, and thus, the width sensor 21 can detect the sheet S having a width of 200 mm or more. That is, the width sensor 21 also functions as a sensor that measures the width size of the sheet S. For example, the target temperature of the fixing unit 40 or the like may be controlled according to the detection result of the width sensor 21.

### Image Forming Operation and Conveyance Operation

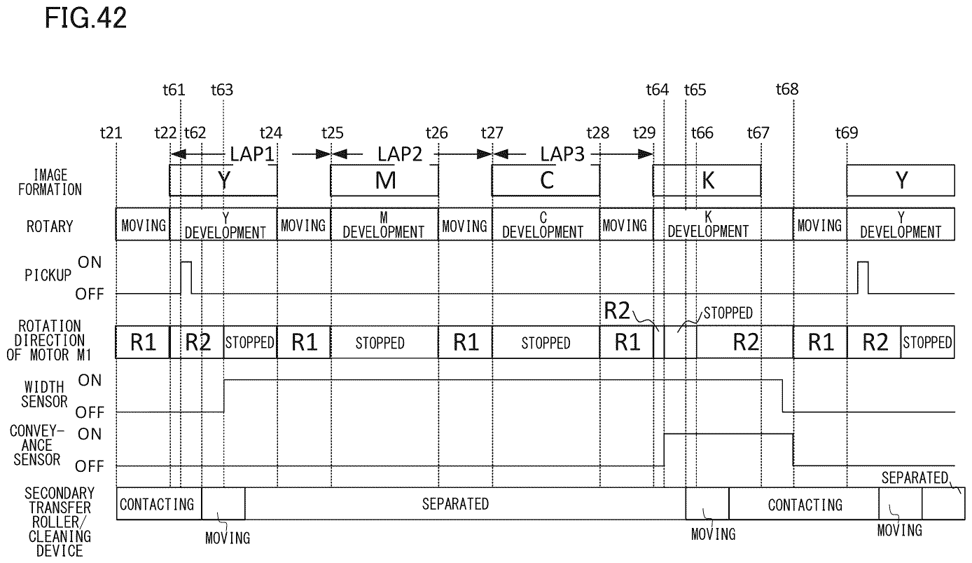

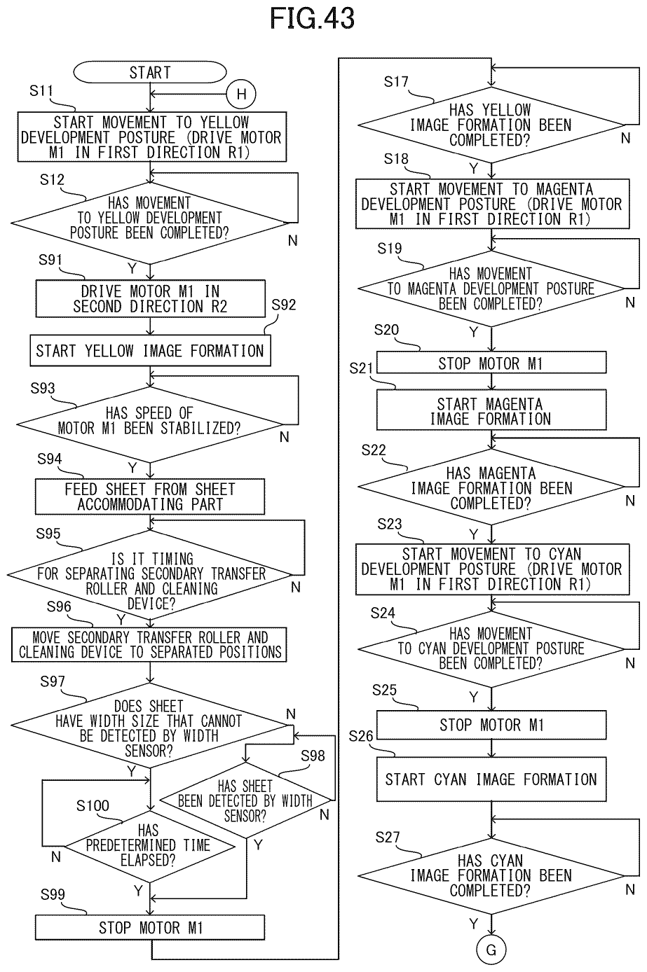

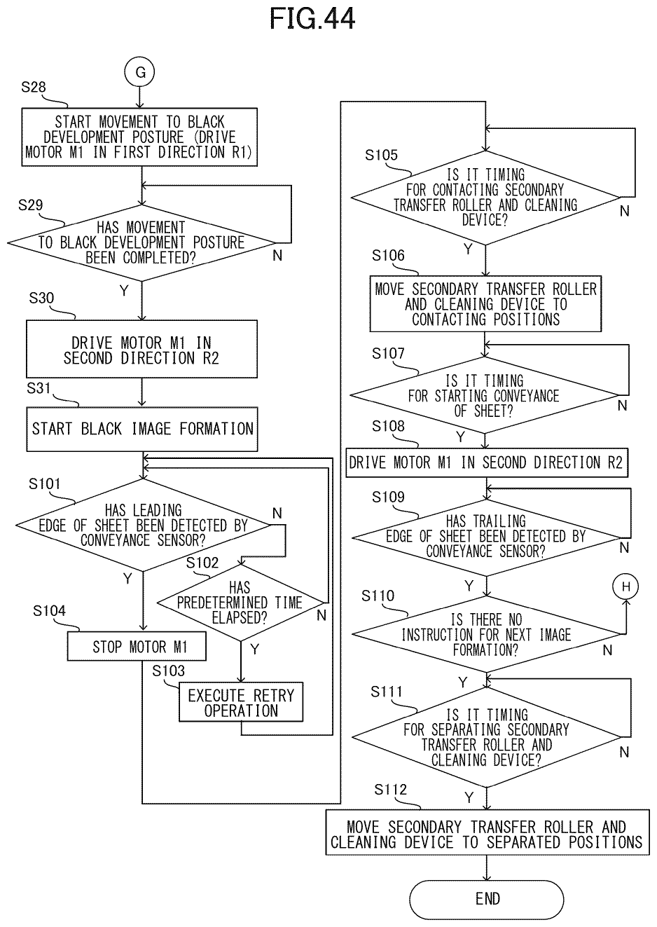

Next, an image forming operation and a conveyance operation according to the fourth embodiment will be described with reference to FIGS. 42 to 44. FIG. 42 is a timing chart for explaining an image forming operation and a conveyance operation according to the fourth embodiment. In the present embodiment as well, the leading edge of the sheet S is detected by the conveyance sensor 20 after the rotary body 90 is moved to the black development posture. FIGS. 43 and 44 are flowcharts illustrating the image forming operation and the conveyance operation.

At times t21, t22, and t24 to t29 in FIG. 42, the same image forming operation and conveyance operation as those at times t21, t22, and t24 to t29 in FIG. 34 are performed. In addition, in S11, S12, and S17 to S31 of FIGS. 43 and 44, the same processing is executed as that in S11, S12, and S17 to S31 of FIGS. 35 and 36. Therefore, the description thereof will be omitted.

As illustrated in FIGS. 42 to 44, when it is determined that the movement of the rotary body 90 to the yellow development posture has been completed (S12:Y), the control unit 30 drives the motor M1 in the second direction R2 and starts yellow image formation at time t22 (S91 and S92). Then, the control unit 30 determines whether the speed of the motor M1 has been stabilized (S93). When it is determined that the speed of the motor M1 has been stabilized, the control unit 30 feeds a sheet S from the sheet accommodating portion 300, that is, executes a feeding operation, at time t61 (S94).

Next, the control unit 30 determines whether it is a separating timing for moving the secondary transfer roller 12 and the cleaning device 13 from the contacting positions to the separated positions (S95). When it is determined that it is a separating timing at which a predetermined time has elapsed from the start of the yellow image forming operation (S95:Y), the control unit 30 moves the secondary transfer roller 12 and the cleaning device 13 from the contacting positions toward the separated positions at time t62 (S96).

Next, the control unit 30 determines whether the sheet S has a width size that cannot be detected by the width sensor 21 (S97). For example, when the width of the sheet designated in the image forming job is smaller than 200 mm, the control unit 30 determines that the width sensor 21 cannot detect the width size of the sheet S. When it is determined that the width size of the sheet S can be detected by the width sensor 21 (S97:N), the control unit 30 determines whether the sheet S has been detected by the width sensor 21 (S98). When the sheet S has been detected by the width sensor 21 (S98:Y), the control unit 30 stops the driving of the motor M1 at time t63 (S99).

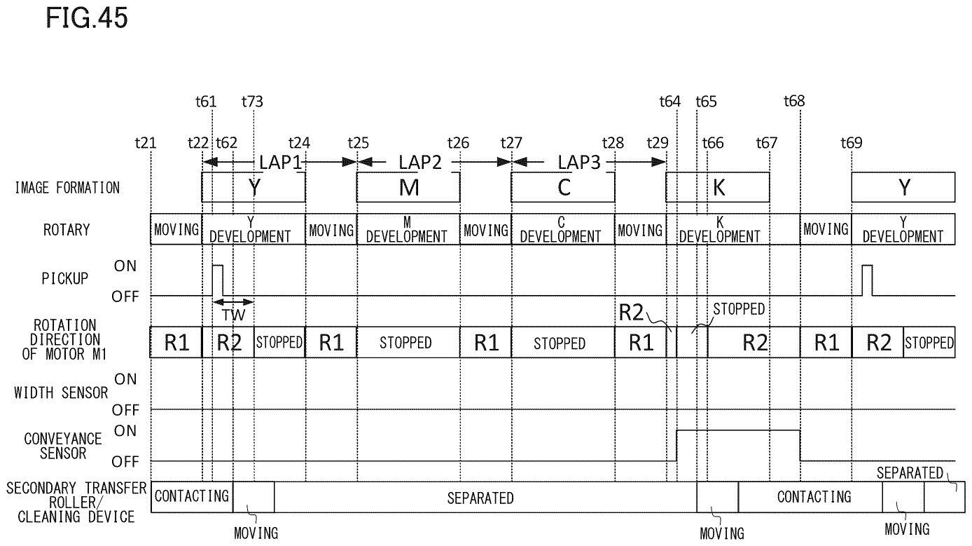

Here, FIG. 45 is a timing chart illustrating an image forming operation and a conveyance operation when the width size of the sheet S cannot be detected by the width sensor 21. As described with reference to FIG. 43, when the width size of the sheet S can be detected by the width sensor 21, the control unit 30 stops the driving of the motor M1 based on the fact that the sheet S has been detected by the width sensor 21. On the other hand, as illustrated in FIG. 45, when the width size of the sheet S cannot be detected by the width sensor 21, control different from that in FIG. 42 is performed. That is, when it is determined that the width size of the sheet S cannot be detected by the width sensor 21 (S97:Y), the control unit 30 determines whether a predetermined time TW has elapsed since the feeding operation (pickup operation) was performed (S100).

When it is determined that the predetermined time TW has elapsed since the feeding operation (pickup operation) was performed (S100:Y), the control unit 30 stops the driving of the motor M1 at time t73 (S99). In this manner, in the present embodiment, the motor M1 that has been driven in the second direction R2 stops based on the fact that the sheet S has been detected by the width sensor 21 or the fact that the predetermined time TW has elapsed since the feeding operation (pickup operation) was performed. Therefore, the sheet S is temporarily stopped upstream of the conveyance sensor 20 in the sheet conveyance direction CD. The timing chart of FIG. 45 from time t73 onward is similar to the timing chart of FIG. 42.

Here, a distance until the leading edge of the sheet S reaches the secondary transfer roller 12 after the operation of feeding the sheet S is started is defined as Dsns, and a conveyance speed of the sheet S is defined as Ssheet. At this time, the predetermined time TW until the driving of the motor M1 is stopped after the feeding operation (pickup operation) is performed satisfies the following relational expression (Mathematical Formula 3).

$$( Dsns \div Ssheet ) > TW \qquad ( Mathematical Formula 3 )$$

As illustrated in FIGS. 42 to 44, the control unit 30 subsequently performs a cyan image forming operation, a magenta image forming operation, and a black image forming operation in this order, in the same manner as in the first and second embodiments, but the detailed description thereof will be omitted (S17 to S31).

After driving the motor M1 in the second direction R2 and starting a black image forming operation at time t64, the control unit 30 determines whether the sheet S has been detected by the conveyance sensor 20 (S101). By driving the motor M1 in the second direction R2, the sheet S is conveyed in the sheet conveyance direction CD by the pickup roller 310, the feed roller 311, the separation roller 312, etc. That is, the conveyance of the sheet S is resumed. When the sheet S has not been detected by the conveyance sensor 20 (S101:N), the control unit 30 determines whether a predetermined time has elapsed since the conveyance of the sheet S was resumed (S102). When it is determined that the predetermined time has not elapsed since the conveyance of the sheet S was resumed (S102:N), the processing returns to step S101. When it is determined that the predetermined time has elapsed since the conveyance of the sheet S was resumed (S102:Y), the control unit 30 executes a retry operation of performing the feeding operation again (S103), and returns to step S101.

In the present embodiment, the conveyance distance from the pickup roller 310 to the conveyance sensor 20 is shorter than the length of the sheet S used in the image forming apparatus 1D. Therefore, even though the retry operation is executed in step S103, no succeeding sheet is fed from the sheet accommodating portion 300. In addition, for example, when a sheet S having a width of less than 200 mm is fed for the predetermined time TW (S97, S100, and S99), the leading edge position of the sheet S is somewhere upstream of the conveyance sensor 20 in the sheet conveyance direction CD. For example, when the leading edge position of the sheet S is upstream of the feed roller 311 in the sheet conveyance direction CD, the sheet S can be conveyed to the conveyance sensor 20 by executing the retry operation in step S103.

When the sheet S is detected by the conveyance sensor 20 (S101), the control unit 30 stops the driving of the motor M1 at time t64 (S104). Next, the control unit 30 determines whether it is a timing for contacting the secondary transfer roller 12 and the cleaning device 13 (S105). When it is determined that it is a contacting timing (S105:Y), the control unit 30 moves the secondary transfer roller 12 and the cleaning device 13 from the separated positions toward the contacting positions at time t65 (S106).

Next, the control unit 30 determines whether it is a timing for starting (resuming) the conveyance of the sheet S (S107). When it is determined that it is a timing for starting the conveyance of the sheet S (S107:Y), the control unit 30 drives the motor M1 in the second direction R2 at time t66 (S108). In the present embodiment, even when the black image forming operation is completed at time t67, the motor M1 continues to be driven in the second direction R2 in order to convey the sheet S, and accordingly, the rotary body 90 maintains the black development posture.

Next, the control unit 30 determines whether the trailing edge of the sheet S has been detected by the conveyance sensor 20 (S109). When the trailing edge of the sheet S has been detected by the conveyance sensor 20 (S109:Y), the control unit 30 determines whether there is no instruction for a next image forming operation from the host computer 3002 (S110). When there is an instruction for a next image forming operation from the host computer 3002 (S110:N), the control unit 30 moves the rotary body 90 toward the yellow development posture to start image formation on a next sheet at time t68 (S11). When the rotary body 90 moves to the yellow development posture at time t69, the control unit 30 stops the driving of the motor M1 and starts a yellow image forming operation. Each of the timing charts illustrated in FIGS. 42 and 45 exemplifies a case where there is an instruction for a next image forming operation from the host computer 3002.

On the other hand, when there is no instruction for a next image forming operation from the host computer 3002 (S110:Y), the control unit 30 determines whether it is a timing for separating the secondary transfer roller 12 and the cleaning device 13 (S111). When it is determined that it is a separating timing at which a predetermined time has elapsed since the conveyance sensor 20 detected the trailing edge of the sheet S (S111:Y), the control unit 30 moves the secondary transfer roller 12 and the cleaning device 13 from the contacting positions toward the separated positions (S112). Then, the image forming operation and the conveyance operation illustrated in FIGS. 43 and 44 are completed.

As described above, in the present embodiment, the sheet S is fed immediately after the yellow image forming operation is started, and the sheet S is conveyed to just before the detection position of the conveyance sensor 20 in advance. As a result, it is possible to shorten the distance until the sheet S is detected by the conveyance sensor 20 after the conveyance of the sheet S is resumed at time t64. For example, when the width of the sheet S is 200 mm or more, the sheet S can be detected by the width sensor 21. Therefore, the distance until the sheet S is detected by the conveyance sensor 20 after the conveyance of the sheet S is resumed at time t64 is a distance from the width sensor 21 to the conveyance sensor 20. Such a distance corresponds to the distance Dsns in the relational expression (Mathematical Formula 2) described in the second embodiment. As a result, the condition for performing the retry operation can be relaxed, and the waste of the sheet S and the toner can be suppressed. Further, unlike the third embodiment, the black image forming operation is not delayed by one cycle (LAP4 in FIG. 37) of the intermediate transfer belt 10a, thereby making it possible to improve productivity.

In the present embodiment as well, similarly to the first embodiment, the control unit 30 controls the motor M1 in the image forming operation such that the sheet S is detected by the conveyance sensor 20 after moving the rotary body 90 to the black development posture, which is a predetermined development posture. For example, if the rotary body 90 changes its posture many times after the sheet S is detected by the conveyance sensor 20 and before the image is transferred onto the sheet in the secondary transfer portion, there is a possibility that the leading edge position of the sheet S may shift due to vibration when the rotary body 90 rotates. On the other hand, in the present embodiment, after the sheet S is detected by the conveyance sensor 20, the number of times the motor M1 is driven to drive the rotary body 90 can be reduced. In addition, the rotation direction of the motor M1 is not switched to the first direction R1 until the sheet S reaches the secondary transfer roller 12 after the sheet S is detected by the conveyance sensor 20. As a result, it is possible to suppress a variation in timing at which the sheet S reaches the secondary transfer portion, and transfer the toner image to a desired position of the sheet S in the secondary transfer portion.

### Other Embodiments

In any of the embodiments described above, the rotary drive ratchet gear 410 is switched between the first non-transmission state and the first transmission state by the restriction lever 430 that moves in conjunction with the drive rack 15R when the motor M1 rotates in the second direction R2, but the switch of the rotary drive ratchet gear 410 is not limited thereto. For example, the restriction lever 430 may be switched between the allowing position and the restricting position by a moving member other than the drive rack 15R. Instead of the restriction lever 430, an actuator such as a solenoid may switch the rotary drive ratchet gear 410 between the first non-transmission state and the first transmission state when the motor M1 rotates in the second direction R2.

In addition, in any of the embodiments described above, the image forming operation and the conveyance operation when forming a color image have been described, but the image formation is not limited thereto. For example, even when a monochrome image is formed, the motor M1 may be controlled such that the conveyance sensor 20 detects the leading edge of the sheet S after the rotary body 90 moves to the black development posture. As a result, it is possible to suppress a variation in timing at which the sheet S reaches the secondary transfer portion, and transfer the toner image to a desired position of the sheet S in the secondary transfer portion.

In any of the embodiments described above, the rotary body 90, the pickup roller 310, the feed roller 311, the separation roller 312, and the conveyance roller pair 320 are driven by one drive source, namely the motor M1, but the drive source for driving them is not limited thereto. For example, a motor (first motor) that drives the rotary body 90 may be provided separately from a motor (second motor) that drives the pickup roller 310, the feed roller 311, the separation roller 312, and the conveyance roller pair 320.

Further, in any of the embodiments described above, the position of the rotary body 90 is moved to the magenta replacement posture when there is no instruction for a next image forming operation from the host computer 3002, but the movement of the rotary body 90 is not limited thereto. For example, the rotary body 90 may be moved to a position different from the magenta replacement posture according to the configuration of the image forming apparatus.

In any of the embodiments described above, the operation of feeding the sheet S is started after the speed of the motor M1 is stabilized, but the start of the feeding operation is not limited thereto. For example, the feeding operation may be started immediately after the driving is started without waiting until the speed of the motor M1 is stabilized.

In any of the embodiments described above, the image forming operation and the conveyance operation when conveying (feeding) the sheet S from the sheet accommodating portion 300 have been described, but the conveyance of the sheet is not limited thereto. For example, in a case where each of the image forming apparatuses 1 and 1D has a duplex conveyance path so that duplex printing can be performed, the control according to each of the embodiments described above may be adopted for the image forming operation and the conveyance operation when conveying the sheet S from the duplex conveyance path. The duplex conveyance path guides the sheet with the image formed on the first side thereof back toward the secondary transfer portion. That is, the conveyance unit driven by the rotation of the motor M1 in the second direction R2 conveys the sheet from the duplex conveyance path toward the secondary transfer roller 12.

In addition, the retry operation described in the second to fourth embodiments described above may be repeated multiple times. When the number of times of the retry operation reaches a predetermined number of times or more, the control unit 30 may determine that the feeding operation has failed and end the image forming operation and the conveyance operation.

Further, in the fourth embodiment described above, only one width sensor 21 is disposed at the position shifted by 100 mm from the center C1 of the conveyance path CP, but the width sensor 21 is not limited thereto. The position of the width sensor 21 and the number of width sensors 21 may be arbitrarily set. The width sensor 21 is preferably disposed upstream of the conveyance sensor 20 in the sheet conveyance direction CD. Further, in the fourth embodiment, the width sensor 21 is used to detect the size (width size) in the width direction W of the sheet S, but a sensor used for another purpose may be adopted.

In any of the embodiments described above, the drive transmission from the motor M1 is controlled by using the rotary drive ratchet gear 410 and the conveyance drive ratchet gear 370, but the drive transmission is not limited thereto. For example, instead of the rotary drive ratchet gear 410 and the conveyance drive ratchet gear 370, another clutch mechanism such as an electromagnetic clutch may be applied. Even in such a case, when the motor M1 rotates in the first direction R1, the driving force is transmitted to the rotary body 90, and when the motor M1 rotates in the second direction R2, the driving force is transmitted to the pickup roller 310, the feed roller 311, the separation roller 312, and the conveyance roller pair 320.

According to the present disclosure, it is possible to suppress a variation in timing at which the sheet reaches the transfer unit.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-046029, filed Mar. 19, 2025, which is hereby incorporated by reference herein in its entirety.

What is claimed is:

1. An image forming apparatus configured to execute an image forming operation of forming a color image on a sheet, the image forming apparatus comprising:
a photosensitive drum;
a rotary including a plurality of developing rollers, the rotary being rotatable to a plurality of development postures during an execution of the image forming operation, one of the plurality of developing rollers facing the photosensitive drum in a case where the rotary takes each of the plurality of development postures;
an intermediate transfer member to which a toner image is transferred from the photosensitive drum;
a transfer unit configured to transfer the toner image borne on the intermediate transfer member to the sheet;
a conveyance unit configured to execute a conveyance operation of conveying the sheet in a sheet conveyance direction toward the transfer unit;
a detection unit disposed between the conveyance unit and the transfer unit in the sheet conveyance direction, and configured to detect the sheet;
a motor configured to drive the rotary by rotating in a first direction, and drive the conveyance unit by rotating in a second direction opposite to the first direction; and
a control unit configured to control the motor,
wherein the control unit controls the motor in the image forming operation such that the sheet is detected by the detection unit after the rotary is moved to a predetermined development posture, the predetermined development posture being a development posture to which the rotary moves last during the execution of the image forming operation, among the plurality of development postures.

2. The image forming apparatus according to claim 1, wherein the conveyance unit starts the conveyance operation after the rotary is moved to the predetermined development posture in the image forming operation.

3. The image forming apparatus according to claim 2, wherein the control unit controls the motor to continue to rotate in the second direction after the conveyance operation is started by the conveyance unit until the sheet reaches the transfer unit.

4. The image forming apparatus according to claim 1, wherein the transfer unit is movable between a contacting position where the transfer unit is brought into contact with the intermediate transfer member and a separated position where the transfer unit is separated from the intermediate transfer member, and
the control unit moves the transfer unit from the separated position to the contacting position after the sheet is detected by the detection unit in the image forming operation.

5. The image forming apparatus according to claim 4, wherein in a case where the detection unit does not detect the sheet within a predetermined time in the image forming operation, the conveyance unit executes a retry operation of performing the conveyance operation performed by the conveyance unit again.

6. The image forming apparatus according to claim 5, wherein the rotary is rotatable to a non-development posture in which none of the plurality of developing rollers faces the photosensitive drum, and
in a case where the conveyance unit executes the retry operation, the control unit moves the transfer unit from the separated position to the contacting position after the rotary is rotated from the predetermined development posture to the non-development posture.

7. The image forming apparatus according to claim 5, further comprising an exposing unit configured to form an electrostatic latent image on the photosensitive drum by exposing the photosensitive drum,
wherein the electrostatic latent image developed by the rotary taking the predetermined development posture is a predetermined electrostatic latent image, and
the control unit controls the exposing unit in the image forming operation such that a formation of the predetermined electrostatic latent image on the photosensitive drum is started before the sheet is detected by the detection unit.

8. The image forming apparatus according to claim 5, further comprising an exposing unit configured to form an electrostatic latent image on the photosensitive drum by exposing the photosensitive drum,
wherein the electrostatic latent image developed by the rotary taking the predetermined development posture is a predetermined electrostatic latent image, and
the control unit controls the exposing unit in the image forming operation such that a formation of the predetermined electrostatic latent image on the photosensitive drum is started after the sheet is detected by the detection unit.

9. The image forming apparatus according to claim 1, wherein the control unit controls the conveyance unit, in the image forming operation, such that the sheet is conveyed by the conveyance unit before the rotary is moved to the predetermined development posture, and that the sheet is stopped upstream of the detection unit in the sheet conveyance direction.

10. The image forming apparatus according to claim 9, further comprising a width detection unit disposed upstream of the detection unit in the sheet conveyance direction, and configured to detect a width size of the sheet,
wherein the control unit controls the conveyance unit, in the image forming operation, such that the sheet is conveyed before the rotary is moved to the predetermined development posture, and that the sheet is stopped based on detection of the sheet by the width detection unit.

11. The image forming apparatus according to claim 9, wherein the control unit controls the conveyance unit, in the image forming operation, to resume a conveyance of the sheet after the rotary is moved to the predetermined development posture.

12. The image forming apparatus according to claim 1, wherein the toner image developed by the rotary taking the predetermined development posture is black.

13. The image forming apparatus according to claim 1, wherein the control unit rotates the motor in the first direction based on detection of a trailing edge of the sheet by the detection unit.

14. The image forming apparatus according to claim 1, further comprising:
a first drive transmission unit configured to transition between a first transmission state in which driving force from the motor is transmitted to the rotary in a case where the motor rotates in the first direction, and a first non-transmission state in which driving force from the motor is not transmitted to the rotary in a case where the motor rotates in the second direction; and
a second drive transmission unit configured to transition between a second transmission state in which the driving force from the motor is transmitted to the conveyance unit in a case where the motor rotates in the second direction, and a second non-transmission state in which the driving force from the motor is not transmitted to the conveyance unit in a case where the motor rotates in the first direction.

15. The image forming apparatus according to claim 14, wherein each of the first drive transmission unit and the second drive transmission unit includes a ratchet.

16. The image forming apparatus according to claim 1, further comprising a sheet accommodating portion in which the sheet are accommodated,
wherein the conveyance unit includes a pickup roller configured to feed the sheet from the sheet accommodating portion.

17. The image forming apparatus according to claim 1, further comprising a duplex conveyance path configured to guide a sheet with an image formed on a first side of the sheet toward the transfer unit,
wherein the conveyance unit conveys the sheet from the duplex conveyance path toward the transfer unit.

18. An image forming apparatus configured to execute an image forming operation of forming a color image on a sheet, the image forming apparatus comprising:
a photosensitive drum;
a rotary including a plurality of developing rollers, the rotary being rotatable to a plurality of development postures during an execution of the image forming operation, one of the plurality of developing rollers facing the photosensitive drum in a case where the rotary takes each of the plurality of development postures;
an intermediate transfer member to which a toner image is transferred from the photosensitive drum;
a transfer unit configured to transfer the toner image borne on the intermediate transfer member to the sheet;
a conveyance unit configured to execute a conveyance operation of conveying the sheet in a sheet conveyance direction toward the transfer unit;
a detection unit disposed between the conveyance unit and the transfer unit in the sheet conveyance direction, and configured to detect the sheet;
a first motor configured to drive the rotary;
a second motor configured to drive the conveyance unit; and
a control unit configured to control the first motor and the second motor,
wherein the control unit controls the first motor and the second motor in the image forming operation such that the sheet is detected by the detection unit after the rotary is moved to a predetermined development posture, the predetermined development posture being a development posture to which the rotary moves last during the execution of the image forming operation, among the plurality of development postures.
